(19) United States
(12) Patent Application Publication
(10) Pub. No.: US 2025/0053348 A1
(43) Pub. Date: Feb. 13, 2025

(54) IMAGE PROCESSING APPARATUS, IMAGE PROCESSING METHOD, AND NON-TRANSITORY COMPUTER-READABLE MEDIUM

(71) Applicant: CANON KABUSHIKI KAISHA, Tokyo (JP)

(72) Inventors: MAYUKO YAMAGATA, Tokyo (JP); DAISUKE KOBAYASHI, Kanagawa (JP); EIJI KOMAMIYA, Kanagawa (JP); HIROKAZU TANAKA, Tokyo (JP); TSUKASA DOI, Tokyo (JP)

(21) Appl. No.: 18/798,409

(22) Filed: Aug. 8, 2024

(30) Foreign Application Priority Data
Aug. 10, 2023 (JP) 2023-131466
Jul. 26, 2024 (JP) 2024-121295

(51) Int. Cl. G06F 3/12; G06T 7/13; G06V 10/56; G06V 10/60; G06V 10/764

(52) U.S. Cl. CPC G06F 3/1202; G06T 7/13; G06V 10/56; G06V 10/60; G06V 10/764

(57) ABSTRACT

An image processing apparatus is provided. The apparatus detects an edge in an N-arized image (N is a natural number not less than 2) representing a result of threshold-based processing for a grayscale image obtained from an input image. The apparatus generates the print data based on the input image and a detection result of the edge.

### BACKGROUND OF THE INVENTION

### Field of the Invention

The present invention relates to an image processing apparatus, an image processing method, and a non-transitory computer-readable medium and, more particularly, to an inkjet printing apparatus including a printhead for executing printing by discharging ink.

### Description of the Related Art

There is known a technique of suppressing bleeding caused by contact between a plurality of ink droplets in an inkjet printer. For example, Japanese Patent Laid-Open No. 6-152902 discloses a method of thinning out, every other dot, black pixels and color pixels located at the boundary between a black image portion and a color image portion. In the method of Japanese Patent Laid-Open No. 6-152902, contact between a black ink droplet and a color ink droplet is suppressed, and thus ink bleeding is reduced. Furthermore, Japanese Patent Laid-Open No. 2019-72890 discloses a method of executing multi-pass printing so that printing of a high-density region in an edge portion is biased to one pass and printing of a low-density region in the edge portion is biased to one pass. In the method of Japanese Patent Laid-Open No. 2019-72890, the arrival timings of ink droplets are separated between the adjacent regions in the edge portion, and thus bleeding caused by contact between ink droplets is reduced.

### SUMMARY OF THE INVENTION

According to an embodiment of the present invention, an image processing apparatus for generating print data of at least one color, which is used by a printing apparatus for printing an image on a print medium by adhering a recording material of at least one color to the print medium in accordance with the print data, comprises one or more memories storing instructions and one or more processors that execute the instructions to: detect an edge in an N-arized image (N is a natural number not less than 2) representing a result of threshold-based processing for a grayscale image obtained from an input image; and generate the print data based on the input image and a detection result of the edge.

According to another embodiment of the present invention, an image processing apparatus for generating print data corresponding to each color, which is used by a printing apparatus for printing an image on a print medium by adhering a recording material of at least one color to the print medium in accordance with the print data, comprises one or more memories storing instructions and one or more processors that execute the instructions to: detect an edge in a grayscale image corresponding to an input image; and generate the print data based on the input image, a detection result of the edge, and a pixel value at the edge of the grayscale image.

According to still another embodiment of the present invention, an image processing apparatus comprises one or more memories storing instructions and one or more processors that execute the instructions to: detect an edge in an N-arized image (N is a natural number not less than 2) representing a result of threshold-based processing for a grayscale image obtained from an input image; and generate, based on the input image and a detection result of the edge, color separation data indicating a recording amount for each pixel and a detection result of the edge for each pixel and corresponding to a recording material used by a printing apparatus for printing.

According to yet another embodiment of the present invention, the image processing method of generating print data of at least one color, which is used by a printing apparatus for printing an image on a print medium by adhering a recording material of at least one color to the print medium in accordance with the print data, comprises: detecting an edge in an N-arized image (N is a natural number not less than 2) representing a result of threshold-based processing for a grayscale image obtained from an input image; and generating the print data based on the input image and a detection result of the edge.

According to still yet another embodiment of the present invention, a non-transitory computer-readable medium stores a program executable by a computer to perform a method of generating print data of at least one color, which is used by a printing apparatus for printing an image on a print medium by adhering a recording material of at least one color to the print medium in accordance with the print data, comprising: detecting an edge in an N-arized image (N is a natural number not less than 2) representing a result of threshold-based processing for a grayscale image obtained from an input image; and generating the print data based on the input image and a detection result of the edge.

Further features of the present invention will become apparent from the following description of exemplary embodiments (with reference to the attached drawings).

### BRIEF DESCRIPTION OF THE DRAWINGS

FIG. 1 is a perspective view of a printing apparatus according to an embodiment;

FIGS. 2A and 2B are a view and a block diagram showing an example of the hardware configuration of an image processing apparatus according to the embodiment;

FIGS. 3A and 3B are flowcharts of an image processing method according to the embodiment;

FIGS. 4A and 4B are views each showing an example of a dot arrangement in an edge portion;

FIGS. 5A to 5C are views each showing an example of input image data;

FIGS. 6A and 6B are graphs each showing the relationship between an ink amount and brightness;

FIGS. 7A to 7C are views for explaining edge pattern detection;

FIGS. 8A to 8C are views for explaining rotation and phase shifting of pattern matching data;

FIG. 9 is a graph for explaining tone correction processing;

FIG. 10 is a flowchart of color separation processing and quantization processing;

FIGS. 11A to 11C are views for explaining index expansion processing;

FIGS. 12A to 12C are views for explaining conversion of an input image into a luminance image;

FIGS. 13A to 13C are views for explaining conversion of a luminance image into a binary image;

FIGS. 14A to 14C are views each showing a result of edge detection processing;

FIGS. 15A to 15F are views each showing an example of quantization data;

FIGS. 16A to 16F are views each showing an example of a dot arrangement pattern;

FIGS. 17A to 17C are views each showing an example of a dot arrangement;

FIG. 18 is a flowchart of an image processing method according to an embodiment;

FIGS. 19A to 19C are views for explaining index expansion processing;

FIGS. 20A to 20C are views each showing a result of edge detection processing;

FIGS. 21A to 21F are views each showing an example of quantization data;

FIGS. 22A to 22F are views each showing an example of a dot arrangement pattern;

FIGS. 23A to 23C are views each showing an example of a dot arrangement;

FIGS. 24A to 24D are views each showing an example of quantization data;

FIGS. 25A to 25D are views each showing an example of a dot arrangement pattern;

FIGS. 26A and 26B are views each showing an example of a dot arrangement;

FIGS. 27A to 27C are views showing a schematic configuration of a printhead;

FIGS. 28A to 28D are views showing an example of a case where a third edge portion continues;

FIG. 29 is a flowchart of an image processing method according to an embodiment;

FIGS. 30A and 30B are graphs for explaining ink color separation;

FIG. 31 is a flowchart of color separation processing and quantization processing;

FIG. 32 is a graph for explaining tone correction processing;

FIG. 33 is a view for explaining index expansion processing;

FIGS. 34A to 34C are views each showing an example of a binary image corresponding to ink amount information;

FIGS. 35A to 35C are views each showing a result of edge detection processing;

FIGS. 36A to 36C are views each showing density values after tone correction;

FIGS. 37A to 37F are views each showing an example of quantization data;

FIGS. 38A to 38F are views each showing an example of a dot arrangement pattern;

FIGS. 39A to 39C are views each showing an example of a dot arrangement;

FIG. 40 is a view for explaining multi-pass printing;

FIGS. 41A and 41B are views for explaining index expansion processing;

FIGS. 42A to 42F are views each showing an example of index data;

FIGS. 43A to 43D are views each showing an example of a mask pattern;

FIG. 44 is a table showing an example of a mask decoding table;

FIGS. 45A to 45F are views each showing an example of a dot arrangement pattern;

FIGS. 46A to 46D are views each showing an example of a dot arrangement;

FIGS. 47A to 47D are views each showing an example of a dot arrangement;

FIGS. 48A to 48C are views each showing an example of threshold setting; and

FIGS. 49A to 491 are views each showing an example of a dot arrangement.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

The method of Japanese Patent Laid-Open No. 6-152902 has a problem that the outline of a character or line printed by black ink is thin and thus visibility decreases. The method of Japanese Patent Laid-Open No. 2019-72890 has a problem that a white background is readily generated in an edge portion due to a print position deviation between passes.

An embodiment of the present invention can suppress secondary deterioration in image quality while improving sharpness of a printed image such as a character or line.

### <Structure of Printing Apparatus>

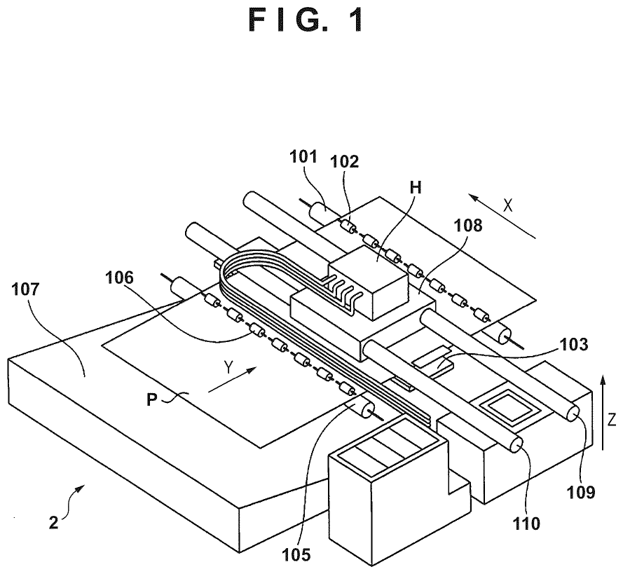

The structure of a printing apparatus according to each embodiment will be described below with reference to FIG. 1. FIG. 1 is a perspective view showing an overview of a print unit in a printer 2 serving as a printing apparatus according to an embodiment.

A print medium P (to be also simply referred to as a print medium hereinafter) fed to the print unit is conveyed in the −Y direction (sub-scanning direction) by a nip portion between a conveyance roller 101 arranged on a conveyance path and a pinch roller 102 driven by the conveyance roller 101 along with the rotation of the conveyance roller 101.

A platen 103 is provided at a print position facing a surface (nozzle surface) on which nozzles of a printhead H adopting an inkjet printing method are formed, and maintains the distance between the front surface of the print medium P and the nozzle surface of the printhead H constant by supporting the back surface of the print medium P from below.

The print medium P whose region is printed on the platen 103 is conveyed in the −Y direction along with the rotation of the discharge roller 105 while being nipped by a discharge roller 105 and a spur 106 driven by the discharge roller 105, and is then discharged to a discharge tray 107.

The printhead H is detachably mounted on a carriage 108 in a posture that the nozzle surface faces the platen 103 or the print medium. The carriage 108 is moved reciprocally in the X direction as the main scanning direction along two guide rails 109 and 110 by the driving force of a carriage motor (not shown). In the process of the movement, the printhead H executes a discharge operation according to a discharge signal.

The ±X direction in which the carriage 108 moves is a direction intersecting the −Y direction in which the print medium is conveyed, and is called the main scanning direction. To the contrary, the −Y direction of conveyance of the print medium is called the sub-scanning direction. By alternately repeating main scanning (movement with a discharge operation) of the carriage 108 and the printhead H and conveyance (sub-scanning) of the print medium, an image is formed stepwise on the print medium P. The contents of the structure of the printing apparatus according to this embodiment have been described.

The printing apparatus according to the embodiment prints an image on the print medium by adhering recording materials of one or more colors to the print medium in accordance with print data of one or more colors. The printing apparatus to be described below prints an image on the print medium by adhering recording materials of a plurality of colors to the print medium. More specifically, the printing apparatus prints an image by adhering cyan ink, magenta ink, yellow ink, and black ink to the print medium in accordance with nozzle data of cyan (C), magenta (M), yellow (Y), and black (K). As will be described later, the nozzle data corresponds to print data.

### <Structure of Printhead>

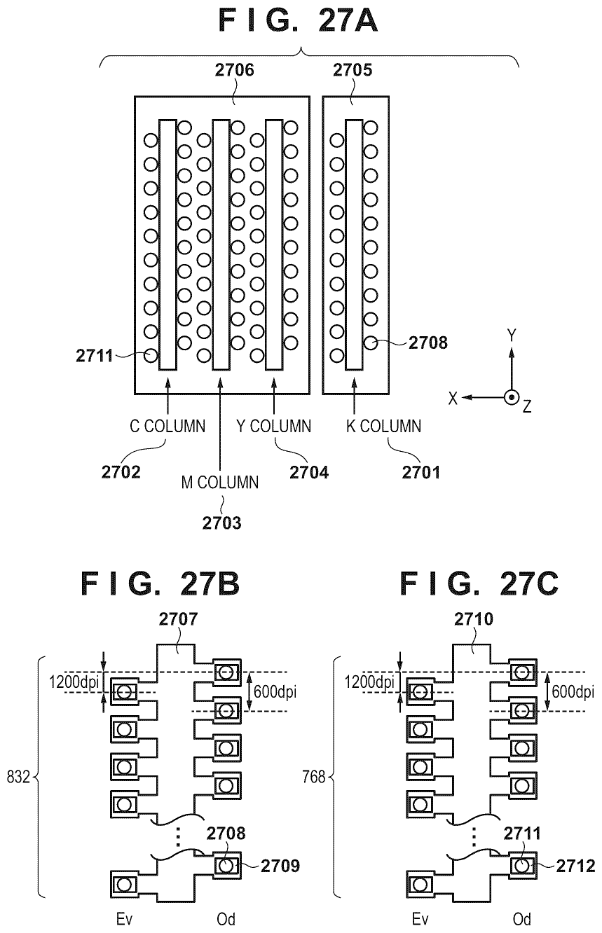

The structure of the printhead according to this embodiment will be described below with reference to FIGS. 27A to 27C. FIGS. 27A to 27C are schematic views of the nozzle surface of the printhead H used in this embodiment when viewed from the +Z direction. The printhead H includes print chips 2705 and 2706, and each print chip receives a print signal from the main body of the printing apparatus via a contact pad (not shown), and is supplied with power necessary to drive the printhead. As shown in FIG. 27A, on the print chip 2705, a nozzle array 2701 (to be also referred to as a black nozzle array hereinafter) in which a plurality of nozzles for discharging black ink are arrayed in the Y direction is arranged. Similarly, on the print chip 2706, a nozzle array 2702 for discharging cyan ink, a nozzle array 2703 for discharging magenta ink, and a nozzle array 2704 for discharging yellow ink are arranged.

FIG. 27B is an enlarged view of the black nozzle array 2701. FIG. 27C is an enlarged view of one nozzle array among the nozzle arrays 2702, 2703, and 2704, that is, three nozzle arrays of cyan, magenta, and yellow in total. This enlarged view is common to color inks. Nozzles 2708 or 2711 for discharging ink are arranged on two sides of an ink liquid chamber 2707 or 2710. A discharge heater 2709 or 2712 is arranged immediately below each nozzle (on the +Z direction side). When the discharge heater 2709 or 2712 is applied with a voltage, it generates heat to generate a bubble, thereby causing the corresponding nozzle to discharge ink. There are arranged 832 nozzles 2708 and 768 nozzles 2711. Each nozzle 2708 discharges black ink, and an Ev column and an Od column each formed by arraying the nozzles 2708 at a pitch of 600 dpi in the Y direction are arranged. The Ev column is arranged by being shifted by a half pitch in the −Y direction with respect to the Od column. By performing print scanning using the black nozzle array 2701 having the above configuration, the print medium can be printed with a print density of 1,200 dpi. Each of the cyan nozzle array 2702, the magenta nozzle array 2703, and the yellow nozzle array 2704 has the same configuration as that of the black nozzle array 2701.

Note that the printhead H of this embodiment has a configuration including the print chip with the black nozzle array and the print chip with the cyan nozzle array, the magenta nozzle array, and the yellow nozzle array but the present invention need not be limited to this configuration. More specifically, all the black nozzle array, the cyan nozzle array, the magenta nozzle array, and the yellow nozzle array may be mounted on one chip. Alternatively, a printhead on which a print chip with a black nozzle array is mounted may be separated from a printhead on which a print chip with a cyan nozzle array, a magenta nozzle array, and a yellow nozzle array is mounted. Alternatively, a black nozzle array, a cyan nozzle array, a magenta nozzle array, and a yellow nozzle array may be mounted on different printheads, respectively. Furthermore, the printhead H of this embodiment adopts a so-called bubble jet method of discharging ink by applying a voltage to a heater to generate heat but the present invention need not be limited to this. More specifically, a configuration of discharging ink using electrostatic actuators or piezoelectric elements may be used.

The contents of the structure of the printhead according to this embodiment have been described above.

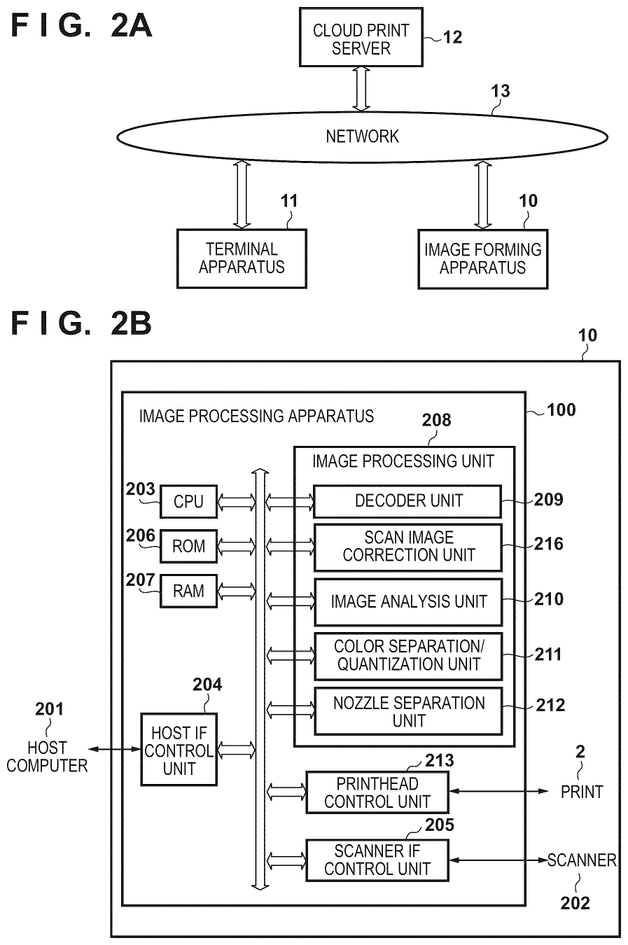

FIG. 2A is a view showing an example of the configuration of a printing system including an image forming apparatus 10 on which the printer 2 is mounted. As an example, FIG. 2A shows a cloud print system in which a terminal apparatus 11, a cloud print server 12, and the image forming apparatus 10 are connected via a network 13. The cloud print server 12 is a server apparatus that provides a cloud print service. That is, in the configuration shown in FIG. 2A, the image forming apparatus 10 is a printer supporting cloud printing. The network 13 is a wired network, a wireless network, or a network including both of them. As the network 13, for example, an Internet, WAN, or VPN environment is assumed. However, the printing system is not limited to the cloud print system. For example, the network 13 may be formed as an office LAN or the terminal apparatus 11 and the image forming apparatus 10 may directly be connected without intervention of the network 13. FIG. 2A shows one terminal apparatus 11 and one image forming apparatus 10 but a plurality of terminal apparatuses 11 and a plurality of image forming apparatuses 10 may be provided. The cloud print server 12 may be a server system formed by a plurality of information processing apparatuses. The printing system may be a cloud print system in which a plurality of cloud print services cooperate with each other.

The terminal apparatus 11 is an information processing apparatus such as a PC, a tablet, or a smartphone, and a cloud printer driver for a cloud print service is installed in the terminal apparatus 11. A user can execute arbitrary application software on the terminal apparatus 11. For example, a print job and print data are generated via the cloud printer driver based on image data generated on the print application. The print job and the print data are transmitted, via the cloud print server 12, to the image forming apparatus 10 registered in the cloud print service. The image forming apparatus 10 is a device that executes printing on a print medium such as a sheet, and prints an image on the print medium based on the received print data.

### <Configuration of Control System>

The configuration of a control system according to this embodiment will be described below with reference to FIG. 2B. FIG. 2B is a schematic block diagram of an image processing apparatus 100. This embodiment assumes that the image processing apparatus 100 is included in the image forming apparatus 10. However, the image processing apparatus 100 may be formed as an apparatus connected to the image forming apparatus 10 including the printer 2 and a scanner 202. For example, the image processing apparatus 100 may be formed in a host computer 201. In this case, the image processing apparatus 100 need not include a printhead control unit 213 or a scanner IF control unit 205.

The host computer 201 is an information processing apparatus that, for example, creates a print job formed from input image data and print condition information necessary for printing, and corresponds to, for example, the terminal apparatus 11 shown in FIG. 2A. Note that the print condition information is information concerning the type and size of a print sheet, print quality, and the like.

The scanner 202 is a scanner device connected to the image processing apparatus, and converts analog data, generated by reading document information placed on a scanner table, into digital data via an A/D converter. Reading by the scanner 202 is controlled when the host computer 201 transmits a scan job to the image processing apparatus 100 but the present invention is not limited to this. A dedicated UI apparatus connected to the scanner 202 or the image processing apparatus 100 can substitute for the scanner 202.

A ROM 206 is a readable memory that stores a program for controlling the image processing apparatus 100.

A CPU 203 controls the image processing apparatus 100 by executing the program stored in the ROM 206.

A host IF control unit 204 communicates with the host computer 201, transmits a print job or the like, and stores the print job in a RAM 207.

The RAM 207 is a readable/writable memory used as a program execution area or a data storage area.

An image processing unit 208 generates printable nozzle data separated for each nozzle from input image data stored in the RAM 207 in accordance with a print condition included in a print job. The generated nozzle data is stored in the RAM 207. The image processing unit 208 includes a decoder unit 209, a scan image correction unit 216, an image analysis unit 210, a color separation/quantization unit 211, and a nozzle separation processing unit 212.

The printhead control unit 213 controls the printhead H in the printer 2 based on control data obtained based on the nozzle data stored in the RAM 207.

A shared bus 215 is connected to each of the CPU 203, the host IF control unit 204, the scanner IF control unit 205, the ROM 206, the RAM 207, and the image processing unit 208. These connected units can communicate with each other via the shared bus 215. The contents of the configuration of the control system according to this embodiment have been described above.

The image processing apparatus according to the embodiment can be implemented by a computer including a processor and a memory. In this case, when the processor such as the CPU 203 executes the program stored in the memory such as the RAM 207 or the ROM 206, the respective functions of the image processing unit 208 can be implemented. Some or all of the functions of the image processing apparatus may be implemented by dedicated hardware components. In addition, the image processing apparatus according to the embodiment may be formed by, for example, a plurality of information processing apparatuses connected via the network.

### First Embodiment

In this embodiment, nozzle data indicating a dot arrangement is generated to thin out dots in an edge region. Especially, in this embodiment, information representing an edge detection result is added to a pixel, and dots in the edge region are thinned out based on the information. On the other hand, in this embodiment, the edge region is detected based on a luminance image. In this case, if the pixel value of a pixel in an input image belongs to a low-brightness region, this pixel is not added with information representing an edge. Therefore, generation of nozzle data is controlled not to thin out dots in the edge region in the low-brightness region.

### <Overall Procedure>

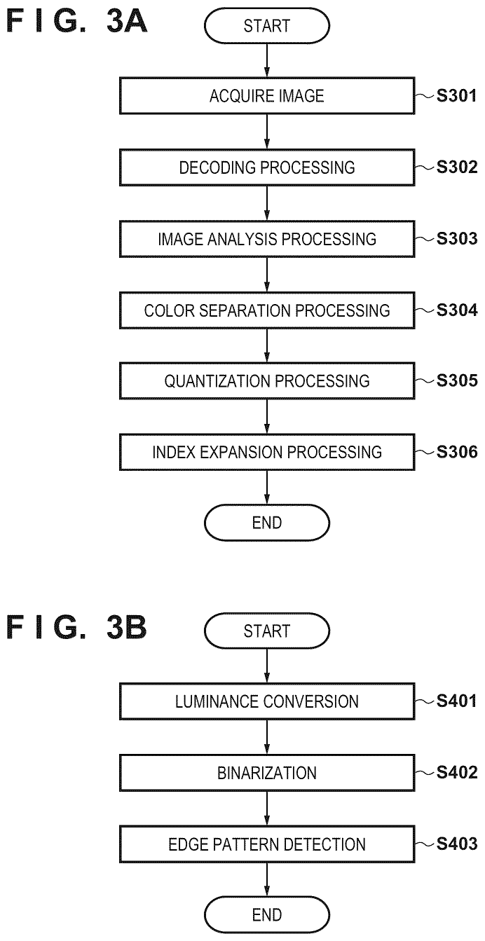

The procedure of edge processing according to this embodiment will be described below. FIG. 3A is flowchart illustrating processing executed by an image processing unit 208 according to this embodiment. In this embodiment, with the processing shown in FIG. 3A, input image data can be converted into nozzle data.

In step S301, the image processing unit 208 acquires input image data from a RAM 207.

In step S302, a decoder unit 209 performs decoding processing of the acquired input image data. The saving format of the input image data varies, and a compression format such as JPEG is generally used to decrease a communication amount between a host computer 201 and an image processing apparatus 100. In a case where the saving format is JPEG, the decoder unit 209 decodes JPEG and converts it into a bitmap format (an information format that records an image as continuous pixel values). In a case where the host computer 201 communicates with the image processing apparatus 100 via a dedicated driver or the like, a dedicated saving format may be handled. In a case where a dedicated saving format convenient for both the driver and the image processing apparatus 100 is held, the decoder unit 209 can perform conversion into the dedicated saving format. In accordance with, for example, the characteristic of an inkjet printing apparatus, saving formats with different compression ratios can be applied to a region where information is desirably held at fine accuracy and other regions. If it is desirable to focus on image quality instead of decreasing the communication amount, the input image data may be in the bitmap format. In this case, the decoder unit 209 need only output the bitmap format intact as a conversion result.

In step S303, an image analysis unit 210 detects an edge from an input image. The input image is an image indicated by the input image data acquired by the image processing unit 208, and includes a bitmap image output from the decoder unit 209. The image analysis unit 210 can execute image analysis using the bitmap image as a decoding result to detect the edge. In this embodiment, the image analysis unit 210 detects an edge in an N-arized image indicating the result of threshold-based processing for a grayscale image obtained from the input image where N is a natural number of 2 or more. For example, N can be, 2, 3, or 4. In this embodiment, the image analysis unit 210 detects pixels (to be referred to as edge pixels or first edge pixels hereinafter) on the inner side of the edge and pixels (to be referred to adjacent edge pixels or second edge pixels hereinafter) on the outer side of the edge, which correspond to two sides (for example, upper and lower sides or left and right sides) of the edge. In the following description, the edge region includes the edge pixels and the adjacent edge pixels.

In this embodiment, by analyzing the input image, it is estimated based on a feature in the input image whether a target pixel is in an edge portion with a paper white portion or an edge portion with a portion formed by ink different from the target pixel. In addition, in the embodiment, it is estimated which of the upper edge portion, the lower edge portion, the left edge portion, and the right edge portion of the shape of a character or the like includes the target pixel.

FIG. 3B shows the internal processing procedure of the image analysis processing executed in step S303. In step S401, the image analysis unit 210 converts the input image into a grayscale image. In the grayscale image, each pixel is assigned with one pixel value. The image analysis unit 210 can calculate the pixel value of one pixel of the grayscale image using a plurality of pixel values for a corresponding pixel of the input image. The grayscale image can be, for example, a luminance image or a brightness image. That is, the grayscale image can indicate, for each pixel, the luminance or brightness on the print medium in a case where the image is printed on the print medium in accordance with the pixel values of the input image. In this embodiment, the image analysis unit 210 converts the input image into a luminance image. For example, if the bitmap image data includes information of three channels of R, G, and B, the image analysis unit 210 can convert this information into information of one channel of a luminance Y That is, the image analysis unit 210 can calculate the luminance value Y for each pixel based on the R pixel value, B pixel value, and G pixel value. Note that if the application transmits the luminance value, step S401 can be skipped.

Conversion from information of three channels of R, G, and B into information of one channel of the luminance Y can be performed by:

$$Y = R \times 0.299 + G \times 0.587 + B \times 0.114 \qquad ( 1 )$$

The image analysis unit 210 may convert the input image into a grayscale image in accordance with the type of the print medium. In addition, the image analysis unit 210 may generate such grayscale image by converting the pixel values of the input image in accordance with a conversion table. In this case, the image analysis unit 210 can use a conversion table corresponding to the type of the print medium.

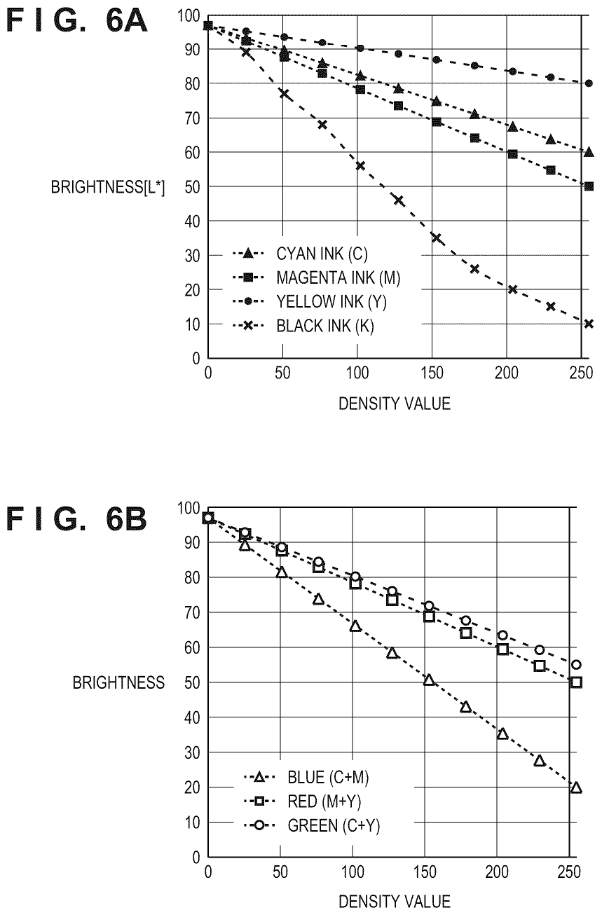

FIGS. 5A to 5C each show an example of the input image data. Each of FIGS. 5A, 5B, and 5C shows a character “E” expressed by pixels 52. The background color of the character “E” is different among FIGS. 5A, 5B, and 5C. The color of the pixel 52 is represented by RGB=(0, 0, 0). The color of a pixel 51 is represented by RGB=(255, 255, 255). The color of a pixel 53 is represented by RGB=(255, 255, 0). The color of a pixel 54 is represented by RGB=(0, 0, 255). FIG. 5A shows an example in which a black character is arranged on a white background. FIG. 5B shows an example in which a black character is arranged on a yellow background. FIG. 5C shows an example in which a black character is arranged on a blue background. According to conversion formula (1), a luminance Y_51 of the pixel 51 is 255, a luminance Y_52 of the pixel 52 is 0, a luminance Y_53 of the pixel 53 is 226, and a luminance Y_54 of the pixel 54 is 29.

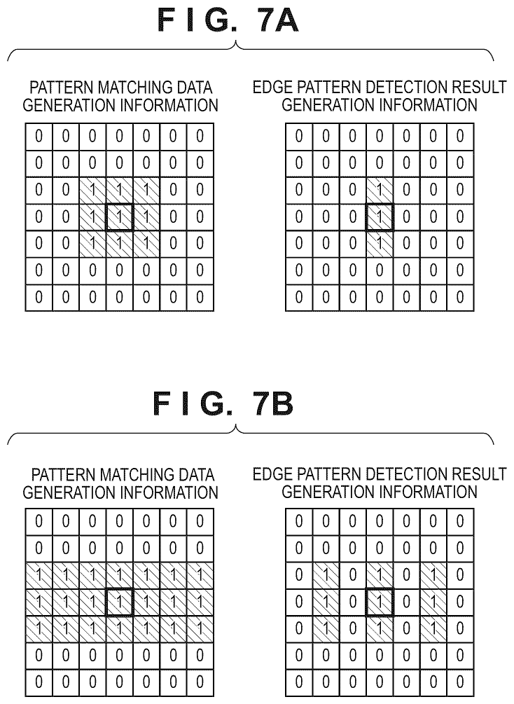

In this embodiment, image analysis is executed using an index of a luminance. The luminance Y is obtained by weighting the pixel values of R, G, and B by coefficients, as given by conversion formula (1). By using the luminance Y, a difference in brightness between the colors on the print medium can be expressed. This point will be described with reference to FIGS. 6A and 6B. FIG. 6A is a graph obtained by plotting the brightness on the paper with respect to the density value of each ink color in a case where printing is executed in a given print mode. FIG. 6B is a graph obtained by plotting the brightness on the paper with respect to the density value of each secondary color obtained by the same inks. The brightness shown in each of FIGS. 6A and 6B is the L* value of the CIE L*a*b* values obtained by measuring, by a colorimeter, the color of a printed material obtained by printing according to each density value.

As is apparent from FIG. 6A, even if the amount of yellow ink to be applied onto the print medium is increased, a brightness change is gentle, as compared with paper white. On the other hand, if black ink is applied, even if the application amount is small, a brightness change is large. As is apparent from FIG. 6B, a brightness change of blue as a secondary color of cyan ink and magenta ink is especially large. The luminance Y_53 of the pixel 53 in FIG. 5B representing yellow is 226, which indicates that this pixel is bright. In addition, the luminance Y_54 of the pixel 54 in FIG. 5C representing blue is 29, which indicates that this pixel is dark. The relationship of the luminance obtained by conversion matches the relationship of the brightness of the ink color on the print medium shown in each of FIGS. 6A and 6B. This is the reason for using the luminance value for edge detection.

In step S402, the image analysis unit 210 preforms threshold-based processing for the grayscale image obtained in step S401 to generate an N-arized image representing the result of the threshold-based processing. In this embodiment, the image analysis unit 210 generates a binary image by performing binarization processing. More specifically, the image analysis unit 210 converts the data of the luminance Y into binary data for edge detection. In this way, the image analysis unit 210 converts the luminance image into a binary image.

As an example, the image analysis unit 210 converts the luminance Y into binary data (Bin) using a threshold Th prepared in advance in accordance with a print mode of the printer, as given by expression (2) below. The threshold Th will be described later. The binary data generation expression is merely an example, and the binary conversion method is not particularly limited. For example, the design of an inequality condition and the form of an expression may be different.

$$IF Y > Th : Bin = 0 \qquad ( 2 )$$

$$else : Bin = 1$$

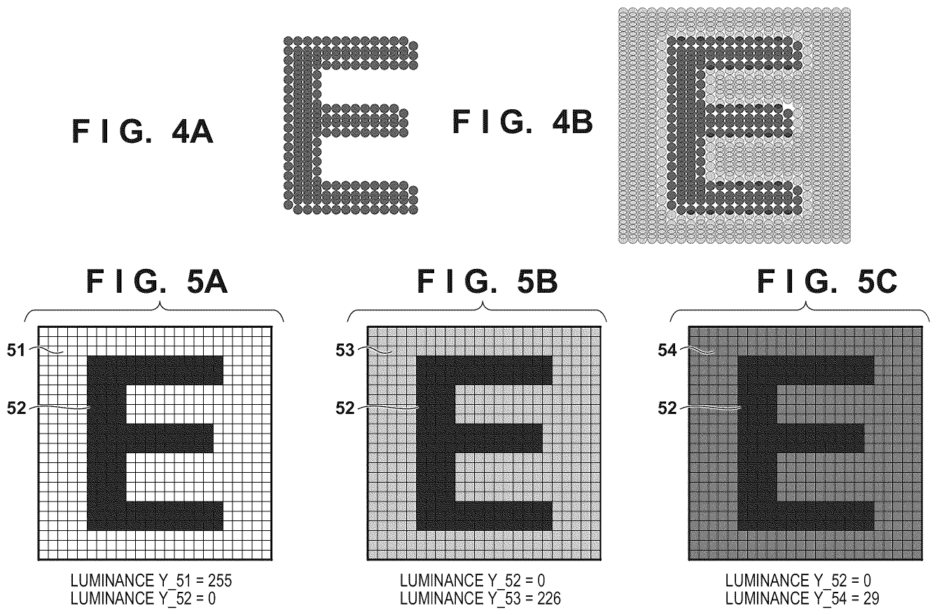

In this embodiment, an edge is detected from the input image, and it is possible to control the number of dots of an ink color forming an edge pixel and the number of dots of an ink color forming an adjacent edge pixel. FIGS. 4A and 4B each show an example of a dot arrangement in a case where such control is executed.

FIG. 4A shows a dot arrangement corresponding to the input image data shown in FIG. 5A. In FIG. 4A, the number of dots is controlled to suppress the application amount of the black ink in the detected edge pixel. As shown in FIG. 4A, by suppressing the application amount of the black ink in the edge pixel, bleeding of the black ink on the print medium is suppressed. Therefore, a high-quality print image with high sharpness is obtained.

In addition, by limiting the application amount of the color ink in the detected adjacent edge pixel, it is possible to suppress bleeding between the colors. FIG. 4B shows a dot arrangement corresponding to the input image data shown in FIG. 5C. In FIG. 4B, the numbers of dots are controlled to suppress the application amount of the black ink in the edge pixel and limit the application amount of the color ink in the adjacent edge pixel.

However, in a case where color pixels as adjacent edge pixels are dark, as shown in FIG. 4B, the contrast in a boundary portion (for example, between the character and the background) decreases by suppressing the application amount of the black ink or color ink in the edge pixel or the adjacent edge pixel. Therefore, the visibility of a printed material may decrease. Especially when a small character or a thin line is printed, the outline of the character or the line is thin, and the tendency of decreasing the visibility is remarkable.

As will be described below, a binary image is generated in accordance with the threshold Th, and an edge is detected based on the binary image. As described above, the luminance Y simulates the brightness of ink on the print medium. Therefore, setting the threshold Th of the luminance Y to be used for binarization is equivalent to designating a brightness region of the background color as an edge detection target. Thus, based on the relationship between the visibility and the brightness of the adjacent edge pixels, the threshold Th can be decided to make it difficult to decrease the visibility.

For example, as shown in FIG. 6A, even if the amount of the yellow ink to be applied onto the print medium increases, a brightness change of a print portion is gentle, and a brightness difference between the print portion and the paper white is small. Therefore, even if both or one of the black ink and the yellow ink is thinned out, the contrast between the pixels 52 to which the black ink is applied and the pixels 53 to which the yellow ink is applied is difficult to decrease. In this case, even if a white portion is generated around the pixels 52, this is difficult to be noticeable. On the other hand, as shown in FIG. 5B, at the boundary between the pixels 53 to which the application amount of the yellow ink is large and the pixels 52 which are adjacent to the pixels 53 and to which the black ink is applied, especially bleeding between the colors is noticeable because of a brightness difference between the inks on the medium. By thinning out both or one of the black ink and the yellow ink, it is possible to improve the sharpness of a black image. Therefore, it is possible to set the threshold Th so that the pixel 52 which is adjacent to the pixel of the luminance Y_53 and to which the black ink is applied is detected as an edge pixel. For example, a binary image can be set near the luminance Y_53. In this case, it is possible to control the number of dots of each color ink for each of the pixels 52 and 53.

In step S403, the image analysis unit 210 detects an edge in the N-arized image obtained in step S402. In this embodiment, the image analysis unit 210 detects an edge pattern in the binary image.

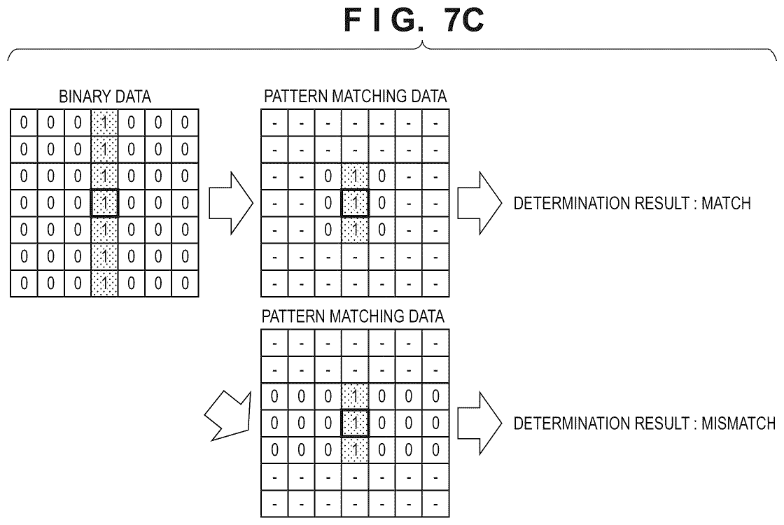

FIGS. 7A and 7B each show an example of pattern information for edge pattern detection. The pattern information includes two types of information, that is, “pattern matching data generation information” and “edge pattern detection result generation information”. The pattern matching data generation information is obtained by executing bit AND processing for each pixel in a rectangular region of the binary data obtained in step S402. Pattern matching data obtained as a result of the bit AND processing is obtained by extracting only information necessary to detect an edge pattern from the rectangular region. The edge pattern detection result generation information is information for executing pattern matching processing for the pattern matching data. If a complete match is obtained as a result of the pattern matching processing, the rectangular region is determined as a predetermined edge pattern. The determination result is linked with the central pixel in the rectangular region.

FIG. 7A shows pattern information for determining that a target pixel is “in a left/right edge portion of a 1-dot vertical line”. The pattern matching data generation information is set with values so as to perform edge pattern detection for 3×3 pixels including the target pixel. A pixel added with “0” in the pattern matching data generation information is regarded as a pixel that is not considered in pattern matching regardless of how the binary data is formed. Next, the edge pattern detection result generation information corresponds to the above-described predetermined edge pattern, and is, in this example, a pattern in which only three pixels in a central vertical column among the 3×3 pixels are set with 1. This information corresponds to determination of whether the three pixels in the central vertical column have a low luminance and the remaining six pixels have a high luminance. If pattern matching data completely matches this pattern, it is found that there exist high-luminance pixels at least on the left and right sides and low-luminance pixels in the target pixel and the upper and lower pixels thereof.

It is found from FIG. 7B that the target pixel is not only “in the left/right edge portion of a 1-dot vertical line” but also “in a part of 1 dot/1 space”. “1 dot/1 space” indicates a pattern in which a plurality of 1-dot vertical lines are arranged at an interval of 1 dot. By widening the range of the pattern matching data generation information to 7×3 pixels, information concerning the periphery of the 1-dot line to which the target pixel belongs can be included for determination.

FIG. 7C shows a result of successively performing pattern matching for the binary data using FIGS. 7A and 7B. When applying the pattern matching data generation information and the edge pattern detection result generation information shown in FIG. 7A to the target binary data, a determination result is determined as “match”. When applying the pattern matching data generation information and the edge pattern detection result generation information shown in FIG. 7B to the target binary data, a determination result is determined as “mismatch”. Based on the two pattern detection results, it is found that the target binary data is “in the left/right edge portion of a 1-dot vertical line” but “not in a part of 1 dot/1 space”.

Based on the above-described method, it is possible to detect various edge patterns. In this embodiment, 7×7 pixels are set as the target of pattern matching, but this is merely an example. If, for example, it is only necessary to be able to detect the patterns shown in FIGS. 7A and 7B, 7×3 pixels suffice as the target of pattern matching. On the other hand, if it is desirable to individually detect a line shape of a 4- or more-dot line, 7×7 pixels are insufficient and a wider region may be set as a target. By widening the target range, a work memory for holding binary data to be compared and a work memory for holding pattern information are required more. The work memory corresponds to the RAM 207. In a case where the image analysis unit 210 is implemented as a dedicated circuit, when it is desirable to process a plurality of pixels by performing pattern matching by a parallel clock, the numbers of processing registers and processing circuits increase. Furthermore, since it is necessary to hold in advance the pattern information in a ROM 206 of the image processing apparatus 100, the capacity of the ROM 206 is also required. If the edge pattern is finely and diversely confirmed, more pattern information needs to be held, and thus design is performed in consideration of the memory capacity and an increase in analysis time caused by an increase in number of times of comparison.

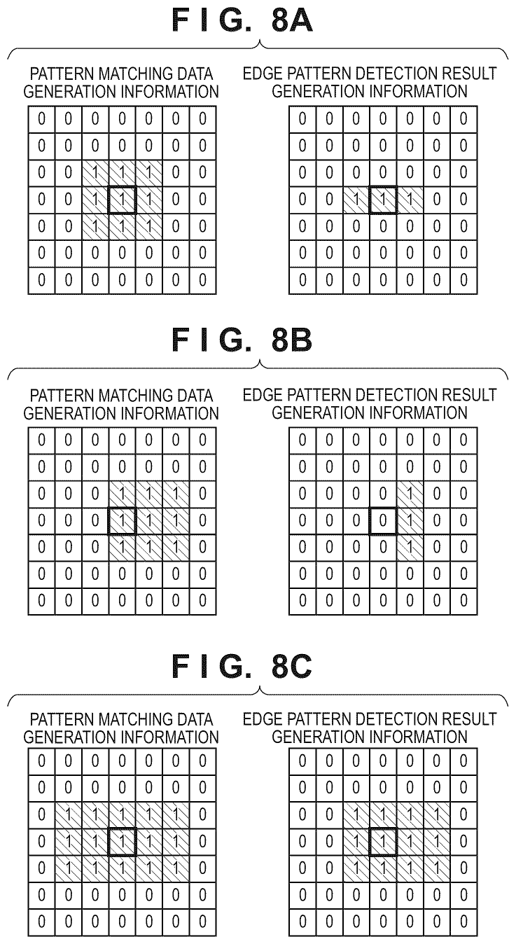

Performing a determination of “0” in the pattern matching data generation information=“not considered in pattern matching” contributes to a decrease in memory capacity and a decrease in number of times of comparison. As another way for decreasing the memory capacity, as shown in FIGS. 8A to 8C, it is also possible to perform pattern matching of another variation by processing such as rotation or phase shifting. In FIG. 8A, the pattern information shown in FIG. 7A is rotated by 90°, and it is possible to determine that the target pixel is “in the upper/lower edge portion of a 1-dot horizontal line” using the processed pattern information.

Furthermore, by devising the pattern information, as shown in FIG. 8C, it is possible to detect “an adjacent pixel on the right side of a leftmost pixel” as an edge pixel. By rotating the pattern shown in FIG. 8C, it is also possible to detect “an adjacent pixel on the left side of a rightmost pixel”, “an adjacent pixel on the lower side of an uppermost pixel”, and “an adjacent pixel on the upper side of a lowermost pixel”. By this method, it is possible to detect the second pixel from the endmost pixel in addition to the endmost edge pixel. That is, it is possible to detect two pixels from the end as edge pixels.

In FIGS. 8A to 8C, variations are increased by processing the pattern information. However, variations can be increased by processing the binary data.

As shown in FIG. 7C, it is effective to narrow a determination result by successively applying a plurality of pieces of pattern information and to obtain information that is not known by individual pattern information. For example, when “match” with the pattern shown in FIG. 7A is determined in FIG. 7C, it may be unnecessary to perform determination with respect to a 2- or more-dot line prepared in advance. An effect of decreasing the number of times of comparison is obtained by applying only the pattern information for determining more detailed information of the 1-dot line, as shown in FIG. 7B. By applying FIGS. 7A and 7B, it is found that the target binary data is “in the left/right edge portion of a 1-dot vertical line” and “not in a part of 1 dot 1 space”. Not by preparing obtainable individual pattern information but by deriving that information from the results of FIGS. 7A and 7B, an effect of reducing the memory capacity is obtained.

Furthermore, the image analysis unit 210 may further detect a pixel adjacent to the edge portion detected as described above. For example, the image analysis unit 210 can detect such pixel using the pattern information. In FIG. 8B, the pattern information shown in FIG. 7A is horizontally shifted by one pixel, and it is possible to determine that the target pixel is “an adjacent pixel of a 1-dot vertical line” using the processed pattern information. Furthermore, the image analysis unit 210 may further detect an adjacent edge pixel based on the detection result of the edge pixel.

As described above, in this embodiment, it is possible to determine whether the target pixel is a pixel to undergo special processing such as processing of thinning out dots or processing of changing the arrangement of dots. This processing for detecting the edge from the binary data is merely an example, and another detection method may be used.

The determination result of the image analysis processing in step S303 is output in an information format suitable for processing in a subsequent step. For example, the determination result can be expressed by 3-bit multi-valued data such as non-detection (non-appropriate for any detection pattern)=0, upper edge portion detection=1, lower edge portion detection=2, left edge portion detection=3, right edge portion detection=4, and adjacent to one of edge portions=5. Alternatively, expression of assignment of each bit within 5 bits is also possible, such as non-detection=00000, upper edge portion detection=00001, lower edge portion detection=00010, left edge portion detection=00100, right edge portion detection=01000, and adjacent to one of edge portions=10000. The former can transmit the determination result to the next processing with a small data amount. The latter has a merit of reducing the processing load since bit processing can be used in the next processing. It has been explained that the five pieces of information are transmitted to the subsequent step. However, as described in step S303 that “the pattern information can diversely be expressed”, information more than control information necessary for the subsequent processing steps may be detected and transmitted.

A case where the image analysis unit 210 detects a pixel in the edge endmost portion in step S303 will be described below. In an embodiment, the image analysis unit 210 can detect an edge pixel by the above-described method. In another embodiment, the image analysis unit 210 can separately detect a pixel in the upper edge portion, a pixel in the left edge portion, a pixel in the lower edge portion, and a pixel in the right edge portion. Then, the image analysis unit 210 can output an edge determination result for each pixel. A pixel in each of the upper edge portion, the left edge portion, the lower edge portion, and the right edge portion is a pixel in a region having pixel values of “1” in the binary image, and indicates a pixel in each of the upper edge portion, the left edge portion, the lower edge portion, and the right edge portion of the region.

For example, the image analysis unit 210 can output “1” as a determination result for a pixel in the upper edge portion or the left edge portion. The image analysis unit 210 can output “2” as a determination result for a pixel in the lower edge portion or the right edge portion. Furthermore, the image analysis unit 210 can output “0” as a determination result for a pixel that does not correspond to the above pixels. In this embodiment, however, it is not necessary to discriminate between the pixel in the upper edge portion or the left edge portion and the pixel in the lower edge portion or the right edge portion.

In addition, the image analysis unit 210 can detect an adjacent edge pixel by the above-described method. In the following description, the adjacent edge pixel is a pixel in a region having pixel values “0” in the binary image, and indicate a pixel adjacent to the edge pixel. In an embodiment, each adjacent edge pixel is adjacent on the upper, left, lower, or right side of the edge pixel. In this example, the pixel value of the edge pixel in the grayscale image is smaller than the pixel value of the adjacent edge pixel. However, in this embodiment, it is not necessary to detect the adjacent edge pixel.

The information indicating the relationship between each pixel and an edge will sometimes be referred to as edge information hereinafter. This edge information can indicate whether each pixel forms an edge. Furthermore, this edge information can indicate the type of the edge (for example, the upper edge or lower edge) formed by each pixel. In addition, this edge information can indicate whether each pixel is adjacent to a pixel forming an edge. This edge information can indicate the classification of each pixel (for example, an edge pixel in the upper edge portion, the left edge portion, the lower edge portion, or the right edge portion, or an adjacent edge pixel).

In steps S304 to S306, a color separation/quantization unit 211 and a nozzle separation processing unit 212 generate, from the value of a pixel of interest of the input image, print data corresponding to at least one color with respect to the pixel of interest. In this embodiment, for each pixel of the input image, print data corresponding to C, M, Y, and K is generated. In this embodiment, in accordance with the edge detection result, print data is generated for at least one color. In the following example, in accordance with the edge detection result, print data corresponding to K is generated. Especially, in this embodiment, by a method corresponding to whether the pixel of interest of the input image is at an edge, print data corresponding to at least one color with respect to the pixel of interest is generated from the value of the pixel of interest of the input image. In the following example, by a method corresponding to whether the pixel of interest of the input image is in a first edge portion or a second edge portion, print data corresponding to K with respect to the pixel of interest is generated from the value of the pixel of interest of the input image.

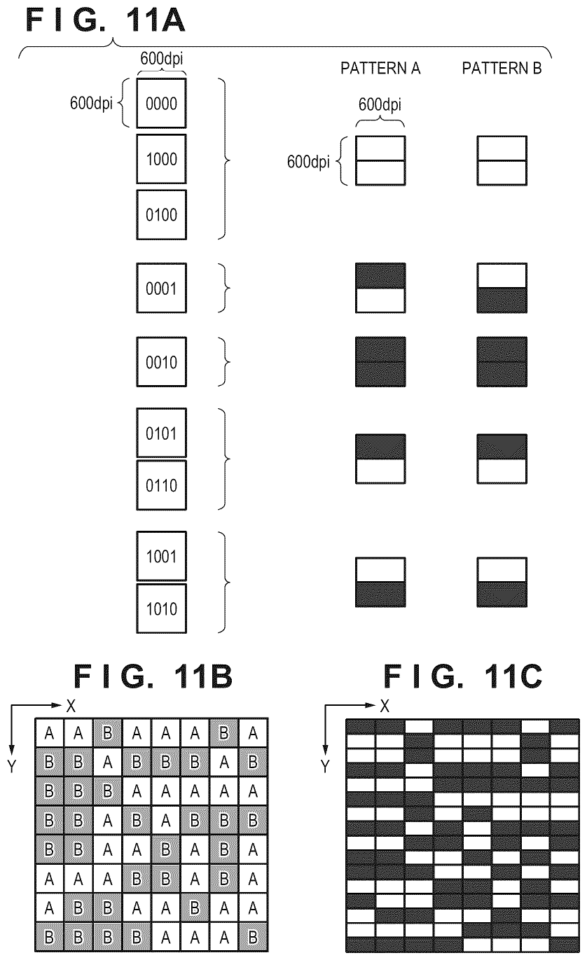

FIG. 10 is a flowchart of color separation processing in step S304 and quantization processing in step S305, which are executed by the color separation/quantization unit 211.

In step S1001, the color separation/quantization unit 211 performs color correction processing for the bitmap image obtained in step S302. In this example, the bitmap image is data of three channels of R, G, and B, and has a 8-bit, 256-level pixel value for each of R, G, and B. In step S1001, the color separation/quantization unit 211 converts the RGB data of the input image data into device R′G′B′ data in a color space unique to the printing apparatus. The color separation/quantization unit 211 can perform conversion by a method of, for example, referring to a lookup table (LUT) stored in advance in the memory.

Next, in step S1002, the color separation/quantization unit 211 separates the color data of the image into ink color data. The color separation/quantization unit 211 can separate the converted R′G′B′ data into 8-bit density data of four colors of C (cyan), M (magenta), Y (yellow), and K (black) that are the ink colors of the printing apparatus. At this stage, single-channel gray images of four planes are generated, and the gray images of the 4 planes correspond to the four colors, respectively. Each gray image indicates the density value of each pixel. For example, the color separation/quantization unit 211 can perform the separation processing by a method of, for example, referring to a lookup table (LUT) stored in advance in the memory. Processing for a density value K of the K plane will be described below. The same processing is performed for density values C, M, and Y of the C, M, and Y planes unless otherwise specified.

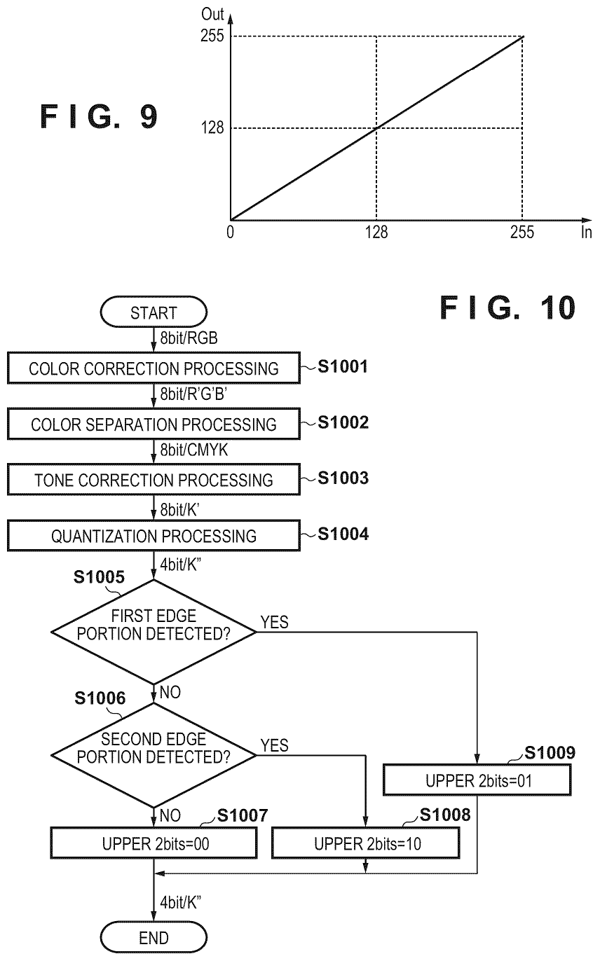

In step S1003, the color separation/quantization unit 211 performs tone correction processing for the density value K. For example, the color separation/quantization unit 211 can obtain a density value K′ by performing, for the density value K, tone correction processing using a tone correction table. The tone correction processing is performed so that the input density value and an optical density expressed on the print medium have a linear relationship. FIG. 9 shows an example of setting of the tone correction processing. In FIG. 9, In corresponds to the density value K that is the input value to the tone correction processing, and Out corresponds to the density value K′ that is the output value of the tone correction processing. For the sake of descriptive simplicity, FIG. 9 shows an example in which In and Out have a linear relationship.

In step S1004, the color separation/quantization unit 211 performs quantization processing for the density value K′. For example, the color separation/quantization unit 211 performs predetermined quantization processing for the density value K′ to generate 4-bit 3-valued quantization data of “0000”, “0001”, or “0010”. Similarly, the color separation/quantization unit 211 performs quantization processing for density values C′, M′, and Y′ to generate 4-bit 3-valued quantization data C″, M″, and Y″ of “0000”, “0001”, or “0010”.

In steps S1005 to S1009, the color separation/quantization unit 211 sets a value representing the determination result obtained in step S303 in the quantization data obtained in step S1004. The color separation/quantization unit 211 sets a value in the upper 2 bits of the quantization data based on the edge information of the pixel to be processed. Then, the color separation/quantization unit 211 outputs 4-bit quantization data K″. This quantization data can be called color separation data corresponding to a recording material used by the printing apparatus for printing. This data represents a recording amount (lower 2 bits) for each pixel and an edge detection result (upper 2 bits) for each pixel.

More specifically, in step S1005, the color separation/quantization unit 211 determines whether the pixel is in the upper edge portion or the left edge portion. The upper edge portion or the left edge portion will be referred to as the first edge portion hereinafter. If it is detected that the pixel is in the first edge portion, the process advances to step S1009. In step S1009, the color separation/quantization unit 211 sets a value “01” in the upper 2 bits.

If it is not detected that the pixel is in the first edge portion, the color separation/quantization unit 211 determines in step S1006 whether the pixel is in the lower edge portion or the right edge portion. The lower edge portion or the right edge portion will be referred to as the second edge portion hereinafter. If it is detected that the pixel is in the second edge portion, the process advances to step S1008. In step S1008, the color separation/quantization unit 211 sets a value “10” in the upper 2 bits. If it is not detected that the pixel is in the second edge portion, the process advances to step S1007. In step S1007, the color separation/quantization unit 211 sets a value “00” in the upper 2 bits.

On the other hand, in this embodiment, the color separation/quantization unit 211 does not add edge information representing the edge determination result to the upper 2 bits of each of the quantization data C″, M″, and Y″. Therefore, each of the quantization data C″, M″, and Y″ is “0000”, “0001”, or “0010”. The quantization data C″, M″, and Y″ will collectively be referred to as quantization data CL″ hereinafter.

In step S306, the nozzle separation processing unit 212 generates nozzle data to be used as print data. The nozzle separation processing unit 212 generates nozzle data by performing index expansion processing for the quantization data K″ obtained in step S305. In the index expansion processing in this embodiment, the quantization data K″ of 600×600 dpi is converted into composite nozzle data Kp of 600×1200 dpi using an index pattern prepared in advance. In this example, data of one pixel is converted into data of two pixels connected in the vertical direction. In this way, in this embodiment, composite nozzle data of a resolution higher than that of the quantization data is generated based on the multi-valued quantization value (more than two values, and three values in this embodiment) of the quantization data. Furthermore, the composite nozzle data includes data of a plurality of pixels (two pixels in this embodiment) corresponding to one pixel of the input image.

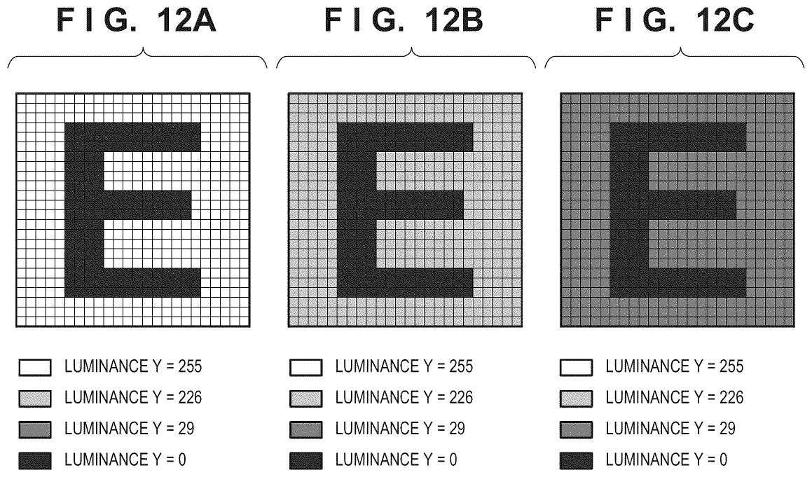

In this embodiment, by the method corresponding to whether the pixel of interest of the input image is in the first edge portion or the second edge portion, the nozzle separation processing unit 212 generates print data corresponding to K with respect to the pixel of interest from the quantization data K″ obtained based on the value of the pixel of interest of the input image. The nozzle separation processing unit 212 generates the nozzle data K based on the detection result of the edge pixel (that is, the first edge portion and the second edge portion). In the following example, such control is executed based on a dot arrangement pattern and a reference index pattern. FIGS. 11A to 11C show examples of the dot arrangement pattern used in the index expansion processing and the reference index pattern. FIG. 11A shows the dot arrangement pattern of the composite nozzle data Kp obtained by the index expansion processing.

If the quantization data K″ indicates “0000”, “0100”, or “1000”, no dot is arranged in either of the two pixels.

If the quantization data K″ indicates “0001”, a dot is arranged in the upper pixel of the two pixels in pattern A, and a dot is arranged in the lower pixel of the two pixels in pattern B. If the quantization data K″ indicates “0010”, dots are arranged in both the two pixels.

If the quantization data K″ indicates “0101” or “0110”, a dot is arranged in the upper pixel of the two pixels and no dot is arranged in the lower pixel of the two pixels. If the quantization data K″ indicates “1001” or “1010”, a dot is arranged in the lower pixel of the two pixels and no dot is arranged in the upper pixel of the two pixels.

Focus is placed on a case where the quantization data K″ indicates “0010”, “0110”, or “1010”. As described above, a value according to the detection result obtained in step S403 is added as edge information to the upper 2 bits of the quantization data K″. This edge information indicates the detection result of the edge pixel (that is, the first edge portion and the second edge portion). In this example, although the lower 2 bits have a common value “10”, the arrangement and number of dots change in accordance with the value of the upper 2 bits. That is, if the quantization data K″ indicates “0010”, dots are arranged in both the upper and lower pixels. On the other hand, if the quantization data K″ indicates “0110” or “1010”, a dot is arranged only in the upper pixel or the lower pixel. In this way, even if the quantization value obtained in step S1004 is the same, the method of generating print data is controlled in accordance with the value of the upper 2 bits of the quantization data K″. More specifically, in this embodiment, the number of dots is controlled in accordance with the value of the upper 2 bits of the quantization data K″. In this example, if it is determined that the pixel is at the edge (in the first edge portion or the second edge portion), the nozzle separation processing unit 212 generates print data so that the recording amount for the pixel decreases, as compared with a case where it is determined that the pixel is not at the edge. As described above, to control the number of dots, it is not necessary to discriminate between the first edge portion and the second edge portion. On the other hand, in this embodiment, the arrangement of dots is also controlled in accordance with the value of the upper 2 bits of the quantization data K″. As described above, in this embodiment, the number or arrangement of dots can be controlled based on the edge information.

In this embodiment, with respect to the quantization data K″, if the pixel is not at the edge (the upper 2 bits of the quantization data are “00”), up to two dots are arranged in this pixel. In this case, the maximum recording rate is 100%. If the pixel is at the edge (in the first edge portion or the second edge portion) (the upper 2 bits of the quantization data are “01” or “10”), up to one dot is arranged in this pixel. Therefore, the maximum recording rate is 50%. The maximum recording rate can be a ratio of the number of dots that can be arranged under a specific condition to the number of dots that can be arranged in one pixel when generating nozzle data. In this way, the nozzle separation processing unit 212 can generate print data so that the maximum recording amount (that is, the number of dots) for the pixel at the edge is smaller than the maximum recording amount for the pixel not at the edge. Furthermore, the nozzle separation processing unit 212 can generate print data so that the maximum recording rate for the pixel at the edge is lower than the maximum recording rate for the pixel not at the edge.

FIG. 11B shows the reference index pattern. Each rectangle corresponds to one pixel of 600 dpi×600 dpi. This reference index pattern determines which of patterns A and B is used to arrange a dot in each pixel.

FIG. 11C shows the binary composite nozzle data (600 dpi in the X direction and 1,200 dpi in the Y direction) obtained by performing the index expansion processing in a case where all the quantization data of each pixel indicate “0001”. The nozzle separation processing unit 212 assigns data (nozzle data K1p) of the upper pixel of the composite nozzle data Kp corresponding to the quantization data K″ of one pixel to the Ev nozzle of a black nozzle array 2701 corresponding to the pixel. In addition, the nozzle separation processing unit 212 assigns data (nozzle data K2p) of the lower pixel of the composite nozzle data Kp corresponding to the quantization data K″ of one pixel to the Od nozzle of the black nozzle array 2701 corresponding to the pixel. Then, with respect to one pixel of the input image, printing at the upper position using the Ev nozzle and printing at the lower position using the Od nozzle are executed. In this way, based on the quantization data for one pixel of the input image, the nozzle separation processing unit 212 generates print data (that is, data of two pixels connected in the vertical direction) for a plurality of positions corresponding to the pixel.

Furthermore, the nozzle separation processing unit 212 generates composite nozzle data Cp, Mp, and Yp for the color inks by similarly performing the index expansion processing for the quantization data C″, M″, and Y″ obtained in step S305.

With the above processing, composite nozzle data of 600×1200 dpi is obtained based on each pixel of the input image data of 600×600 dpi. This composite nozzle data designates printing/non-printing by each nozzle of the black nozzle array 2701. For printing on the print medium, the printhead H can discharge ink in accordance with the nozzle data. That is, data of a plurality of pixels (two pixels in this embodiment) corresponding to one pixel of the input image, which is held by the composite nozzle data, indicates the number of ink dots used for printing of the pixel. In a case where the maximum number of ink dots corresponding to one pixel of the input image, which is indicated by the composite nozzle data, is M (2 dots in this embodiment), the nozzle separation processing unit 212 can limit the number of ink dots for the pixel at the edge to a number less than M.

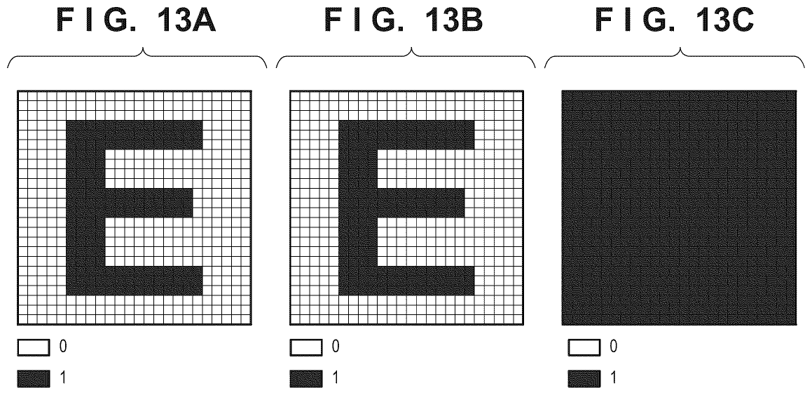

Processing of converting the image data shown in each of FIGS. 5A to 5C into nozzle data in accordance with the flowchart shown in FIG. 3A will further be described with reference to FIGS. 12A to 17C. FIGS. 12A to 12C show images obtained by performing, in step S401, luminance conversion for the image data shown in FIGS. 5A to 5C, respectively. A luminance image obtained from the input image shown in FIG. 5A is formed by pixels of the luminance value Y=255 and pixels of the luminance value Y=0, as shown in FIG. 12A. A luminance image obtained from the input image shown in FIG. 5B is formed by pixels of the luminance value Y=226 and pixels of the luminance value Y=0, as shown in FIG. 12B. A luminance image obtained from the input image shown in FIG. 5C is formed by pixels of the luminance value Y=29 and pixels of the luminance value Y=0, as shown in FIG. 12C.

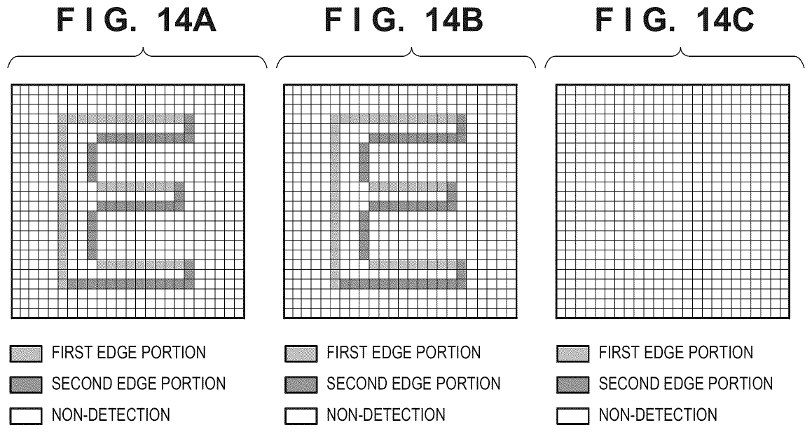

FIGS. 13A to 13C show binary images obtained by performing, in step S402, binarization processing for the luminance images shown in FIGS. 12A to 12C using the threshold Th=225, respectively. The binary images shown in FIGS. 13A to 13C correspond to the luminance images shown in FIGS. 12A to 12C, respectively. Since the luminance image shown in FIG. 12C is formed by pixels of the luminance Y=29 and pixels of the luminance Y=0, all the pixel values are converted into “1” by the binarization processing.

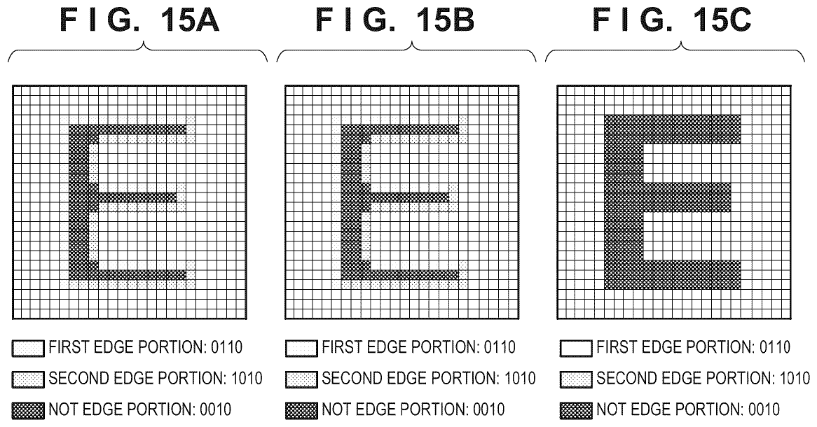

FIGS. 14A to 14C show results of the edge detection processing performed, in step S403, for the respective pixels of the binary images shown in FIGS. 13A to 13C, respectively. Each of FIGS. 14A to 14C shows edge information for each pixel. As shown in FIGS. 14A and 14B, edge portions are detected from the binary images shown in FIGS. 13A and 13B. On the other hand, as shown in FIG. 14C, no edge portions are detected from the binary image shown in FIG. 13C. In this way, the edge of the black character “E” adjacent to a high-density color having the luminance Y=26 is not detected. Thus, to an edge pixel of the black character “E”, edge information representing that this pixel is an edge pixel is not added.

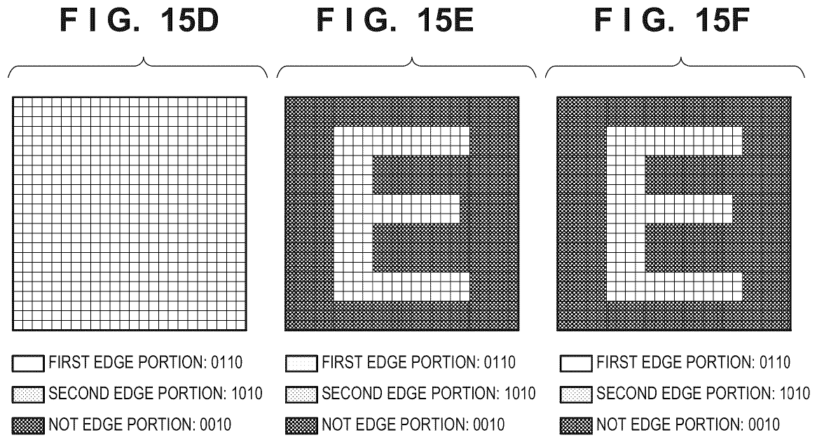

FIGS. 15A to 15F show quantization data obtained by performing the processes of steps S304 and S305 using the edge information shown in FIGS. 14A to 14C. FIGS. 15A to 15C show the quantization data K″ corresponding to the image data shown in FIGS. 5A to 5C, respectively. FIGS. 15D to 15F show the quantization data CL″ corresponding to the image data shown in FIGS. 5A to 5C, respectively.

In the quantization data K″, pixels detected as the first edge portion and the second edge portion are assigned with values “0110” and “1010”, respectively. In addition, a pixel that is not detected as the edge portion is assigned with a value “0010”. In the quantization data K″ obtained from the image data shown in FIG. 5C from which no edge portions are detected, as shown in FIG. 14C, the values of all the pixels corresponding to the black character “E” are “0010”. As described above, a value based on the edge information is not set in the upper 2 bits of the quantization data CL″. Therefore, in the quantization data CL″ shown in FIGS. 15E and 15F, the values of all the pixels corresponding to the color data are “0010”. Note that pixels for which the lower 2 bits of the quantization data are “00” are not shown.

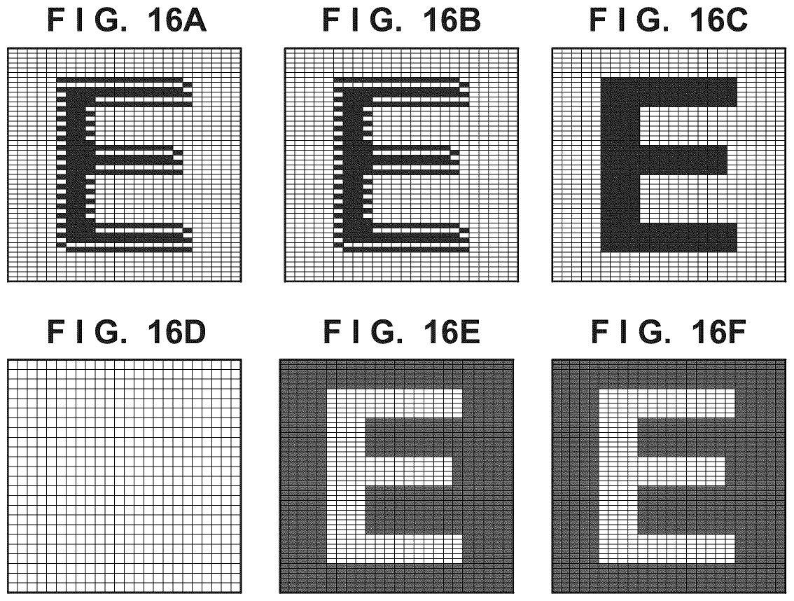

FIGS. 16A to 16F show dot arrangement patterns corresponding to the quantization data K″ shown in FIGS. 15A to 15C and the quantization data CL″ shown in FIGS. 15D to 15F, that are obtained by performing the index expansion processing in step S306. In the dot arrangement pattern K shown in each of FIGS. 16A and 16B, the number and arrangement of dots are controlled in accordance with the edge information. As compared with FIGS. 16A and 16B, it is found that in the dot arrangement pattern K shown in FIG. 16C as well, the number and arrangement of dots are controlled in accordance with the edge information representing that each pixel is not an edge pixel. Note that in this embodiment, the number of dots in the dot arrangement pattern CL is not controlled.

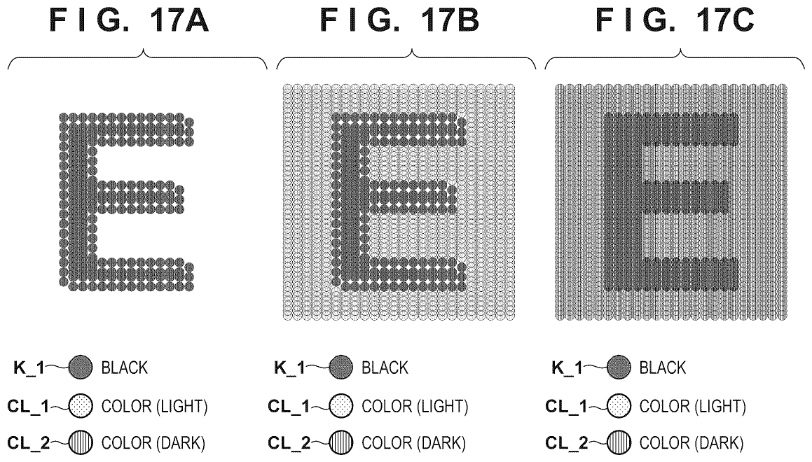

FIGS. 17A to 17C show final dot arrangements obtained by performing the processes of steps S301 to S306 for the input images shown in FIGS. 5A to 5C, respectively. FIG. 17A corresponds to FIG. 5A, and shows the dot arrangement in a case where the adjacent color of the black character “E” formed by black dots indicated by K_1 is white. It is found that the number and arrangement of dots of the edge region are controlled based on a value representing the edge information added to each pixel of the quantization data. This processing can suppress bleeding of black ink K in the edge pixels on the print medium and suppress a decrease in sharpness of the character.

FIG. 17B corresponds to FIG. 5B, and shows the dot arrangement in a case where the density of a color dot of ink CL_1 adjacent to the black character “E” formed by black dots indicated by K_1 is low. In FIG. 17B, CL_1 is the yellow ink. It is found that the number and arrangement of dots corresponding to the edge pixel of the black character “E” are controlled, similar to FIG. 17A. This processing can suppress bleeding of the black ink K. It is also possible to suppress bleeding between the black ink K and the adjacent yellow ink CL_1.

FIG. 17C corresponds to FIG. 5C, and shows the dot arrangement in a case where the density of a color dot of ink CL_2 adjacent to the black character “E” formed by black dots indicated by K_1 is high. In FIG. 17C, CL_2 is formed by magenta ink and cyan ink. Unlike FIGS. 17A and 17B, in this example, no edge pixels are detected. Therefore, the number and arrangement of dots corresponding to all the pixels forming the black character “E” are controlled, similar to non-edge pixels. In this case, if the number of dots of the black ink forming the edge pixel is controlled, the outline of the character is thin especially in a case where a character size is small, and thus the contrast between the character and the background may decrease, thereby decreasing visibility. According to this embodiment, if the luminance of a pixel adjacent to an edge pixel is lower than a predetermined threshold, edge information representing that this pixel is an edge pixel is not added. Therefore, it is possible to suppress visibility from decreasing or a noticeable white frame from appearing around the black character.

Note that according to the dot arrangement pattern shown in FIG. 11A, the dot arrangement is controlled in accordance with whether the pixel is in the first edge portion (upper 2 bits=“01”) or the second edge portion (upper 2 bits=“10”). More specifically, if the pixel is in the first edge portion (upper edge portion or left edge portion), printing is executed at the upper position of the plurality of print positions and no printing is executed at the lower position. Alternatively, if the pixel is in the second edge portion (lower edge portion or right edge portion), printing is executed at the lower position and no printing is executed at the upper position. By performing such dot arrangement control, the position of each edge is readily aligned, as compared with a case where dots are randomly thinned out, as shown in FIG. 17A.

In this example, if the pixel is in the first edge portion (upper edge portion or left edge portion), it is not necessary to always execute printing at the upper position. For example, by biasing the dot arrangement to one of the plurality of print positions in accordance with the edge information, the same effect is obtained. In an embodiment, printing at a position adjacent to the second edge pixel, among the plurality of print positions corresponding to the first edge pixel, is executed more than printing at a position not adjacent to the second edge pixel. The nozzle separation processing unit 212 can generate print data for a color of a first group in this way. In this embodiment, in the composite nozzle data having a resolution higher than those of the input image and the quantization data, the number of dots is controlled based on the edge information. Therefore, if the quantization value obtained in step S1004 with respect to the edge pixel is 0, 1, or 2, control can be performed to set the number of dots for the edge pixel to 0, 1, or 1. However, it is not necessary to control the number of dots in data of a high resolution. For example, in step S1004, a binary (0 or 1) quantization value may be obtained. Then, the number of dots may be controlled (thinned out) so that the number of dots for a half of the edge pixels with a quantization value of 1 is 0 and the number of dots for the remaining edge pixels is 1.

According to this embodiment, the number of dots of the edge region is controlled based on the edge information detected using the N-arized image representing the result of the threshold-based processing for the grayscale image (for example, the luminance image). Therefore, it is possible to suppress secondary deterioration in image quality such as a decrease in visibility while improving sharpness of a printed image such as a character or line.

### First Modification

In the above-described embodiment, the number and arrangement of dots applied to an edge pixel are controlled. A configuration of controlling the number and arrangement of dots applied to an adjacent edge pixel will be described below.

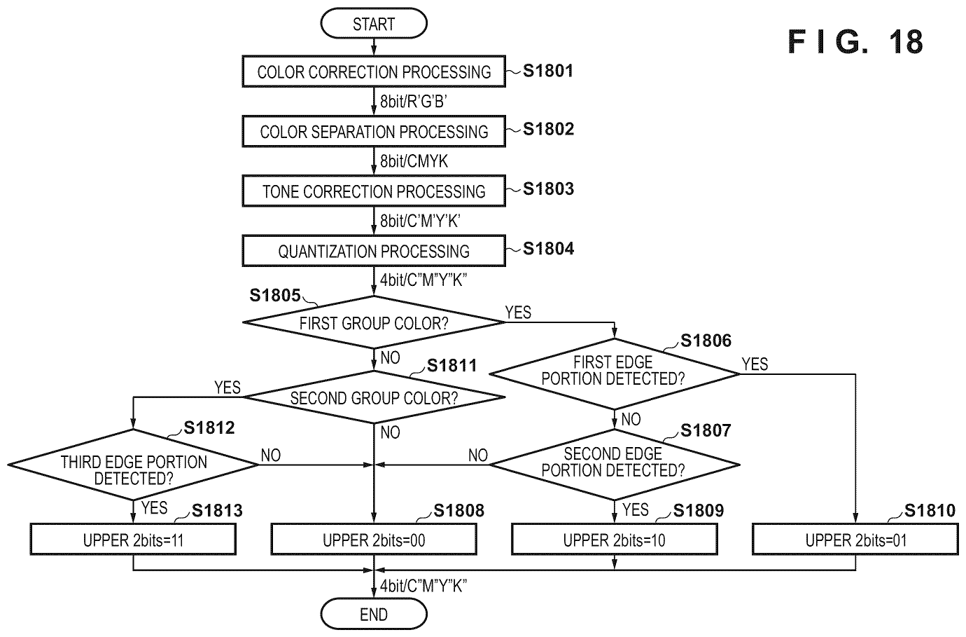

FIG. 18 is a flowchart of the color separation processing in step S304 and the quantization processing executed in step S305, which are executed by the color separation/quantization unit 211 according to this modification. Steps S1801 to S1804 are performed, similar to steps S1001 to S1004.

In steps S1805 to S1813, the color separation/quantization unit 211 sets a value representing the determination result obtained in step S303 in quantization data obtained in step S1804. That is, the color separation/quantization unit 211 outputs the 4-bit quantization data C″, M″, Y″, and K″ by setting a value in the upper 2 bits of each quantization data based on the edge information. The processes of steps S1805 to S1813 are performed for each of the quantization data C″, M″, Y″, and K″. At this time, the color separation/quantization unit 211 decides the value of the upper 2 bits by processing corresponding to each color. The plurality of colors used for printing can be classified into two or more groups including the first group and the second group. Then, the color separation/quantization unit 211 can perform different processing for each color group. In the following description, K is defined as a first group color, Y is defined as a second group color, and C and M are defined as third group colors.

In step S1805, the color separation/quantization unit 211 determines whether the quantization data to be processed corresponds to the first group color. If the quantization data to be processed corresponds to the first group color, the process advances to step S1806; otherwise, the process advances to step S1811. With respect to the quantization data K″ of the first group color, the value of the upper 2 bits is set by the processes of steps S1806 to S1810. These processes are the same as in steps S1005 to S1009.

In step S1811, the color separation/quantization unit 211 determines whether the quantization data to be processed corresponds to the second group color. If the quantization data to be processed corresponds to the second group color, the process advances to step S1812; otherwise, the process advances to step S1808. With respect to the quantization data Y″ of the second group color, the value of the upper 2 bits is set by the processes of steps S1812, S1813, and S1808.

In step S1812, the color separation/quantization unit 211 determines whether the pixel is an adjacent edge pixel. As described above, the image analysis unit 210 can detect an adjacent edge pixel. A portion adjacent to the first edge portion or the second edge portion will be referred to as a third edge portion hereinafter. For example, the first edge portion and the third edge portion or the second edge portion and the third edge portion correspond to two sides of an edge. The third edge portion can exist in a region having a pixel value “0” in the binary image. In this example, the adjacent edge pixel is a pixel in the third edge portion. The edge pixel and the adjacent edge pixel corresponding to two sides of the edge are adjacent to each other, and the value of the edge pixel is different from the value of the adjacent edge pixel in the binary image. If the pixel is in the third edge portion, the process advances to step S1813. In step S1813, the color separation/quantization unit 211 sets a value “11” in the upper 2 bits. If the pixel is not in the third edge portion, the process advances to step S1808, and the color separation/quantization unit 211 sets a value “00” in the upper 2 bits.

If the quantization data to be processed corresponds to the third group color, the process advances to step S1808. That is, the color separation/quantization unit 211 sets a value “00” in the upper 2 bits of each of the quantization data C″ and M″ of the third group colors.

In step S306, the nozzle separation processing unit 212 performs the index expansion processing for the quantization data C″, M″, Y″, and K″ output in step S305, similar to the above embodiment. As described above, the quantization data for the first group color is added with edge information representing the detection result of the edge pixel (that is, the first edge portion and the second edge portion). Therefore, the nozzle separation processing unit 212 can generate print data for the first group color based on the detection result of the edge pixel.

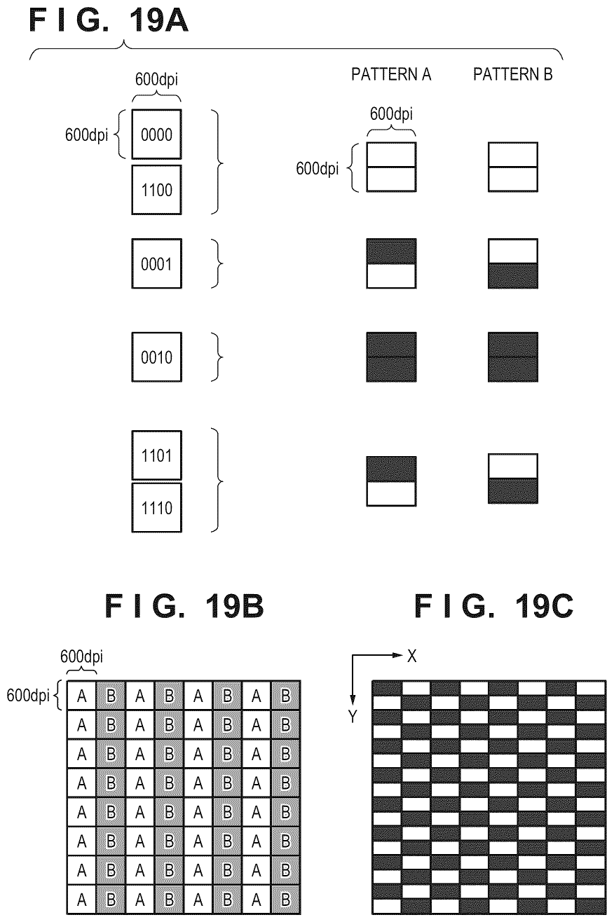

FIGS. 19A to 19C show examples of the dot arrangement pattern used in the index expansion processing for the quantization data Y″ corresponding to the second group color, and the reference index pattern. Note that for the index expansion processing for the quantization data K″ corresponding to the first group color, the dot arrangement pattern used in the index expansion processing and the reference index pattern that are shown in FIGS. 11A to 11C are used.

FIG. 19A shows a dot arrangement pattern indicated by the composite nozzle data Yp obtained by performing the index expansion processing corresponding to the quantization data Y″. If the quantization data Y″ indicates “0000” or “1100”, no dot is arranged in either of the two pixels.

If the quantization data Y″ indicates “0001”, a dot is arranged in the upper pixel of the two pixels in pattern A, and a dot is arranged in the lower pixel of the two pixels in pattern B. If the quantization data Y″ indicates “0010”, dots are arranged in both the two pixels. These are the same as in the dot arrangement pattern shown in FIG. 11A.

If the quantization data Y″ indicates “1101” or “1110”, a dot is arranged in the upper pixel of the two pixels in pattern A and a dot is arranged in the lower pixel of the two pixels in pattern B, similar to “0001”.

As described above, although “1110” and “0010” have common lower 2 bits “10”, the arrangement and number of dots change in accordance with the value of the upper 2 bits. That is, if the quantization data Y″ indicates “0010”, dots are arranged in both the upper and lower pixels. On the other hand, if the quantization data Y″ indicates “1110”, a dot is arranged only in the upper pixel or the lower pixel. In this way, even if the quantization value obtained in step S1804 is the same, it is possible to control the arrangement or number of dots in accordance with the value of the upper 2 bits of the quantization data Y″.

As described above, the quantization data for the second group color is added with edge information representing the detection result of the adjacent edge pixel (that is, the third edge portion). Therefore, the nozzle separation processing unit 212 can generate print data for the second group color based on the detection result of the adjacent edge pixel. For example, if it is determined that the pixel of interest is at the edge (in the third edge portion), the nozzle separation processing unit 212 can generate print data so that the recording amount for the pixel of interest decreases, as compared with a case where it is determined that the pixel of interest is not at the edge. As described above, it is possible to control each of the dot arrangement for the first group color and the dot arrangement for the second group color based on a different type of edge detection result (for example, the detection result of the edge pixel or the adjacent edge pixel).

In this embodiment, with respect to the quantization data Y″, if the pixel is not at the edge (the upper 2 bits of the quantization data are “00”), up to two dots are arranged in this pixel. In this case, the maximum recording rate is 100%. If the pixel is at the edge (in the third edge portion) (the upper 2 bits of the quantization data are “11”), up to one dot is arranged in this pixel. Therefore, the maximum recording rate is 50%. As described above, the nozzle separation processing unit 212 can generate print data so that the maximum recording amount (that is, the number of dots) for the pixel at the edge is smaller than the maximum recording amount for the pixel not at the edge. Furthermore, the nozzle separation processing unit 212 can generate print data so that the maximum recording rate for the pixel at the edge is lower than the maximum recording rate for the pixel not at the edge.

FIG. 19B shows the reference index pattern to be referred to in a case where the quantization data Y″ indicates “1101” or “1110”. Except for the case of the quantization data Y″ of “1101” or “1110”, the reference index pattern shown in FIG. 11B is referred to. In this way, it is possible to control the dot arrangement in the edge region by switching the reference index pattern to be referred to, in accordance with the upper 2 bits of the quantization data.

FIG. 19C shows the binary composite nozzle data (600 dpi in the X direction and 1,200 dpi in the Y direction) obtained by performing the index expansion processing according to the reference index pattern shown in FIG. 19B in a case where all the quantization data of the each pixel indicate “1101”. By using the reference index pattern shown in FIG. 19B, in a region of pixels for which “11” is set in the upper 2 bits, a pixel in which a dot is arranged on the upper side and a pixel in which a dot is arranged on the lower side are alternately arranged.

The nozzle separation processing unit 212 assigns data (nozzle data Y1p) of the upper pixel of the composite nozzle data Yp corresponding to the quantization data Y″ of one pixel to the Ev nozzle of the yellow nozzle array corresponding to the pixel. In addition, the nozzle separation processing unit 212 assigns data (nozzle data Y2p) of the lower pixel of the composite nozzle data Yp corresponding to the quantization data Y″ of one pixel to the Od nozzle of the yellow nozzle array corresponding to the pixel.

The nozzle separation processing unit 212 performs, in the same manner, the index expansion processing for the quantization data C″ and M″ obtained in step S305, thereby generating the composite nozzle data Cp and Mp.

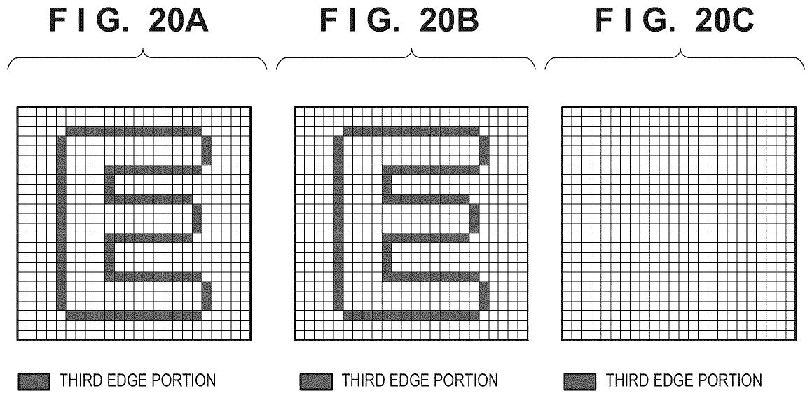

Processing of converting the image data shown in each of FIGS. 5A to 5C into nozzle data in accordance with the flowchart shown in FIG. 3A will further be described with reference to FIGS. 20A to 23C.

FIGS. 14A to 14C and 20A to 20C show results of edge detection processing performed for the respective pixels of the binary images shown in FIGS. 13A to 13C, respectively. FIGS. 14A to 14C each show the “first edge portion” and “second edge portion” detected in step S403. FIGS. 20A to 20C each show the detection result of the third edge portion adjacent to one of the edge portions. In FIGS. 20A and 20B, a pixel adjacent to the first edge portion or the second edge portion of the black character “E” is detected as the third edge portion. On the other hand, since neither the first edge portion nor the second edge portion is detected in FIG. 14C, no third edge portion is detected in FIG. 20C.

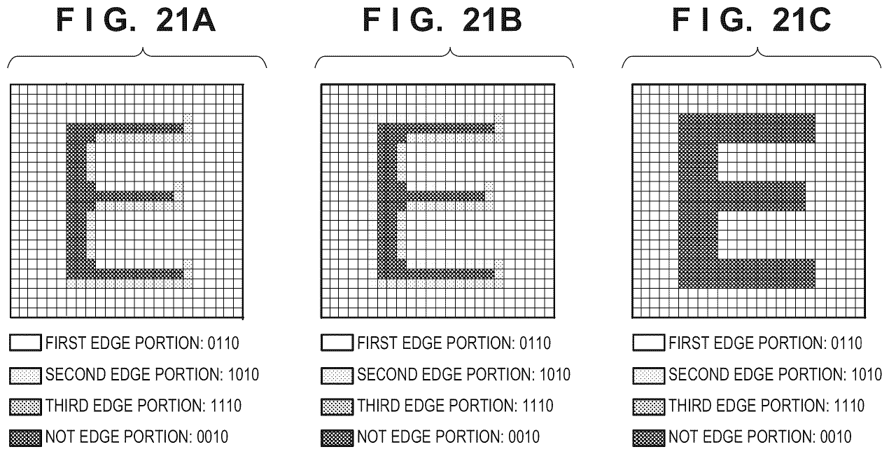

FIGS. 21A to 21F show quantization data obtained by performing the processes of steps S304 and S305 using the edge information shown in FIGS. 14A to 14C and 20A to 20C. FIGS. 21A to 21C show the quantization data K″ corresponding to the image data shown in FIG. 5A to 5C, respectively, and are the same as FIGS. 15A to 15C, respectively. FIGS. 21D to 21F show the quantization data Y″ corresponding to the image data shown in FIGS. 5A to 5C, respectively. In the quantization data Y″ shown in FIG. 21E, a value “1110” is assigned to a pixel that is detected as the third edge portion. A value “0010” is assigned to a pixel that is not detected as the third edge portion. Note that FIGS. 21A to 21F do not show a pixel for which the lower 2 bits of the quantization data are “00”.

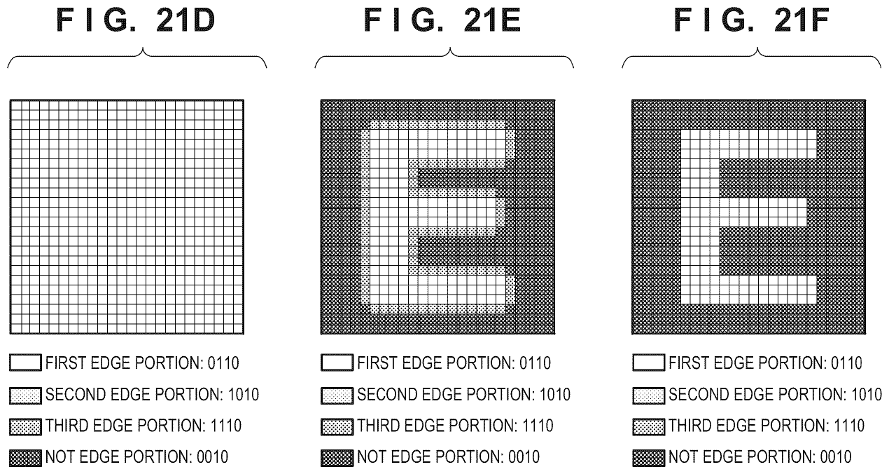

FIGS. 22A to 22F show dot arrangement patterns corresponding to the quantization data K″ shown in FIGS. 21A to 21C and the quantization data CL″ shown in FIGS. 21D to 21F, that are obtained by performing the index expansion processing in step S306. The dot arrangement patterns K shown in FIGS. 22A to 22C are the same as in FIGS. 16A to 16C. It is found that in the dot arrangement pattern CL shown in FIG. 22E, the number and arrangement of dots in the adjacent edge pixel are controlled in accordance with the edge information indicating the third edge portion. With respect to a pixel that is detected as the third edge portion, the dot arrangement pattern is controlled so as to execute printing with one of a dot (Ev nozzle) on the upper side and a dot (Odd nozzle) on the lower side. On the other hand, with respect to a pixel that is not detected as the third edge portion, the dot arrangement pattern is controlled so as to execute printing with both the nozzle on the upper side and the nozzle on the lower side. For example, in FIG. 22F, since a background pixel is not detected as the third edge portion, the dot arrangement pattern is controlled so as to execute printing in a pixel adjacent to the black character “E” with both the nozzle on the upper side and the nozzle on the lower side. It is thus found that the number and arrangement of dots are controlled in accordance with the edge information even in the dot arrangement pattern Y.

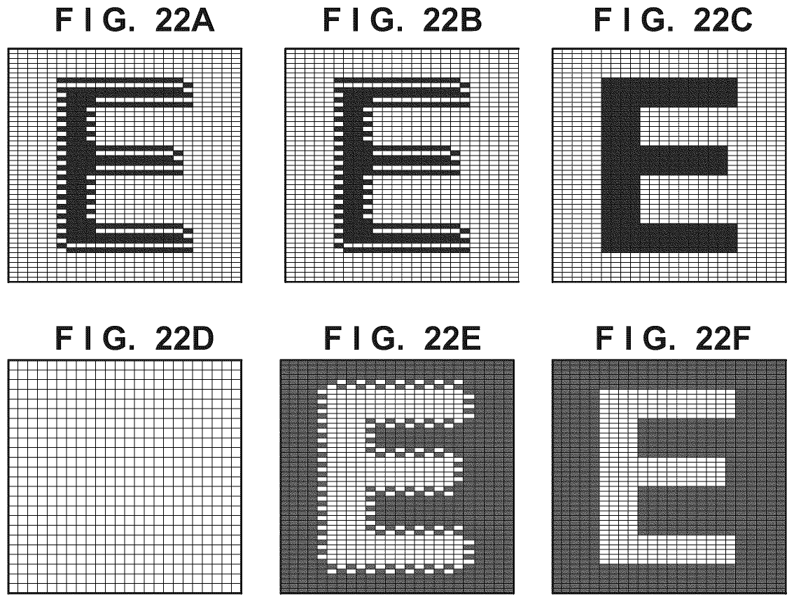

FIGS. 23A to 23C show final dot arrangements obtained by performing the processes of steps S301 to S306 for the input images shown in FIGS. 5A to 5C, respectively. FIGS. 23A and 23C are the same as FIGS. 17A and 17C, respectively. FIG. 23B corresponds to FIG. 5B, and shows the dot arrangement in a case where the density of a color dot of the ink CL_1 adjacent to the black character “E” formed by black dots indicated by K_1 is low. In FIG. 23B, CL_1 is the yellow ink. It is found that the number and arrangement of dots corresponding to the edge pixels of the black character “E” are controlled, similar to FIG. 23A. This processing can suppress bleeding of the black ink K on the print medium in the edge pixels, and suppress a decrease in sharpness of the character. In this example, the number of yellow dots indicated by CL_1 adjacent to the edge pixel of the black character “E” is also limited. Therefore, as compared with the example shown in FIG. 17B, it is possible to further suppress bleeding between the colors. Especially, in the example shown in FIG. 23B, the arrangement of dots of the yellow ink CL_1 adjacent to K_1 is also devised. That is, by using the index pattern shown in FIG. 19B, the dots of the yellow ink CL_1 are uniformly arranged in the adjacent portion of the edge pixels of the black character “E”. With this configuration, it is possible to further effectively suppress bleeding between the colors.

### Second Modification

In the above-described modification, K is classified as the first group color, Y is classified as the second group color, and C and M are classified as the third group colors. Then, with respect to the first group color, nozzle data is generated so as to control the number and arrangement of ink dots in the edge pixel. With respect to the second group color, nozzle data is generated so as to control the number and arrangement of ink dots in the adjacent edge pixel. However, the classification method is not particularly limited. For example, K may be classified as the first group color and C, M, and Y may be classified as the second group colors.

Alternatively, colors other than black may be classified as the first group colors. In an embodiment, at least one color is classified as the first group color, and each of the remaining colors is classified as the second group color or the third group color. In this case, the color classified as the first group color can be a color (for example, K, C, or M) having relatively low brightness. In another embodiment, at least one color is classified as the second group color and each of the remaining colors is classified as the first group color or the third group color. In this case, the color classified as the second group color can be a color (for example, Y, C, or M) having relatively high brightness. With this configuration as well, an effect of suppressing secondary deterioration in image quality while suppressing at least one of a decrease in sharpness of the character and bleeding between the colors. In an embodiment, the optical densities of recording materials of all the first group colors are higher than any of the optical densities of recording materials of the second group colors. The optical density (OD) represents the attenuation factor of light expressed by a logarithm.

For example, at least one of K, C, and M may be classified as the first group color and Y may be classified as the second group color. A case where K, C, and M are classified as the first group colors and Y is classified as the second group color will be described below. Ink forming the edge pixel is not limited to the black ink. For example, pixels forming the character “E” shown in each of FIGS. 5A and 5B may be blue (RGB=(0, 0, 255)). In this case as well, in step S303, the first edge portion and the second edge portion can be detected, as shown in FIGS. 14A and 14B, and the third edge portion can be detected, as shown in FIGS. 20A and 20B. An example in which the number and arrangement of dots of each ink are controlled based on the edge information in a case where the pixel 52 of the input image shown in each of FIGS. 5A and 5B is blue of RGB=(0, 0, 255) will be described below.

The color separation processing in step S304 and the quantization processing in step S305 according to this modification can be performed in accordance with FIG. 18. As described above, the quantization data C″, M″, and K″ correspond to the first group colors and the quantization data Y″ corresponds to the second group color. A value “01” or “10” is set in the upper 2 bits of each of the quantization data C″, M″, and K″ of the pixel determined as the first edge portion or the second edge portion. A value “11” is set in the upper 2 bits of the quantization data Y″ of the pixel determined as the third edge portion. A value “00” is set in the upper 2 bits of each of the remaining quantization data.

The index expansion processing in step S306 is performed, similar to the above-described first modification. That is, for the index expansion processing corresponding to the quantization data C″, M″, and K″, the dot arrangement pattern and the reference index pattern shown in FIGS. 11A and 11B are used. For the index expansion processing corresponding to the quantization data Y″, the dot arrangement pattern and the reference index pattern shown in FIGS. 19A and 19B are used.

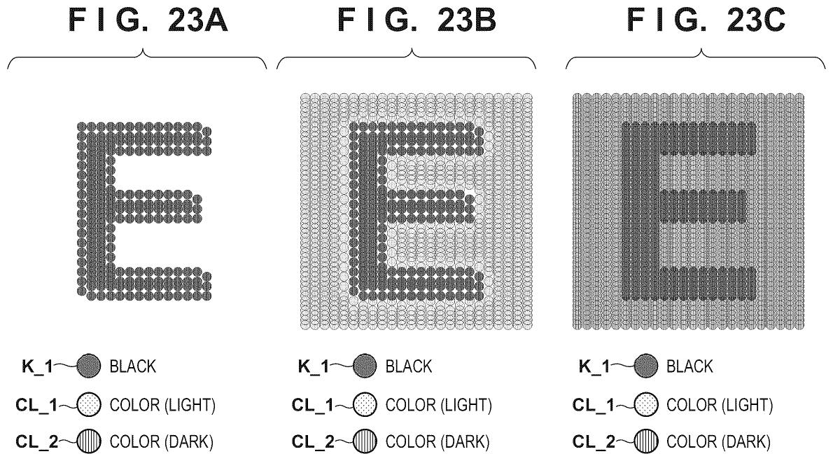

Processing of converting the above image data into nozzle data in accordance with the flowchart shown in FIG. 3A will further be described with reference to FIGS. 24A to 26B.

FIGS. 24A and 24C show quantization data obtained by performing the processes of steps S304 and S305 using the input images shown in FIGS. 5A and 5B, respectively. FIGS. 24B and 24D show quantization data obtained by performing the processes of steps S304 and S305 using the input images shown in FIGS. 5A and 5B, respectively. FIGS. 24A and 24B respectively show the quantization data C″ and M″, and FIGS. 24C and 24D each show the quantization data Y″. With respect to the pixel that is detected as the first edge portion or the second edge portion, the values of the quantization data C″ and M″ corresponding to the first group colors are “0110” or “1010”. With respect to the pixel that is not detected as the first edge portion or the second edge portion, the values of the quantization data C″ and M″ are “0010”. With respect to the pixel that is detected as the third edge portion, the value of the quantization data Y″ corresponding to the second group color is “1110”. With respect to the pixel that is not detected as the third edge portion, the value of the quantization data Y″ is “0010”. Note that the pixel for which the lower 2 bits of the quantization data are “00” is not shown.

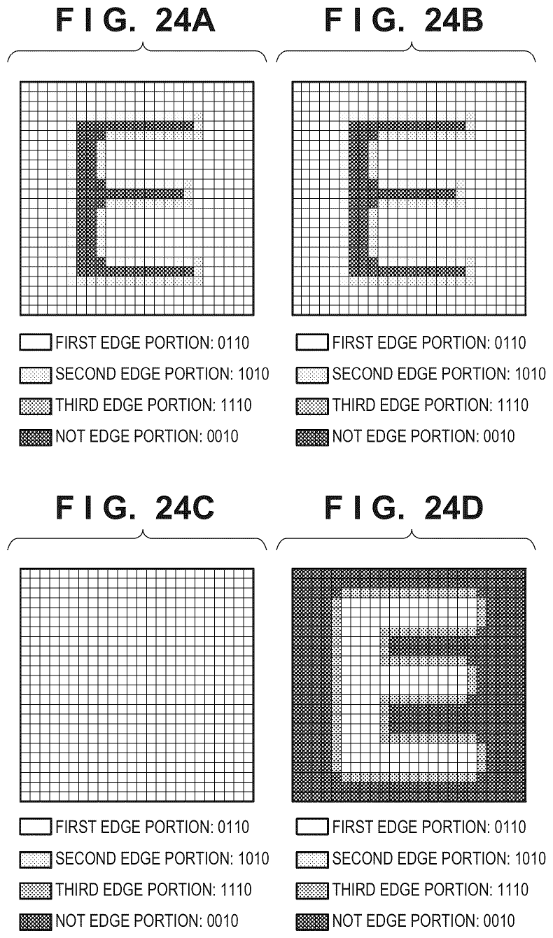

FIGS. 25A to 25D show dot arrangement patterns obtained by performing the index expansion processing in step S306. The dot arrangement patterns C and M shown in FIGS. 25A and 25B correspond to the quantization data C″ and M″ shown in FIGS. 24A and 24B, respectively, and are the same as the dot arrangement patterns K shown in FIGS. 22A and 22B, respectively. The dot arrangement patterns Y shown in FIGS. 25C and 25D correspond to the quantization data Y″ shown in FIGS. 24C and 24D, respectively, and are the same as the dot arrangement patterns Y shown in FIGS. 22D and 22E, respectively.

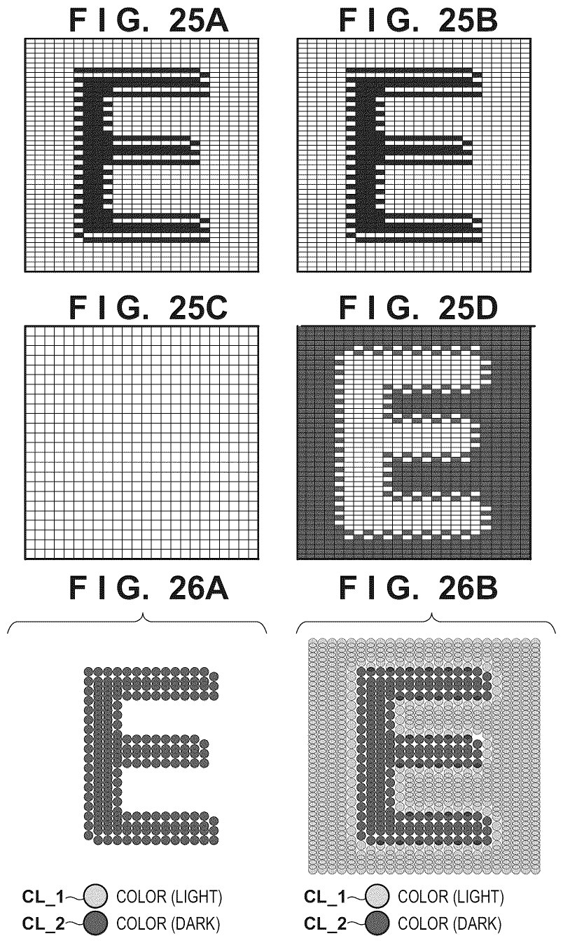

FIGS. 26A and 26B show final dot arrangements obtained by performing the processes of steps S301 to S306 for the above-described input images. FIG. 26A shows the dot arrangement in a case where the adjacent color of the character “E” formed by color dots indicated by CL_2 is white. The color indicated by CL_2 is a color darker than CL_1. In this example, the color dots indicated by CL_2 are obtained by combining dots of the cyan ink and dots of the magenta ink. In this example, the character “E” is a blue character. In this case as well, it is found that the number and arrangement of dots of the edge region are controlled based on a value representing the edge information added to each pixel of the quantization data. This processing can suppress bleeding of the cyan and magenta inks on the print medium in the edge pixels and suppress a decrease in sharpness of the character.

FIG. 26B shows the dot arrangement in a case where the density of a color dot of the ink CL_1 adjacent to the character “E” formed by color dots indicated by CL_2 is low. In FIG. 26B, CL_1 is the yellow ink. It is found that the number and arrangement of dots corresponding to the edge pixel of the blue character “E” are controlled, similar to FIG. 26A. This processing can suppress bleeding of the cyan ink and the magenta ink on the print medium in the edge pixels, and suppress a decrease in sharpness of the character. In this example, the number of yellow dots indicated by CL_1 adjacent to the edge pixel of the blue character “E” is also limited. Therefore, it is possible to suppress bleeding between the yellow ink and the cyan and magenta inks.

Bleeding between colors occurs not only between the black ink and the color ink but also between the color inks. Bleeding between colors also occurs between the cyan ink and the magenta ink. On the other hand, in a case where a difference in brightness between single color inks is large, bleeding between the colors is readily noticeable. For example, the yellow ink as single color ink has a low density, and the cyan ink and the magenta ink as single color inks have high densities. Therefore, bleeding between the yellow ink and the cyan and magenta inks are relatively noticeable. In this embodiment, to suppress bleeding between yellow with high brightness and blue as a secondary color of the cyan ink and the magenta ink, the cyan ink and the magenta ink are classified as the first group colors.

By this method, it is possible to suppress secondary deterioration in image quality such as a decrease in visibility while improving the sharpness of an image such as a character or line printed by color ink. In addition, by this method, it is possible to suppress bleeding between the color inks.

In a case where K is classified as the first group color and C, M, and Y are classified as the second group colors, “11” can be set in the upper 2 bits of each of the quantization data C″ and M″ with respect to the pixel detected as the “third edge portion”, similar to the quantization data Y″. In the index expansion processing in step S306 for the quantization data C″ and M″, the dot arrangement pattern (FIG. 19A) used for the quantization data Y″ can be used. On the other hand, in the index expansion processing for the quantization data C″ and M″, another dot arrangement pattern may be used. For example, if the quantization data indicates “1101”, a dot is arranged in the upper pixel of the two pixels in pattern A and a dot is arranged in the lower pixel of the two pixel in pattern B. On the other hand, if the quantization data indicates “1110”, dots may be arranged in both the two pixels. As described above, in a case where the upper 2 bits are “11”, the same dot arrangement pattern as in a case where the upper 2 bits are “00” may be used. By setting the dot arrangement pattern to be used in the index expansion processing for each ink color, it is possible to control, for each ink color, the dot arrangement according to the added edge information.

Furthermore, a color classified as the first group color need not exist. In this case, with respect to the second group color, the number and arrangement of dots of the edge region are controlled by the above-described method. For example, if the density of a color dot is low, it is possible to suppress bleeding between the black ink and the color ink by decreasing the amount of the color ink used for printing in the edge region. On the other hand, if the density of a color dot is high, the amount of the color ink used for printing in the edge region is not decreased, and it is thus possible to suppress a noticeable frame from being generated around the black character.

### Third Modification

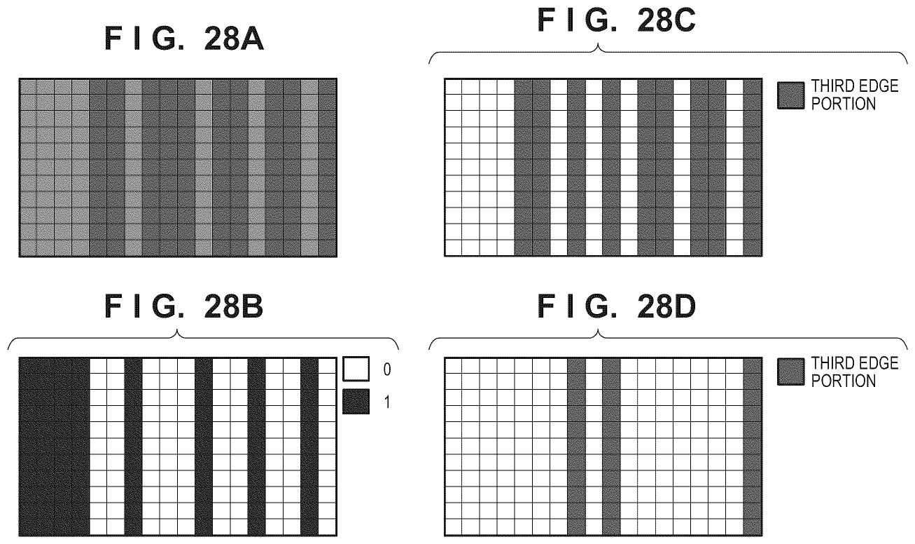

In each of the above-described first and second modifications, the number of dots of the yellow ink in a pixel determined as the third edge portion adjacent to the edge pixel is limited. On the other hand, as shown in FIGS. 28A to 28C, pixels each determined as the third edge portion may continue. FIG. 28A shows a luminance image obtained by performing, in step S401, luminance conversion for a gradation image from yellow to a similar color having a slightly higher density. FIG. 28B shows a binary image obtained by binarizing the luminance image in step S402. If the luminance image shown in FIG. 28A has gradation of the luminance Y around the threshold Th, a pixel of a pixel value “0” and a pixel of a pixel value “1” may alternately exist in the binary image. FIG. 28C shows the result of executing, in step S403, the edge detection processing for the binary image shown in FIG. 28B. For the sake of simplicity, FIG. 28C shows only the “third edge portion”. In FIG. 28C, there are portions in each of which two pixels each detected as the “third edge portion” continue in a direction perpendicular to the edge. This is because in the above example, a pixel adjacent to the “first edge portion” or “second edge portion” is detected as the “third edge portion”. If the “third edge portion” continues in the direction perpendicular to the edge, the portion where the pixels that are limited in number of dots continue may look thin, as compared with adjacent portions even though the brightness of the yellow ink is high.

To cope with this, if the adjacent edge pixels of two or more lines adjacent to each other are detected, the image analysis unit 210 can exclude the adjacent edge pixels of at least one line from the detection result. For example, in step S403, the image analysis unit 210 can detect pixels between “vertical lines of 1 dot/2 space” or “horizontal lines of 1 dot/2 space”. Note that “vertical lines of 1 dot/2 space” or “horizontal lines of 1 dot/2 space” indicate two vertical lines or two horizontal lines having a 1-dot width and an interval of 2 dots. The image analysis unit 210 can detect such pixels using the appropriate pattern information. In this case, the color separation/quantization unit 211 does not add the edge information representing the “third edge portion” to the quantization data for each of the pixels between “vertical lines of 1 dot/2 space” or “horizontal lines of 1 dot/2 space”. FIG. 28D shows the detection result of the third edge portion according to this condition. By detecting the edge region using the appropriate pattern information, it is possible to prevent the number of dots of the yellow ink in the two pixels continuing in the direction perpendicular to the edge from being limited. Note that the pattern information used to prevent the situation in which the pixels each detected as the “third edge portion” continue is not limited to the above pattern information.

Note that the type of the edge detected by the image analysis unit 210 is not limited to the above type. As described above, the image analysis unit 210 can detect various other types of edges using pattern matching. Then, the color separation/quantization unit 211 and the nozzle separation processing unit 212 can appropriately control the arrangement or number of dots in consideration of the various types of edges.

### Fourth Modification

In the above-described embodiment, in step S402, the image analysis unit 210 generates a binary image by performing binarization processing for a grayscale image (for example, a luminance image). However, the image analysis unit 210 may generate an N-arized image other than a binary image. For example, the image analysis unit 210 can convert the luminance Y into 3-valued data (Bin) in accordance with:

$$IF Y > Th\_ 1 : Bin = 0 \qquad ( 3 )$$

$$else IF Th\_ 1 \geq Y > Th\_ 2 : Bin = 1$$

$$else : Bin = 2$$

When performing binarization, the luminance value Y lower than the threshold Th is converted into “1”. Therefore, no edge information is added to a region of a pixel having such luminance value Y, and dot arrangement control according to the edge information is thus not performed. On the other hand, by converting the luminance Y into 3-valued data, the types of edges detected in step S403 can be increased. For example, the threshold Th_1 is set to a value equal to the threshold Th, and the other threshold Th_2 can be set. With this configuration, it is possible to designate a more detailed brightness region where the edge is detected. Thus, it is possible to control the type of the detected edge and pixels.

For example, a pixel in the “first edge portion”, “second edge portion”, or “third edge portion” at the edge between a region of a pixel value “0” and a region of a pixel value “2” can be detected using pattern matching, as described above. Furthermore, a pixel in the “first edge portion”, “second edge portion”, or “third edge portion” at the edge between a region of a pixel value “0” and a region of a pixel value “1” can be detected, as described above.

In addition, using pattern matching, it is possible to detect a pixel in the “third edge portion” at the edge between a region of a pixel value “1” and a region of a pixel value “2”. In this case, it is unnecessary to detect pixels in the “first edge portion” and “second edge portion”. A region of a pixel value “1” adjacent to a region of a pixel value “2” is a halftone brightness region darker than a region of a pixel value “0”. In this configuration, since the number of dots of the color ink, for example, the yellow ink is controlled, it is possible to suppress a decrease in visibility caused by a blur of the outline of the black character. Furthermore, with this configuration, it is possible to suppress bleeding between the colors in the halftone brightness region by controlling the color ink.

### Fifth Modification

In the first embodiment, an edge is detected from the binary image in step S303. Then, the edge information for controlling the dot arrangement pattern with respect to the first group color and the edge information for controlling the dot arrangement pattern with respect to the second group color are set based on the same edge detection result. However, the binary image (or N-arized image) used to detect an edge may be different for each color group or each ink color. For example, a threshold used to convert a grayscale image into a binary image may be different for each color group or each ink color. With this configuration, it is possible to adjust determination of whether to add the edge information for each color group or each ink color.

### Other Modifications

The first embodiment has mainly explained an example in which an edge pixel is an upper/lower/left/right endmost pixel, that is, one pixel inside an edge. However, as described above, the second pixel from the endmost pixel may also be handled as an edge pixel. Each of the first edge pixel (edge pixel) and the second edge pixel (adjacent edge pixel) may include a predetermined number of pixels on two sides of an edge. In this case, the predetermined number of pixels from the endmost pixel can be handled as edge pixels. With this configuration, it is easy to improve the sharpness of an image such as a character or a line. The predetermined number, that is, the width of an edge region included in the edge may be decided in advance in accordance with the print mode of the printer or may be settable by the user. For example, the operation mode of the printer may include a first print mode in which the predetermined number is a first value and a second print mode in which the predetermined number is a second value different from the first value.

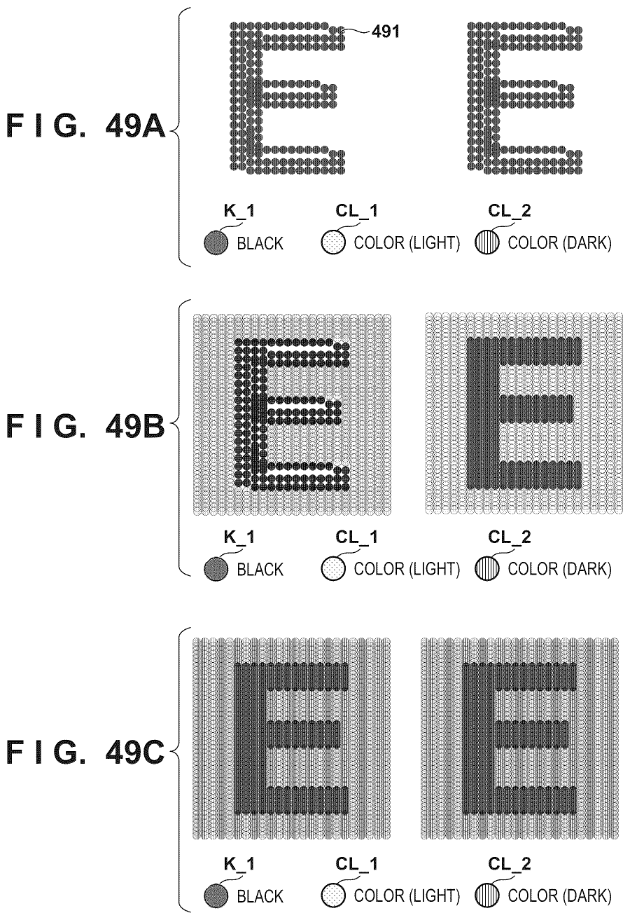

Furthermore, the threshold Th may be set in accordance with the above-described predetermined number. Setting examples will be described with reference to FIGS. 48A to 48C and 49A to 491. FIG. 48A shows an image in which a background with a luminance value of 255 and a character 481 with a luminance value of 0 are arranged in a region 482 and a background with a luminance value of 254 and the character 481 with a luminance value of 0 are arranged in a region 483 adjacent to the region 482. FIG. 48B shows an image in which a background with a luminance value of 226 and the character 481 with a luminance value of 0 are arranged in a region 484 and a background with a luminance value of 225 and the character 481 with a luminance value of 0 are arranged in a region 485 adjacent to the region 484. FIG. 48C shows an image in which a background with a luminance value of 29 and the character 481 with a luminance value of 0 are arranged in a region 486 and a background with a luminance value of 28 and the character 481 with a luminance value of 0 are arranged in a region 487 adjacent to the region 486.

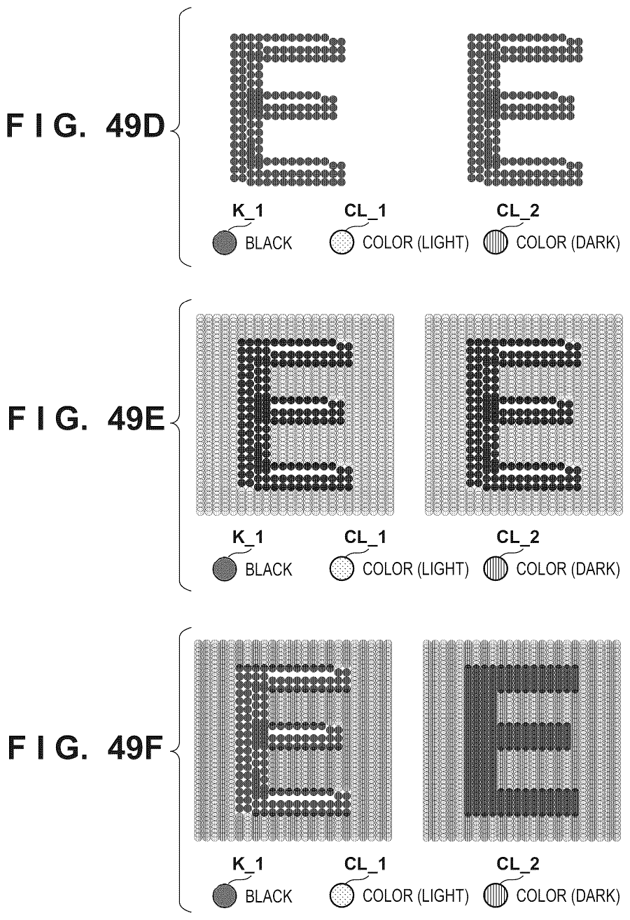

FIGS. 49A to 49C show dot arrangements obtained when the images shown in FIGS. 48A to 48C are converted into nozzle data using the threshold Th=225 in accordance with the flowchart shown in FIG. 3A and the same processing as that for the first pixel from the endmost portion of the edge is performed for the second pixel from the endmost portion, respectively. At this time, the processing for the second edge portion in each of FIGS. 14A to 14C is performed for a pixel group 491 at the center of a horizontal line formed with a 3-pixel width in FIG. 49A. The number of dots corresponding to the background with a luminance value of 254 is small and thus the dots are not illustrated. Dots corresponding to the background with a luminance value of 225 are only slightly different from dots corresponding to the background with a luminance value of 226, and are thus expressed similar to the dots corresponding to the background with a luminance value of 226. Similarly, dots corresponding to the background with a luminance value of 28 are only slightly different from dots corresponding to the background with a luminance value of 29, and are thus expressed similar to the dots corresponding to the background with a luminance value of 29. As shown in FIG. 49B, in a case where the luminance value of the background is 226, dots for two pixels from the edge portion of the edge of the character are thinned out. On the other hand, in a case where the luminance value of the background is 225, the dots of the edge of the character are not thinned out. In this way, in adjacent regions between which a difference in the luminance value of the background is small, a character image printed by thinning out the dots of the edge and a character image printed without thinning out the dots are mixed. If the number of edge pixels for which dots are to be thinned out is large and ink bleeding on the print medium is large, a difference in quality between the character images tends to be large.

According to the study of the present inventor, if ink bleeding on the print medium is relatively large, a difference in quality is more unnoticeable when the luminance of the background is relatively small. In this case, even if the number of pixels at the edge, for which dots are to be thinned out, is large, a difference in quality tends to be hidden by the density of the background. FIGS. 49D to 49F show dot arrangements obtained when the threshold Th=28 is used. By decreasing the threshold Th in a case where the number of pixels for which the dots are to be thinned out is large, the dots at the edge of the character are thinned out in an image having a background with a high luminance in which a difference in quality caused by the presence/absence of thinning is readily noticeable, as shown in FIGS. 49D and 49E. On the other hand, as shown in FIG. 49F, in an image having a background with a low luminance in which a difference in quality caused by the presence/absence of thinning is relatively hardly noticeable, the presence/absence of thinning is controlled.

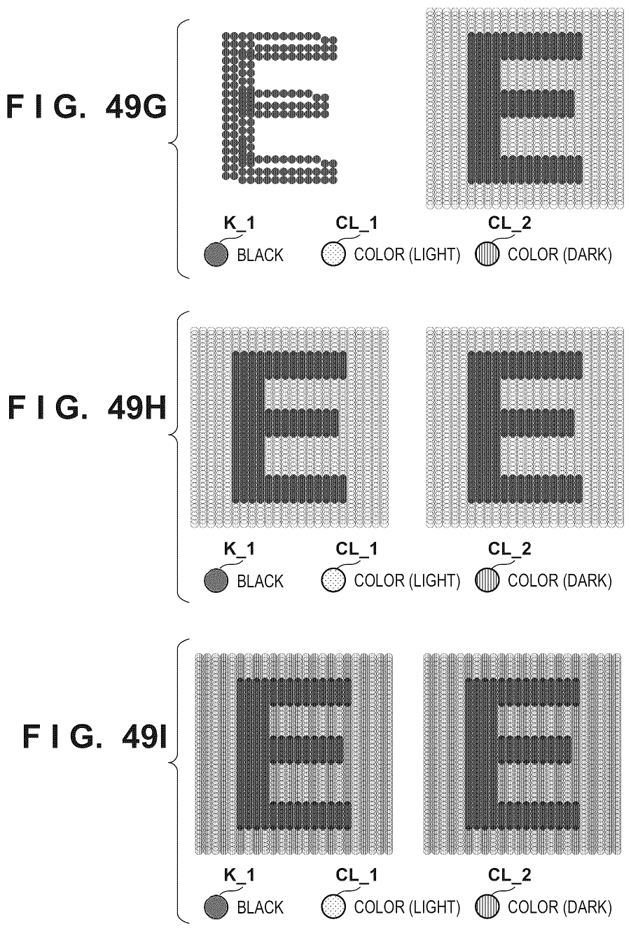

On the other hand, if ink bleeding on the print medium is relatively small, a difference in quality is hardly unnoticeable when the luminance of the background is relatively high. In this case, even if the number of pixels at the edge, for which dots are to be thinned out, is large, the lightness of the color of an edge pixel group 492 to be thinned out is relatively close to the lightness of the color of the background, and thus a difference in quality is relatively hardly visually perceived. FIGS. 49G to 491 show dot arrangements obtained when the threshold Th=254 is used. By increasing the threshold Th in a case where the number of pixels for which the dots are to be thinned out is large, the dots at the edge of the character are not thinned out in an image having a background with a low luminance in which pixels to be thinned out are more readily visually perceived as light-colored with respect to the background, as shown in FIGS. 49H and 491. On the other hand, as shown in FIG. 49G, only in an image having a background with a high luminance in which pixels to be thinned out are hardly visually perceived as light colored, the dots at the edge of the character are thinned out.

As described above, in this modification, the different threshold Th is set in accordance with the number of pixels at the edge, for which the dots are to be thinned out, that is, the above-described predetermined number. The same threshold Th may be set regardless of the above-described predetermined number. For example, the threshold Th may be set in accordance with the print mode of the printer. That is, the operation mode of the printer may include the first print mode in which the threshold Th is the first value and the second print mode in which the threshold Th is the second value different from the first value.

As an example, in print mode 1, the threshold (for example, Th=225) of the first value may be set. At this time, in print mode 2 different from print mode 1, the same threshold (for example, Th=225) may be set. Furthermore, in print mode 3 different from print mode 1 (and print mode 2), another threshold (for example, Th=28) may be set. At this time, the threshold set in print mode 1 (and print mode 2) may correspond to a color on the brighter density side in a grayscale image, as compared with the threshold set in print mode 3. The width of the edge region in print mode 1 may be different from the width of the edge region in print mode 3 (and print mode 2). For example, in print mode 1, the edge pixel may be one pixel inside the upper/lower/left/right endmost portion. In print modes 2 and 3, the second pixel from the endmost portion may also be handled as an edge pixel. In this configuration, the user can select a print mode from print mode 1 and print mode 3 in which the number of pixels at the edge, for which the dots are to be thinned out, is larger than in print mode 1 and the dots are thinned out at the edge even if the luminance of the background is low. Furthermore, the user can select print mode 2 in which the number of pixels at the edge, for which the dots are to be thinned out, is larger than in print mode 1 and the condition (threshold Th) concerning the luminance of the background when thinning out the dots remains unchanged. Print mode 3 can be set as a mode for printing high-quality image in which the sharpness of a character or a thin line is high, as compared with print mode 1, in a case where ink bleeding on the print medium is relatively large. Furthermore, print mode 3 can be set as a mode for printing a code image (such as a barcode image, a QR Code™ image, or a machine-readable code image) of higher quality than in print mode 1. Print mode 2 can be set as a mode for printing a code image of higher quality than in print mode 1 regardless of how ink bleeds on the print medium. It is unnecessary to be able to select all print modes 1 to 3, as a matter of course. For example, only print modes 2 and 3 may be selectable.

### Second Embodiment

In the first embodiment, the number of dots of ink in each of the edge pixel and the adjacent edge pixel is limited based on the edge information. On the other hand, the edge pixel may be enhanced based on the edge information. In this embodiment, processing of improving visibility of a character or a thin line by enhancing edge pixels is performed.

An image processing unit 208 generates nozzle data separated for each nozzle from input image data in accordance with a print condition included in a print job, as described above. A printing apparatus can operate in a print mode of suppressing an ink amount used for printing more than in a standard mode, such as a draft mode or an eco mode. In this case, the print condition can include information indicating print quality, for example, information indicating the draft mode or the eco mode. In this mode, the ink amount may be halved, as compared with the standard mode. If the ink amount is a half of the standard setting, an obtained printed material is thin, as a whole. In this mode, the ink amount forming each of a black character and a thin line is also halved, bleeding of black ink on a print medium hardly occurs. However, if a pixel adjacent to the character or thin line is a high-density color pixel, contrast decreases and thus visibility may also decrease. To cope with this, an edge pixel adjacent to a high-density color pixel is detected and the detected edge pixel is enhanced, thereby making it possible to improve visibility. Processing of detecting an edge pixel adjacent to a high-density color pixel will be described below. A case where a mode of halving an ink amount is designated as a print condition will be described below. This mode will be referred to as a draft mode hereinafter.

The configurations of a printing system and an image processing apparatus according to this embodiment are the same as in FIGS. 1 to 2B and 27A to 27C. Processing according to this embodiment can also be performed in accordance with a flowchart shown in FIG. 3A. Parts different from the first embodiment will be described below.

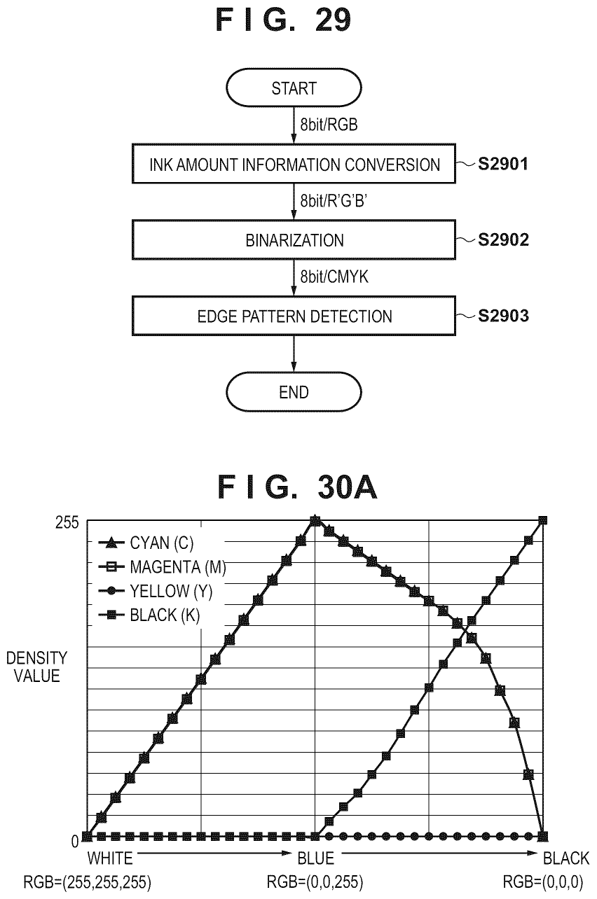

FIG. 29 shows the internal processing procedure of image analysis processing performed in step S303 according to this embodiment. In step S2901, an image analysis unit 210 converts an input image into a grayscale image. The grayscale image used in this embodiment represents, for each pixel, an amount of at least one recording material used to print an image on a print medium in accordance with each pixel value of the input image. For example, the grayscale image can indicate ink amount information A for each pixel. Ink amount information A represents the total amount of at least one color ink applied to each pixel. In this embodiment, the image analysis unit 210 converts each pixel value of the input image into ink amount information A. For example, the image analysis unit 210 can convert information of three channels of R, G, and B of the input image into ink amount information. Thus, the image analysis unit 210 can generate the grayscale image representing the ink amount information for each pixel.

As a practical conversion method, the image analysis unit 210 can generate the grayscale image by converting each pixel value of the input image in accordance with a conversion table. At this time, the image analysis unit 210 can use a conversion table corresponding to the print mode of the printing apparatus. For example, a conversion table corresponding to each of the draft mode and other modes can be stored in a memory. In this embodiment, the image analysis unit 210 can obtain the total ink amount of cyan ink and magenta ink corresponding to the RGB values in the set print mode with reference to the LUT stored in advance in the memory.

Conversion into ink amount information is performed to grasp an ink amount for each pixel. In this embodiment, inks whose ink amounts are to be determined are cyan ink and magenta ink. In an embodiment, an yellow ink amount is not considered. This is because the brightness of yellow ink is high, as described above, and thus a change in brightness on the print medium is gentle even if the ink amount of the yellow ink increases. As described above, in a case where a pixel adjacent to a character or a thin line is a high-density color pixel, contrast decreases, and it is thus possible to improve visibility by enhancing the edge in this case. Therefore, the visibility is effectively improved by performing edge enhancement for a pixel adjacent to a pixel in which the total ink amount of the cyan ink and the magenta ink is large. On the other hand, to suppress occurrence of bleeding between the colors caused by edge enhancement, the yellow ink amount is not considered in this embodiment.

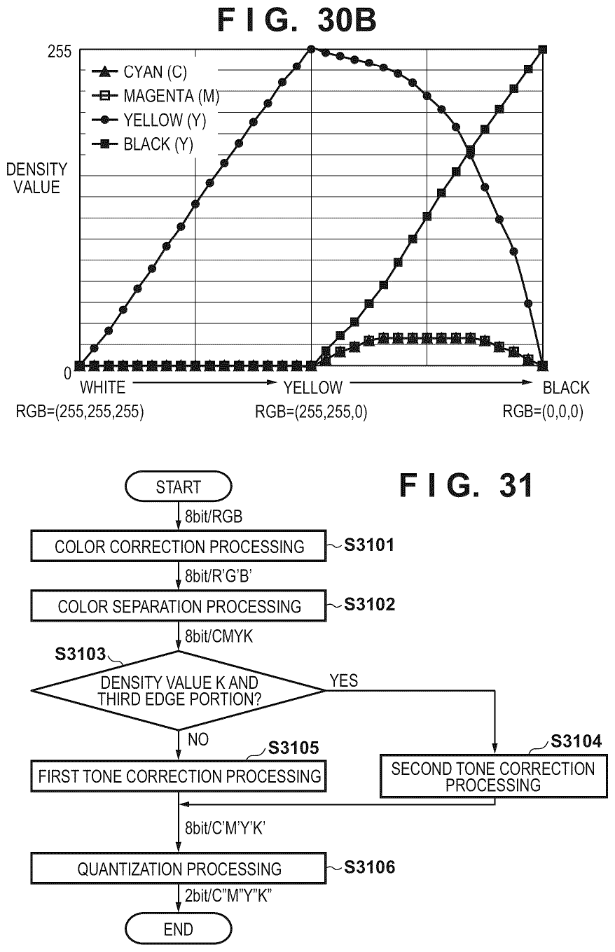

FIGS. 30A and 30B each show the relationship between the RGB values of the input image and ink color data. FIG. 30A shows the density value of each corresponding ink color in a case where the RGB values change from white to blue and to black. When the RGB values indicate white, all the ink colors have a density value of 0. It is found that blue is expressed as a secondary color of the cyan ink and the magenta ink. In this example, almost equal amounts of the cyan ink and the magenta ink are applied. Although blue depends on the tint of each of the cyan ink and the magenta ink, blue is often expressed by equal amounts of these two color inks unless spot color ink is used. Similarly, green is expressed as a secondary color of the cyan ink and the yellow ink. Red is expressed as a secondary color of the magenta ink and the yellow ink. In this case as well, the application amounts of these inks are equal to each other, and as the density of green or red is higher, the application amounts of inks often increase.

FIG. 30B shows the density value of each corresponding ink color in a case where the RGB values change from white to yellow and to black. It is found that yellow is expressed as the primary color of the yellow ink. Similarly, RGB=(0, 255, 255) corresponding to cyan is usually expressed by the primary color of the cyan ink and RGB=(255, 255, 0) corresponding to magenta is usually expressed by the primary color of the magenta ink.

The density value data of each color corresponding to the input RGB values can be prepared in advance as an ink color separation table. Based on the table, it is possible to generate an LUT for converting each pixel value of the input image into ink amount information, which is referred to in step S2901. For example, for each print condition, with reference to the ink color separation table, the ink amount of each ink color corresponding to the RGB values can be acquired and the total ink amount can be calculated based on the ink amounts of the respective ink colors. The thus obtained LUT indicating the total ink amount corresponding to the RGB amounts may be stored in advance in the memory.

In step S2902, the image analysis unit 210 performs threshold-based processing for the grayscale image obtained in step S2901 to generate an N-arized image representing the result of the threshold-based processing. In this embodiment, the image analysis unit 210 converts ink amount information A into binary data for edge detection. In this embodiment, as an example, the image analysis unit 210 converts ink amount information A into binary data (Bin) using a threshold Th preset in accordance with the print mode of the printing apparatus, as given by expression (4) below. The threshold Th will be described later. The binary data generation expression is merely an example, and the binary conversion method is not particularly limited. For example, the design of an inequality condition and the form of an expression may be different.

$$IF ink amount information A > Th : Bin = 0 \qquad ( 4 )$$

$$else : Bin = 1$$

In this embodiment, in the input image, a pixel in which the total ink amount of the cyan ink and the magenta ink is equal to or larger than the threshold Th is detected. Then, the number of dots of the black ink for a pixel adjacent to the detected pixel is controlled. Therefore, based on the relationship between the density of the color pixel adjacent to the pixel formed by the black ink and the effect of improving visibility by enhancing an edge to increase the contrast of an edge portion, the threshold Th can be decided to obtain such effect.

In step S2903, the image analysis unit 210 detects an edge pattern using the N-arized image obtained in step S2902. In this embodiment, the image analysis unit 210 detects an edge pattern in the binary image. An example of pattern information used to detect an edge pattern has already been explained in the first embodiment. In this embodiment, the image analysis unit 210 detects a portion (third edge portion) adjacent to one of edge portions. The image analysis unit 210 can output “3” as a determination result for a pixel in the third edge portion. In addition, the image analysis unit 210 can output “0” as a determination result for another pixel. The pixel in the third edge portion is a pixel adjacent to a pixel in which the total ink amount of the cyan ink and the magenta ink is equal to or larger than the threshold Th. Note that as shown in FIGS. 30A and 30B, a portion forming the black character or the thin line highly probably exists in a region of Bin=1. Therefore, a pixel in the edge portion of the black character or the thin line adjacent to a pixel in which the total ink amount is large highly probably exists in the third edge portion.

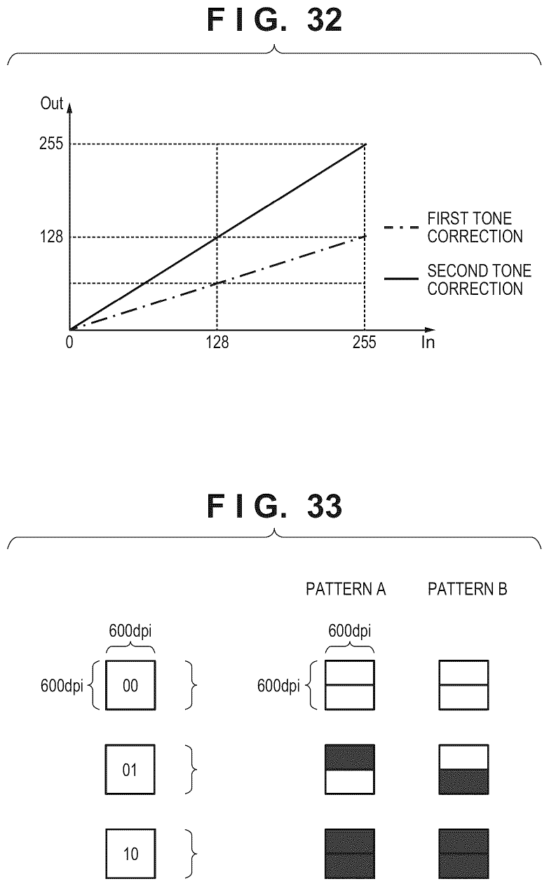

FIG. 31 is a flowchart of color separation processing in step S304 and quantization processing in step S305, which are executed by a color separation/quantization unit 211. Steps S3101 and S3102 are the same as steps S1001 and S1002.

In steps S3103 to S3105, the color separation/quantization unit 211 performs tone correction processing. In step S3103, the color separation/quantization unit 211 determines whether a pixel to be processed is detected as the “third edge portion” and a processing target is a density value K. If the pixel to be processed is the “third edge portion”, the color separation/quantization unit 211 performs second tone correction processing for the density value K in step S3104. If the pixel to be processed is not the “third edge portion”, the color separation/quantization unit 211 performs first tone correction processing for the density value K in step S3105.

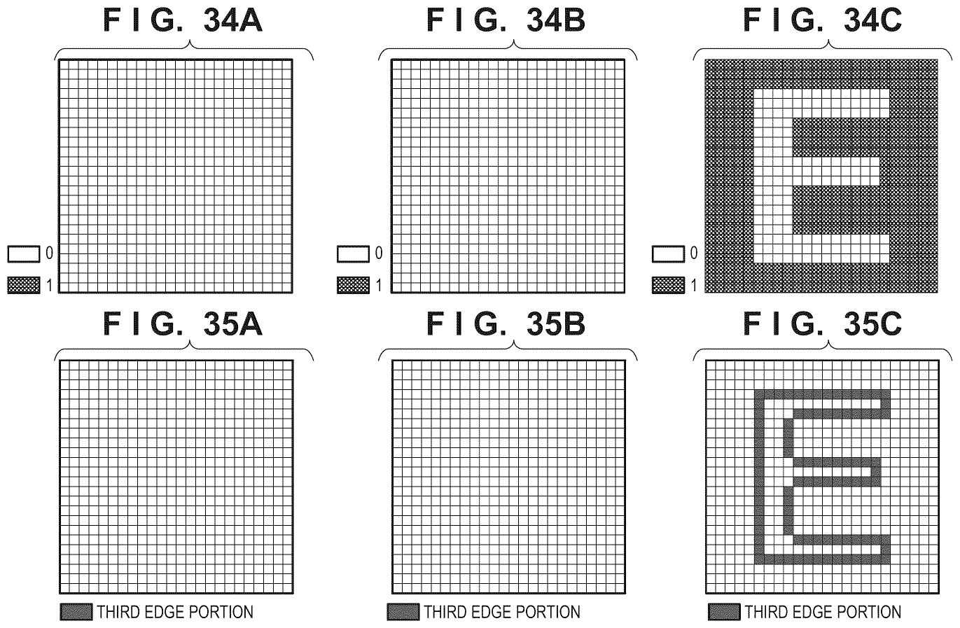

FIG. 32 shows an example of setting of the first tone correction processing and the second tone correction processing. In FIG. 32, In corresponds to the density value K as an input value to the tone correction processing and Out corresponds to a density value K′ as an output value of the tone correction processing. In this embodiment, in a case where the draft mode is set as the print condition, the tone correction processing implements printing according to the draft mode. In this example, in the first tone correction, the output value is a half of the input value. For example, In=255 corresponds to OUT=128. In this way, by performing the first tone correction, the ink amount used is halved from the standard setting. On the other hand, in the second tone correction, the output value larger than that of the first tone correction is obtained with respect to the same input value. In this example, while the ink amount used is halved in the first tone correction, the second tone correction is performed to use an ink amount as much as twice the ink amount used in the first tone correction. For example, In=255 corresponds to Out=255. The first tone correction and the second tone correction are switched based on the information of the “third edge portion”. It is thus possible to increase the black ink amount for a pixel adjacent to a high-density color pixel.

Note that the second tone correction may be performed so that the black ink amount for the edge portion of a high-density black region is increased and the black ink amount for the edge portion of a gradation region is maintained. For example, in the second tone correction, the density value need not be corrected in a case where the input value is smaller than the threshold and may be corrected in a case where the input value is equal to or larger than the threshold. This threshold may be, for example, 255.

In this embodiment, in the tone correction processing for density values C, M, and Y, the information of the “third edge portion” is not used. In step S3105, the color separation/quantization unit 211 performs the first tone correction for the density values C, M, and Y That is, by performing the first tone correction for the density values C, M, and Y, density values C′, M′, and Y′ are halved.

In step S3106, the color separation/quantization unit 211 performs quantization processing for the density values C′, M′, Y′, and K′. The color separation/quantization unit 211 executes predetermined quantization processing to perform conversion into 2-bit 3-valued quantization data C″, M″, Y″, and K″ of “00”, “01”, or “10”.

In step S306, a nozzle separation processing unit 212 performs index expansion processing for the quantization data C″, M″, Y″, and K″ obtained in step S305. In the index expansion processing in this embodiment, the quantization data C″, M″, Y″, and K″ of 600×600 dpi are converted into composite nozzle data Cp, Mp, Yp, and Kp of 600×1200 dpi using an index pattern prepared in advance. In this example, data of one pixel is converted into data of two pixels connected in the vertical direction.

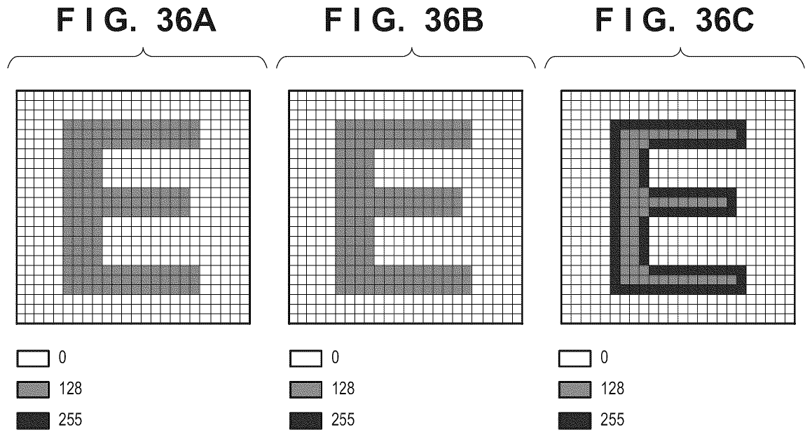

FIG. 33 shows an example of a dot arrangement pattern used in the index expansion processing. If the quantization data indicates “00”, no dot is arranged in either of the two pixels. If the quantization data indicates “01”, a dot is arranged in the upper pixel of the two pixels in pattern A, and a dot is arranged in the lower pixel of the two pixels in pattern B. If the quantization data indicates “10”, dots are arranged in both the two pixels. In this embodiment, a reference index pattern shown in FIG. 11B is used. If all the quantization data of each pixel indicate “01”, composite nozzle data obtained by the index expansion processing is the same as in FIG. 11C.

With the above processing, composite nozzle data of 600×1200 dpi is obtained based on each pixel of the input image data of 600×600 dpi. This composite nozzle data designates printing/non-printing by each nozzle.

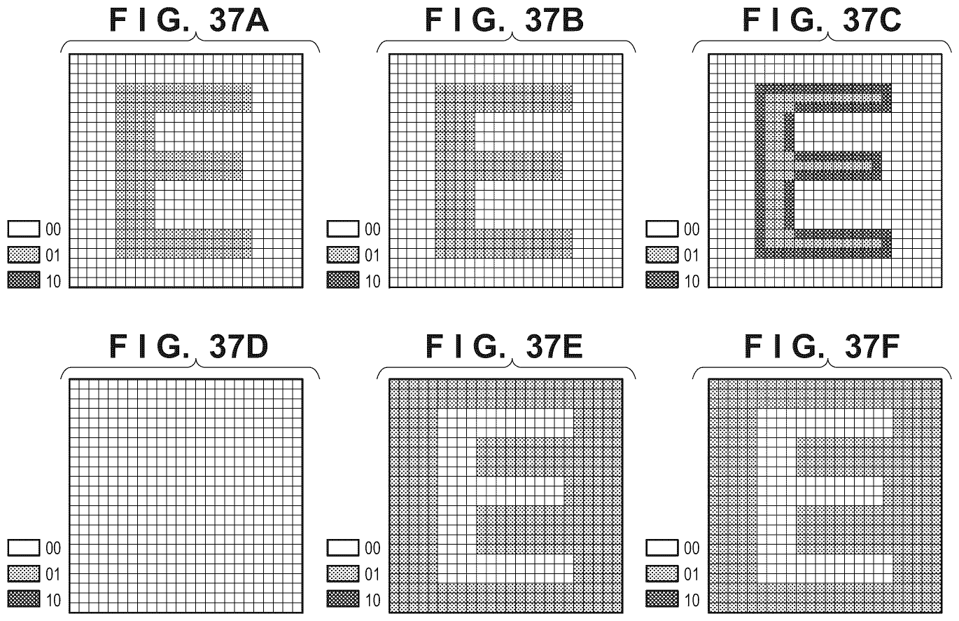

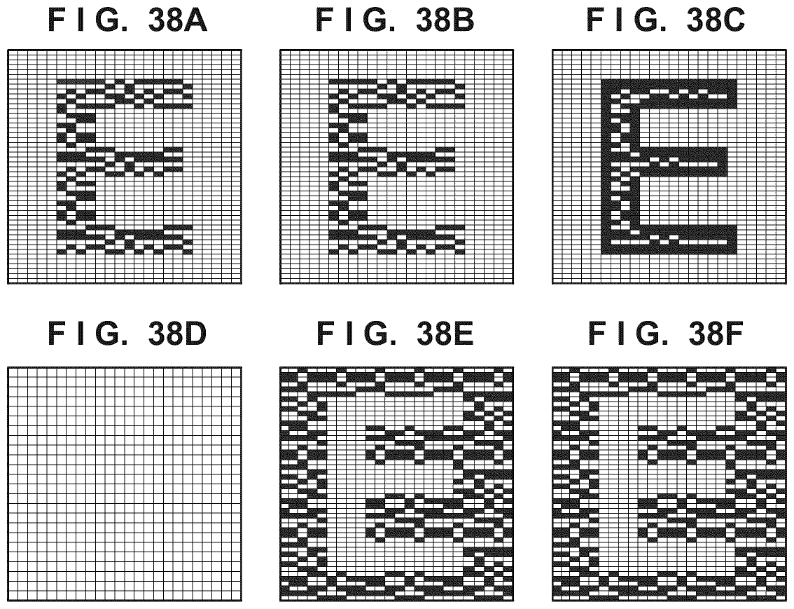

Processing of converting image data shown in each of FIGS. 5A to 5C into nozzle data in accordance with the flowchart shown in FIG. 3A will further be described with reference to FIGS. 34A to 36C. FIGS. 34A to 34C show binary images obtained by performing the processes of steps S2901 and S2902 for the image data shown in FIGS. 5A to 5C, respectively. FIGS. 35A to 35C show results of edge detection processing performed, in step S2903, for the binary images shown in FIGS. 34A to 34C, respectively. Information indicating whether each pixel is located in the third edge portion is obtained as edge information.

In FIGS. 34A and 34B, the values of all pixels are “0”. In the input image shown in FIG. 5A, a black character “E” is arranged on a white background. As shown in FIG. 30A, the ink amounts of the cyan ink and the magenta ink corresponding to white and black are 0. In the input image shown in FIG. 5B, the black character “E” is arranged on a yellow background. As shown in FIG. 30B, the ink amounts of the cyan ink and the magenta ink used to express yellow are 0. Therefore, ink color information A for each pixel of each of these input images is 0 and the value after binarization is also 0. In these cases, no edge is detected in step S2903, as shown in FIGS. 35A and 35B.

In the input image shown in FIG. 5C, the black character “E” is arranged on a blue background. As shown in FIG. 30A, blue is expressed as a secondary color of the cyan ink and the magenta ink. Therefore, if ink amount information A is binarized using the predetermined threshold Th, ink amount information A for a blue pixel is converted into “1”. On the other hand, as described above, ink amount information A for a black pixel is converted into “0”. By performing pattern matching for the thus obtained binary image shown in FIG. 34C, the “third edge portion” as a pixel adjacent to one of the edge portions is detected. FIG. 35C shows the detection result of the third edge portion. As described above, a pixel adjacent to a high-density color pixel can be detected. In this example, a pixel (that is, the third edge portion) forming the black character “E” adjacent to the blue pixel is detected.

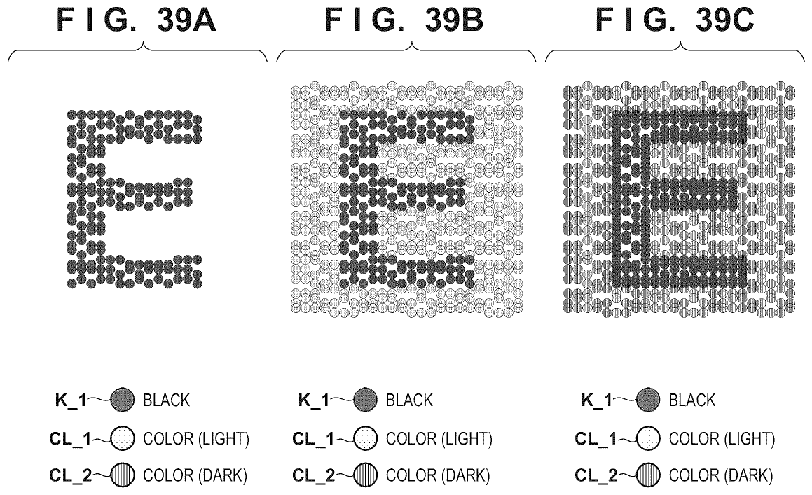

FIGS. 36A to 36C show the density values K′ obtained by performing the processes of steps S3101 to S3105 of FIG. 31 for the input images shown in FIGS. 5A to 5C based on the pieces of edge information shown in FIGS. 35A to 35C, respectively. Since no edge information is detected from the input image shown in each of FIGS. 5A and 5B, the first tone correction processing is performed for each pixel in step S3105. Therefore, the pixel of the density value K=255 is converted into the density value K′=128.

With respect to the input image shown in FIG. 5C, the second tone correction processing is performed for the pixels detected as the “third edge portion”, as shown in FIG. 35C and the first tone correction processing is performed for the remaining pixels. The density value K=255 of each of the pixels detected as the “third edge portion” is converted into the density value K′=255. The density value K=255 of each of the remaining pixels is converted into the density value K′=128. As described above, the processing of obtaining the density value K′ of the black ink for a pixel adjacent to a high-density color pixel and the processing of obtaining the density value K′ of the black ink for the remaining pixels are switched. Note that the first tone correction processing is performed for the density values C, M, and Y, as described above. In this way, correction is performed so as to halve the density values C′, M′, and Y′ as the output values.

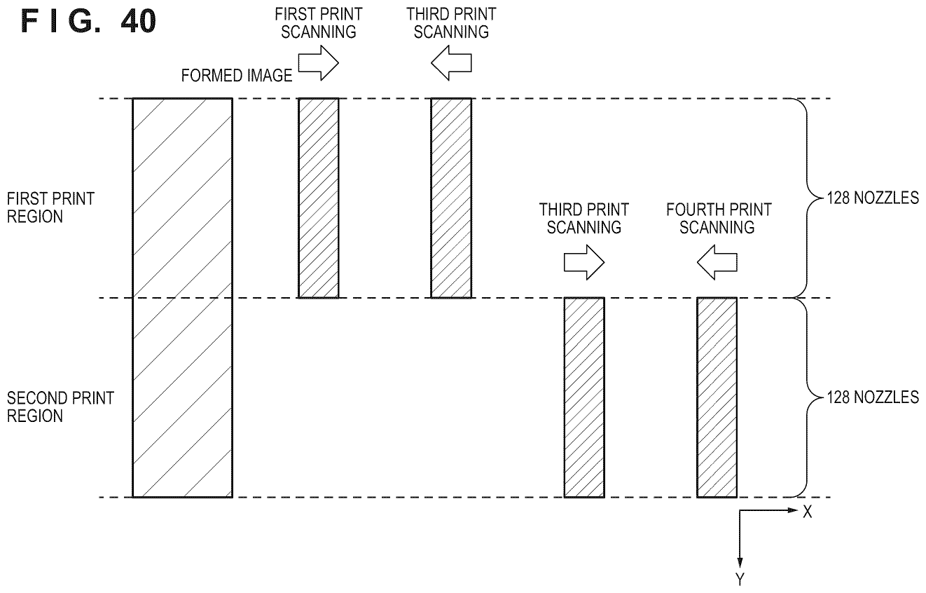

FIGS. 37A to 37F show quantization data obtained by performing the quantization processing in step S3106. FIGS. 37A to 37C show the quantization data K″ obtained by quantizing the density values K′ shown in FIGS. 36A to 36C, respectively. FIG. 37D shows the quantization data C″, M″, and Y″ obtained by performing the processes of steps S3101 to S3106 for the input image shown in FIG. 5A. FIG. 37E shows the quantization data Y″ obtained by performing the processes of steps S3101 to S3106 for the input image shown in FIG. 5B. FIG. 37F shows the quantization data C″ and M″ obtained by performing the processes of steps S3101 to S3106 for the input image shown in FIG. 5C.

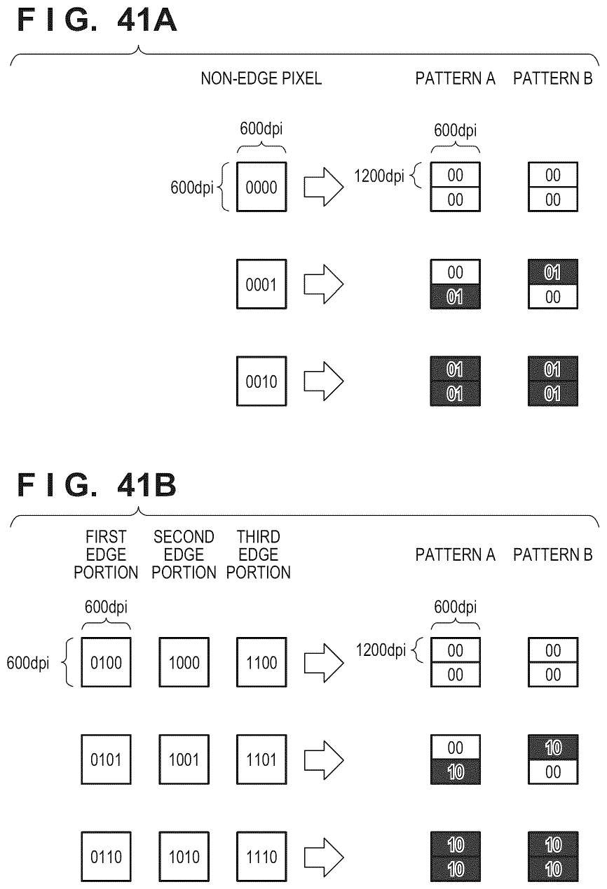

FIGS. 38A to 38F show dot arrangement patterns obtained by performing, in step S305, the index expansion processing based on the dot arrangement pattern and the reference index pattern shown in FIGS. 33 and 11B. FIGS. 38A to 38C show dot arrangement patterns K corresponding to FIGS. 5A to 5C, respectively. FIG. 38D shows dot arrangement patterns C, M, and Y corresponding to FIG. 5A. FIG. 38E shows a dot arrangement pattern Y corresponding to FIG. 5B. FIG. 38F shows dot arrangement patterns C and M corresponding to FIG. 5C. In the dot arrangement pattern K shown in FIG. 38C, two dots are arranged in an edge portion of the black character “E” and dots more than each of the remaining pixels of the black character “E” are arranged. In each of the dot patterns shown in FIGS. 38A, 38B, 38D and 38E, it is found that printing is executed with an ink amount (that is, the number of dots) according to the draft mode set as the print condition.

In this embodiment, with respect to the quantization data K″, if a pixel is at an edge (in the third edge portion), up to two dots are arranged in this pixel as a result of the second tone correction processing. In this case, the maximum recording rate is 100%. If the pixel is not at the edge (in the third edge portion), up to one dot is arranged in this pixel as a result of the first tone correction processing. Therefore, the maximum recording rate is 50%. As described above, the nozzle separation processing unit 212 can generate print data so that the maximum recording amount (that is, the number of dots) for the pixel at the edge is larger than the maximum recording amount for the pixel not at the edge. Furthermore, the nozzle separation processing unit 212 can generate print data so that the maximum recording rate for the pixel at the edge is higher than the maximum recording rate for the pixel not at the edge.

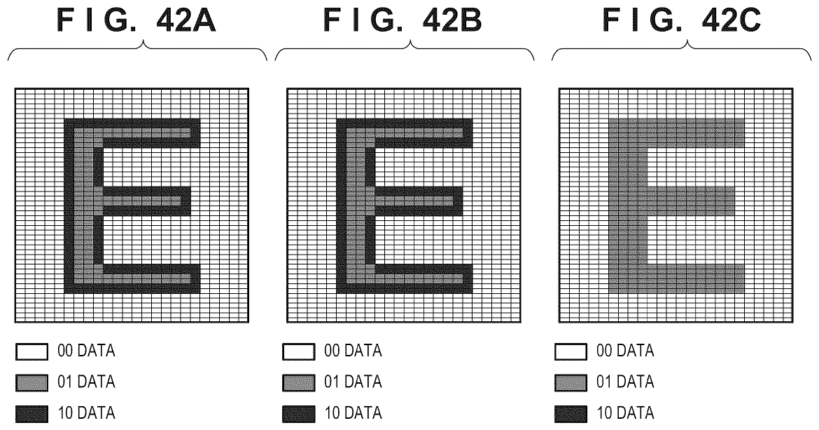

FIGS. 39A to 39C show final dot arrangements obtained by performing the processes of steps S301 to S306 for the input images shown in FIGS. 5A to 5C, respectively, according to this embodiment. FIG. 39A corresponds to FIG. 5A, and shows the dot arrangement in a case where the adjacent color of the black character “E” formed by black dots indicated by K_1 is white. In this embodiment, the draft mode is set as the print condition. Therefore, the number of black dots is halved (one dot per pixel), as compared with the first embodiment. As described above, since the ink amount is small, the influence of ink bleeding caused only by the black ink is small. Thus, in this mode, the black dots need not further be thinned out based on the edge information, unlike the first embodiment. With this configuration, it is possible to improve contrast, thereby improving visibility.

FIG. 39B corresponds to FIG. 5B, and shows the dot arrangement in a case where the density of a color dot of ink CL_1 adjacent to the black character “E” formed by black dots indicated by K_1 is low. In FIG. 39B, CL_1 is the yellow ink. In this embodiment, the draft mode is set as the print condition. Since the number of black dots is decreased, bleeding between the colors is suppressed, as compared with the standard setting. Thus, in this mode, the black dots and the yellow dots need not further be thinned out based on the edge information, unlike the first embodiment. With this configuration, it is possible to improve contrast, thereby improving visibility.

FIG. 39C corresponds to FIG. 5C, and shows the dot arrangement in a case where the density of a color dot of ink CL_2 adjacent to the black character “E” formed by black dots indicated by K_1 is high. In FIG. 39C, CL_2 is formed by the magenta ink and the cyan ink. It is found that the number of black dots indicated by K_1 is controlled so that the number of black dots in the edge portion of the black character “E” is larger than that in the non-edge portion, unlike FIGS. 39A and 39B. As described above, if the density of an adjacent color pixel is high, it is possible to improve the contrast of the black character “E” by increasing the number of black dots in the edge portion of the black character “E”.

According to this embodiment, in a case where a pixel adjacent to the edge of a portion printed by the black ink is a high-density color pixel, it is possible to improve visibility. More specifically, it is possible to improve the visibility of a character or a thin line by enhancing pixels which are adjacent to high-density color pixels and form the character or the thin line.

### Third Embodiment

In this embodiment, printing in each pass in multi-pass printing is controlled in accordance with an edge pixel detection result. In this embodiment as well, edge information is selectively added to a pixel belonging to a specific signal value region in an input image. In accordance with the edge information, nozzle data can be generated so that printing of black ink in an edge pixel is biased to some passes. Furthermore, in accordance with the edge information, nozzle data can be generated so that printing of color inks in an adjacent edge pixel is biased to some passes.

The configurations of a printing system and an image processing apparatus according to this embodiment are the same as in FIGS. 1 to 2B and 27A to 27C. Processing according to this embodiment can also be performed in accordance with a flowchart shown in FIG. 3A. Parts different from the first embodiment will be described below.

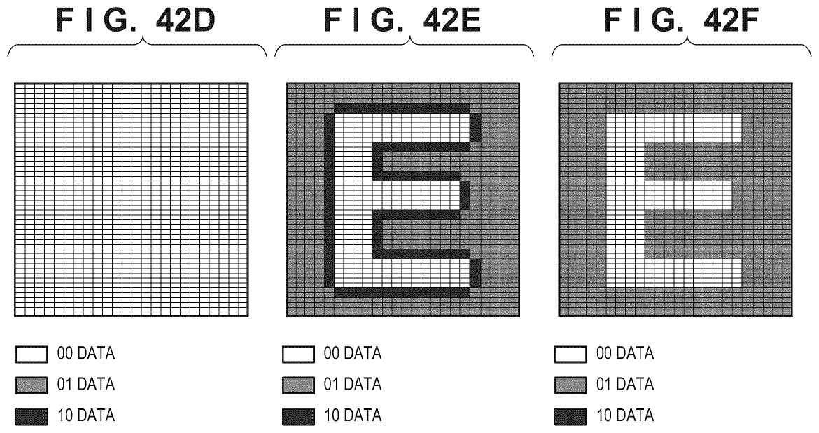

In this embodiment, a printing apparatus executes multi-pass printing of forming an image on a print medium by performing a plurality of print scanning operations. Multi-pass printing will be described first. In this embodiment, bidirectional two-pass printing is executed. FIG. 40 is a schematic view for explaining bidirectional two-pass, multi-pass printing executed under the control of a CPU 203 in a printer 2. For the sake of descriptive simplicity, a print operation using a black nozzle array 2701 among a plurality of nozzle arrays of a printhead H shown in FIGS. 27A to 27C will now be described.

In two-pass printing, printing is executed in print region 1 by first print scanning and second print scanning. In the first print scanning, the printhead H moves in the +X direction as the forward direction. While the printhead moves, the black nozzle array 2701 performs a discharge operation to print region 1. In the second print scanning, the printhead H moves in the −X direction as the backward direction reverse to the direction of the first print scanning. While the printhead moves, the black nozzle array 2701 performs a discharge operation to print region 1. The print medium is not conveyed between the first print scanning and the second print scanning. After the second print scanning, the print medium is conveyed in the −Y direction. A conveyance amount corresponds to a nozzle array length in the sub-scanning direction. FIG. 40 shows a relative positional relationship between each print region and the print medium. As shown in FIG. 40, the black nozzle array 2701 relatively moves in the +Y direction with respect to the print medium.

Subsequently, printing is executed in print region 2 by third print scanning and fourth print scanning. In the third print scanning, the printhead H moves in the +X direction as the forward direction, similar to the first print scanning. The black nozzle array 2701 performs a discharge operation to print region 2. In the fourth print scanning, the printhead H moves in the reverse −X direction, similar to the second print scanning. The black nozzle array 2701 performs a discharge operation to print region 2. After the fourth print scanning, the print medium is conveyed in the −Y direction. As described above, print scanning is performed twice for the same print region, and the print medium is repeatedly conveyed in the −Y direction, thereby executing bidirectional two-pass, multi-pass printing.

In this embodiment, 4-bit quantization data C″, M″, Y″, and K″ are generated for the respective ink colors in accordance with steps S301 to S305 of FIG. 3A. The quantization data can be generated in the same manner as in the first modification. In this example, a first group color may include black and a second group color may include at least one of cyan, magenta, and yellow. In the following example, K is classified as the first group color, and Y, C, and M are classified as the second group colors. That is, the quantization data K″ is 4-bit data obtained by adding edge information of a “first edge portion” or “second edge portion” to an edge pixel. Each of the quantization data C″, M″, and Y″ is 4-bit data obtained by adding edge information of a “third edge portion” to an adjacent edge pixel. The quantization data C″, M″, and Y″ will collectively be referred to as quantization data CL″ hereinafter.

A case where processing is performed using the input images shown in FIGS. 5A to 5C will be described below. In this case, the quantization data are shown in FIGS. 15A to 15F.

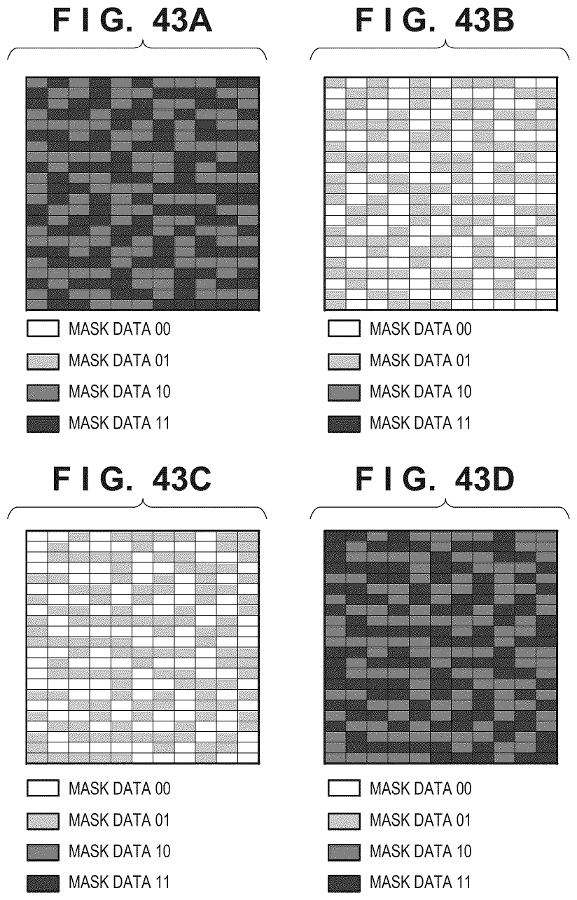

In step S306, a nozzle separation processing unit 212 performs index expansion processing for the quantization data C″, M″, Y″, and K″ obtained in step S305. The nozzle separation processing unit 212 performs the index expansion processing based on dot arrangement patterns shown in FIGS. 41A and 41B and a reference index pattern shown in FIG. 11B. The nozzle separation processing unit 212 converts the quantization data of 600×600 dpi into index data of 600×1200 dpi. Similar to the first embodiment, data of one pixel is converted into data of two pixels connected in the vertical direction. In the first embodiment, the composite nozzle data includes 1-bit data that corresponds to each nozzle and represents printing/non-printing. However, in this embodiment, the index data includes 2-bit data corresponding to each nozzle. This index data is set in accordance with the edge information of the quantization data. In this embodiment, by combining the index data and a multi-valued (2-bit) mask pattern, printing in each pass of multi-pass printing is controlled with respect to a pixel added with edge information.

FIG. 41A shows a dot arrangement pattern used in the index expansion processing for a pixel added with no edge information. If the upper 2 bits of the quantization data of a pixel are “00”, that is, the quantization data indicates “0000”, “0001”, or “0010”, no edge information is added to this pixel. This pixel is assigned with “00” or “01” as the index data. More specifically, if the lower 2 bits of the quantization data are “00”, “00” is set as the index data of both the two pixels. If the lower 2 bits of the quantization data are “01”, in pattern A, index data “01” is set for the lower pixel of the two pixels and index data “00” is set for the upper pixel of the two pixels. In pattern B, index data “01” is set for the upper pixel of the two pixels and index data “00” is set for the lower pixel of the two pixels. If the lower 2 bits of the quantization data are “10”, “01” is set as index data of both the two pixels.

FIG. 41B shows the dot arrangement pattern used in the index expansion processing for a pixel added with edge information. If the upper 2 bits of the quantization data of a pixel are not “00”, edge information is added to this pixel. This pixel is assigned with “00” or “10” as index data. Except that “10” is assigned instead of the index data “01”, a method of assigning the index data is the same as in FIG. 41A.

In the first embodiment, composite nozzle data i is set with information representing printing/non-printing of each nozzle. On the other hand, in this embodiment, to control a printing pass, information representing printing of each nozzle is discriminated between “10” and “01” in accordance with the presence/absence of the edge information. In this example, the index data “10” and “01” both indicate information representing formation of dots by discharging ink. In the first embodiment, with respect to a pixel added with no edge information, when the quantization value obtained in step S1004 increases to 0, 1, and 2, the number of dots increases to 0, 1, and 2. On the other hand, with respect to a pixel added with the edge information, when the quantization value increases to 0, 1, and 2, the number of dots is adjusted to 0, 1, and 1. In the above example, for the sake of easy understanding of the effect of this embodiment, the index data is set so the number of dots does not change depending on the presence/absence of the edge information. More specifically, regardless of the presence/absence of the edge information, when the quantization value increases to 0, 1, and 2, the number of dots increases to 0, 1, and 2.

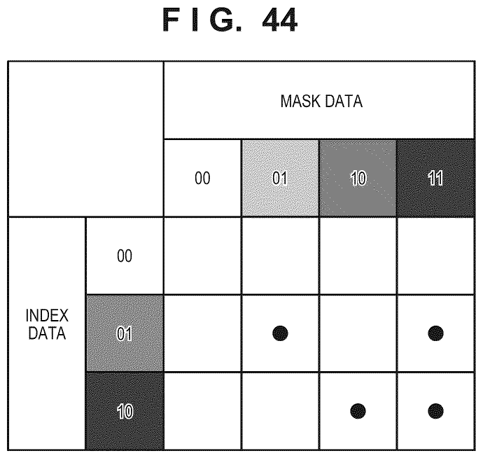

FIGS. 42A to 42C show index data K obtained by performing the index expansion processing for the quantization data K″ shown in FIGS. 15A to 15C in step S306, respectively, according to this embodiment. FIGS. 42D to 42F show index data CL obtained by performing the index expansion processing for the quantization data CL″ shown in FIGS. 15D to 15F in step S306, respectively. The index data CL is data corresponding to one of the color nozzle arrays of C (cyan), M (magenta), and Y (yellow).

In the index data K shown in each of FIGS. 42A and 42B, a value “10” is set in edge pixels (first edge portion and second edge portion) of the black character “E” and a value “01” is set in non-edge pixels inside the edge pixels. In FIG. 42C, since no edge pixels are detected, not a value “10” but a value “01” is set in pixels located in the edge portions of the black character “E”, similar to the pixels inside the edge pixels.

In the index data CL shown in FIG. 42E, a value “10” is set in adjacent edge pixels outside the edge pixels of the character “E” in accordance with the edge information representing the third edge portion. In addition, a value “01” is set in other pixels whose quantization value is not 0. In FIG. 42F, since no edge pixels are detected, not a value “10” but a value “01” is set in adjacent edge pixels outside the edge pixels of the black character “E”, similar to other pixels.

In step S306, the nozzle separation processing unit 212 generates composite nozzle data by further applying a mask pattern to the generated index data. The composite nozzle data according to this embodiment is data representing printing/non-printing by each nozzle in each print scanning operation.

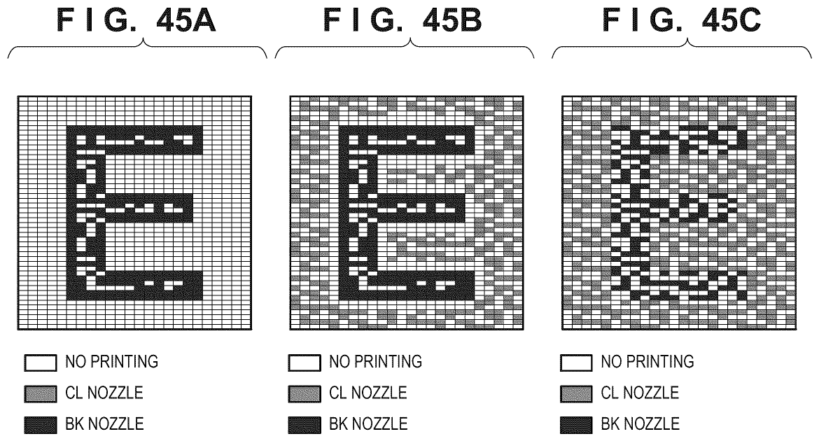

FIGS. 43A to 43D show examples of the mask pattern used in this embodiment. FIGS. 43A and 43B respectively show a first mask pattern and a second mask pattern to be applied to the index data K. The first mask pattern is a mask pattern used to generate nozzle data for print scanning of the first pass of two print scanning operations. The second mask pattern is a mask pattern used to generate nozzle data for print scanning of the second pass. In this way, the nozzle data are generated to control printing by the black nozzle array 2701.

Similarly, FIGS. 43C and 43D respectively show a third mask pattern and a fourth mask pattern to be applied to the index data CL. The third mask pattern is a mask pattern used to generate nozzle data for print scanning of the first pass. The fourth mask pattern is a mask pattern used to generate nozzle data for print scanning of the second pass. In this way, the nozzle data are generated to control printing by the color nozzle arrays of C (cyan), M (magenta), and Y (yellow).

Each mask pattern is data of 600 dpi×1200 dpi. Each pixel of each mask pattern has a 2-bit value of “00”, 01”, “10”, or “11”. This value will be referred to as mask data hereinafter. The meaning of the value will be described later.

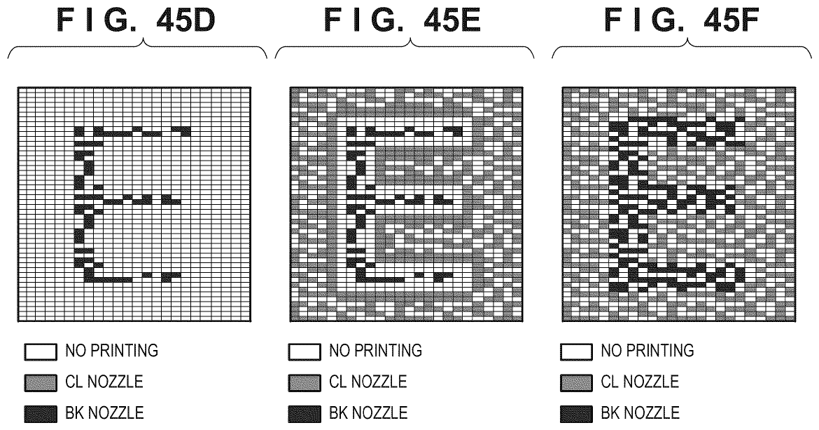

FIG. 44 is a table showing nozzle data corresponding to a combination of 2-bit index data for each pixel and 2-bit mask data. This table defines printing/non-printing for each of combinations of the index data “00”, “01”, and “10” and the mask data “00”, “01”, “10”, and “11”. In the table shown in FIG. 44, “•” represents “printing” and a blank represents “non-printing”. That is, if “printing” is indicated in the table with respect to a combination of the index data and the mask data for a given pixel, printing (that is, ink discharge) is executed in this pixel.

The mask data of the first mask pattern corresponding to the black nozzle array 2701 shown in FIG. 43A are only “10” and “11”. As shown in FIG. 44, with respect to a combination of the index data “10” and the mask data “10” or “11”, “printing” is defined. Therefore, with respect to a pixel assigned with the index data “10”, that is, a pixel which is added with the edge information and for which a dot is formed, printing by the black nozzle array 2701 is executed in the first pass.

On the other hand, the mask data of the second mask pattern corresponding to the black nozzle array 2701 shown in FIG. 43B are only “00” and “01”. As shown in FIG. 44, with respect to a combination of the index data “10” and the mask data “00” or “01”, “non-printing” is defined. Therefore, with respect to a pixel assigned with the index data “10”, that is, a pixel which is added with the edge information and for which a dot is formed, printing by the black nozzle array 2701 is not executed in the second pass.

In a pixel assigned with the index data “01”, printing by the black nozzle array 2701 is executed in a case where the corresponding mask data is “01” or “11”. At this time, a pixel assigned with the index data “01” is a pixel added with no edge information and for which a dot is formed. As described above, a pixel assigned with the index data “01” is printed in the first pass in a case where the mask data “11” is set in the first mask pattern, and is printed in the second pass in a case where the mask data “01” is set in the second mask pattern. When the first mask pattern and the second mask pattern are superimposed on each other, the mask data “11” in the first mask pattern and the mask data “01” in the second mask pattern are complementary to each other. As a result, printing in a pixel assigned with the index data “01” is divided into two passes.

Unlike the mask patterns shown in FIGS. 43A and 43B corresponding to the black nozzle array 2701, the mask data of the first mask pattern corresponding to the color nozzle arrays shown in FIG. 43C are only “00” and “01”. The mask data of the second mask pattern corresponding to the color nozzle arrays shown in FIG. 43D are only “10” and “11”. That is, printing by the color nozzle arrays in a pixel assigned with the index data “10” is executed in the second pass. Printing by the color nozzle arrays in a pixel assigned with the index data “01” is divided into the first pass and the second pass.

As described above, the nozzle separation processing unit 212 can generate print data so that timings of printing edge pixels by the recording material of the first group color are biased to some print scanning operations among a plurality of print scanning operations. Furthermore, the nozzle separation processing unit 212 can generate print data so that timings of printing adjacent edge pixels by the recording material of the second group color are biased to some other print scanning operations among the plurality of print scanning operations. In the above example, print operations by the black nozzle array 2701 for pixels (index data=“10”) added with the edge information are biased to one pass. On the other hand, print operations by the color nozzle arrays for pixels (index data=“10”) added with the edge information are biased to another pass. With this configuration, in the edge region, timings of printing the black ink and the color ink can be shifted from each other. For example, the timing of printing the black ink in the edge pixels forming the character or the thin line and the timing of printing the color ink in the adjacent edge pixels forming the background can temporally be shifted. Therefore, it is possible to reduce bleeding caused by contact between inks before permeating the print medium.

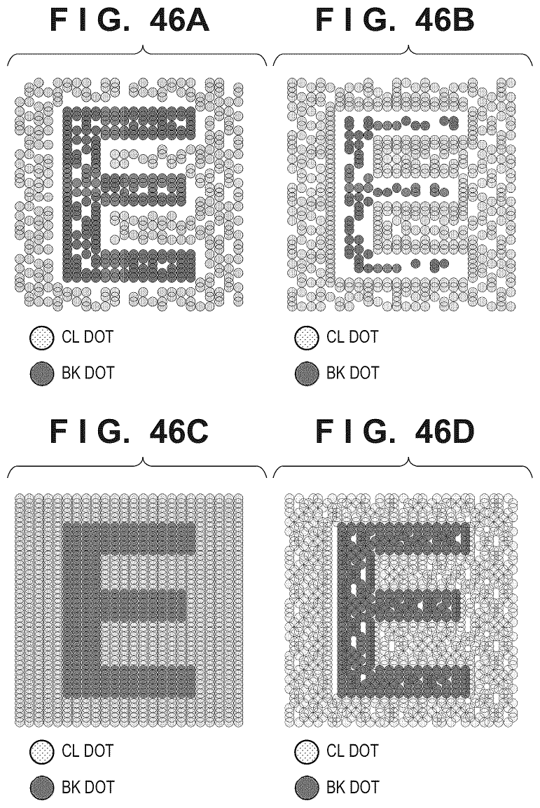

FIGS. 45A to 45C show pixels printed in the first pass in a case where the mask pattern is applied to the index data K shown in FIGS. 42A to 42C and the index data CL shown in FIGS. 42D to 42F. FIGS. 45D to 45F show pixels printed in the second pass in the same case. FIGS. 45A to 45F show, for each pixel, whether printing is executed by the black nozzle, whether printing is executed by the color nozzle, or whether printing is not executed by any nozzle.

As shown in FIG. 45B, printing of the edge pixels inside the character “E” by the black nozzle array 2701 is executed in the first pass. Furthermore, printing of the adjacent edge pixels outside the character “E” by the color nozzle arrays is not executed in the first pass. On the other hand, printing of the edge pixels inside the character “E” by the black nozzle array 2701 is not executed in the second pass. Furthermore, printing of the adjacent edge pixels outside the character “E” by the color nozzle arrays is executed in the second pass. In this way, printing by the black nozzle array 2701 for the pixels added with the edge information can be biased to the first pass, and printing by the color nozzle arrays for the pixels added with the edge information can be biased to the second pass.

On the other hand, as shown in FIG. 45B, printing for the pixels added with no edge information is distributed to the first pass and the second pass not to be biased.

In the above-described example, control is executed so that printing by the black nozzle array 2701 for the pixels added with the edge information is biased to the first pass, and printing by the color nozzle arrays for the pixels added with the edge information is biased to the second pass. On the other hand, the mask pattern corresponding to the black nozzle array 2701 and the mask pattern corresponding to the color nozzle arrays may be interchanged. In this case, printing by the color nozzle arrays for the adjacent edge pixels is executed in the first pass, and printing by the black nozzle array 2701 for the edge pixels is performed in the second pass.

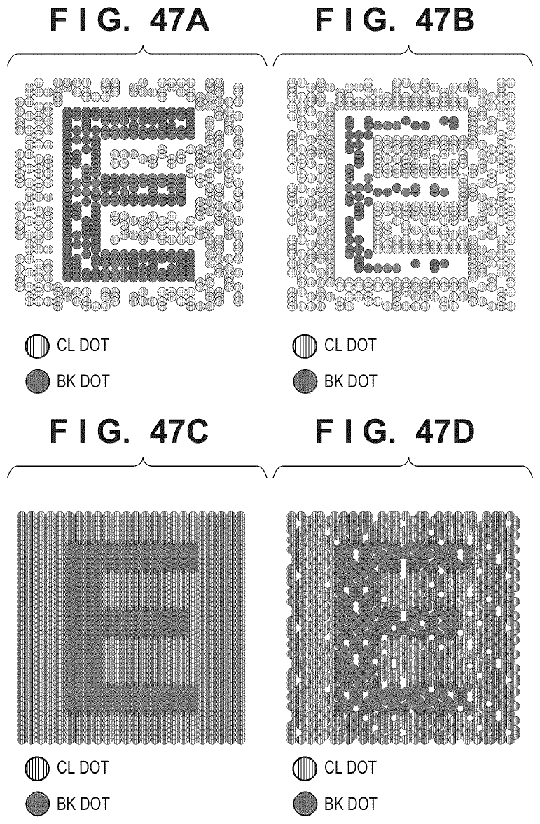

FIG. 46A schematically shows a dot arrangement printed in the first pass in a case where printing is executed, as shown in FIG. 45B. FIG. 46B schematically shows a dot arrangement printed in the second pass in a case where printing is executed, as shown in FIG. 45E. Black dots for the edge pixels of the character “E” are printed in the first pass, and color dots for the adjacent edge pixels of the character “E” are all printed in the second pass. In multi-pass printing, printing of the black dots in the edge pixels of the character “E” and printing of the color dots in the adjacent edge pixels can be biased to different printing passes. With this configuration, it is possible to suppress bleeding caused by contact between inks on the print medium before the inks permeate the sheet.

FIG. 46C shows a state in which the dot arrangement shown in FIG. 46A and the dot arrangement shown in FIG. 46B are superimposed on each other without displacement. On the other hand, FIG. 46D shows a state in which the dot arrangement obtained in the second pass, as shown in FIG. 46B, is superimposed on the dot arrangement obtained in the first pass, as shown in FIG. 46A, while being displaced by −21 μm in the X direction. In this example, since all the edge pixels of the character “E” are printed in the first pass, even if a print position deviation occurs between the passes, the sharpness of the edge portion of the character can be maintained, as shown in FIG. 46B. In the case shown in FIG. 46C, due to a print position deviation between the passes, a continuous white background is generated along the boundary between the character “E” and the background. However, as described above, in this embodiment, the edge information is detected when the brightness of the background adjacent to the character is high (for example, in the case shown in FIG. 5B). Therefore, printing pass control in the edge region, as shown in FIGS. 46A and 46B, is performed when the brightness of the background is high. For example, in FIG. 46C, most of the color dots are yellow dots. In FIG. 46C, since the brightness on the background side is sufficiently high, the white background along the boundary is hardly noticeable. If the brightness on the background side is sufficiently high in this way, it is possible to bias printing of the pixels in the edge region to one pass based on the edge information.

On the other hand, in this embodiment, the edge information is not detected when the brightness of the background adjacent to the character is low (for example, in the case shown in FIG. 5C). In this case, control is executed so printing of the pixels in the edge region is not biased to one pass.

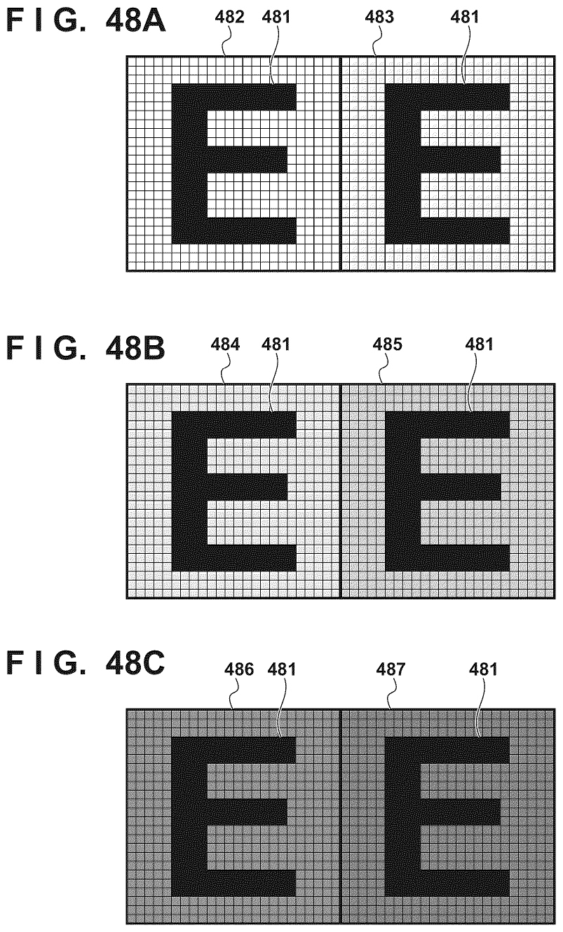

FIG. 47A schematically shows a dot arrangement printed in the first pass in a case where printing is executed, as shown in FIG. 45C. FIG. 47B schematically shows a dot arrangement printed in the second pass in a case where printing is executed, as shown in FIG. 45F. In this example, the edge information is not added to any pixel. Therefore, with respect to the entire region of the image, printing of the black dots and printing of the color dots are divided into two passes.

FIG. 47C shows a state in which the dot arrangement shown in FIG. 47A and the dot arrangement shown in FIG. 47B are superimposed on each other without displacement. On the other hand, FIG. 47D shows a state in which the dot arrangement obtained in the second pass, as shown in FIG. 47B, is superimposed on the dot arrangement obtained in the first pass, as shown in FIG. 47A, while being displaced by −21 μm in the X direction. Unlike FIG. 46D, since printing in the edge region is also divided into two passes, distortion occurs at the edge of the character due to a print position deviation between the passes. However, in this case, since the contrast between the character portion and the background portion is relatively small, the distortion at the edge is hardly visually perceived. On the other hand, a continuous white background along the boundary between the character portion and the background portion, as shown in FIG. 46D, is not generated. In a case where the brightness of the background is relatively low, for example, a case where most of the color dots of the background are formed by the cyan ink or the magenta ink, such white background is readily noticeable. In this embodiment, in this case, control is executed not to bias the printing pass of the edge region, and it is thus possible to suppress deterioration in image quality.

As described above, in this embodiment, printing of an edge region in each pass is controlled based on edge information detected from an N-arized image. That is, the edge information is detected in accordance with the brightness on the background side, and control is executed to bias printing for the edge pixels to a different printing pass in accordance with an ink color. With this configuration, in a case where the brightness of the background is high, even if there is a print position deviation between the passes, the sharpness of the character is maintained. On the other hand, in a case where the brightness of the background is low, even if there is a print position deviation between the passes, it is possible to suppress generation of the white background in the boundary portion between the character and the background.

Note that even in this embodiment, a method of classifying colors into groups is not particularly limited. For example, instead of classifying all of C, M, and Y as the second group colors, one of C, M, and Y may be classified as the third group color. In this embodiment, dots in the edge pixels and the adjacent edge pixels are not thinned out. On the other hand, as in the first embodiment, dots in the edge pixels or the adjacent edge pixels may be thinned out. In this case, the index data can be set so that when the quantization value increases to 0, 1, and 2, the number of dots becomes 0, 1, and 1.

Furthermore, this embodiment has explained a case where the printing apparatus executes two-pass printing. However, multi-pass printing of three or more passes may be executed. For example, when executing three-pass printing, all printing using the black ink for the edge pixels can be executed in the first pass, and all printing using the color inks for the adjacent edge pixels can be executed in the third pass.

In this embodiment, printing in each pass for the edge pixels, the adjacent edge pixels, and the non-edge pixels is controlled using a combination of 2-bit index data and a 2-bit mask pattern. However, different mask patterns may be used for the edge pixels and the non-edge pixels.

In this embodiment, all printing for the edge pixels is executed in a specific pass. However, the present invention is not limited to this configuration. The reason why printing of the edge pixels is biased to one of printing passes is to suppress dots from being disarrayed due to a print position deviation between the plurality of printing passes. That is, the misalignment of the dots in the edge pixels is suppressed, as compared with the non-edge pixels, by making the recording rate in a specific pass with respect to the edge pixels higher than the maximum recording rate in each pass with respect to the non-edge pixels. Therefore, in this case as well, an effect of improving the sharpness of the character or the line is obtained.

For example, with respect to the recording material of the first group color, the recording rate of a pixel not at the edge in print scanning in which the recording rate of the pixel is maximum can be made lower than the recording rate of the pixel in print scanning in which the recording rate of the edge pixel is maximum. More specifically, in four-pass printing, when the recording rates in the respective passes with respect to the non-edge pixel are 25%, the recording rates in the respective passes for the edge pixel with respect to the first group color can be set to 0%, 50%, 0%, and 50%. In this example, printing is divided into two passes. In this case, the recording rate of the pixel not at the edge in print scanning in which the recording rate of the pixel is maximum is 25%, and the recording rate of the pixel in print scanning in which the recording rate of the edge pixel is maximum is 50%.

Furthermore, print data can be generated so that print scanning in which the recording rate of the edge pixel by the recording material of the first group color is maximum is different from print scanning in which the recording rate of the adjacent edge pixel by the recording material of the second group color is maximum. With respect to the recording material of the second group color, the recording rate of the pixel not at the edge in print scanning in which the recording rate of the pixel is maximum can be made lower than the recording rate of the pixel in print scanning in which the recording rate of the adjacent edge pixel is maximum. More specifically, in the above four-pass printing, when the recording rates in the respective passes for the non-edge pixel with respect to the second group color are 25%, the recording rates in the respective passes for the edge pixel can be set to 50%, 0%, 50%, and 0%. In this case, the recording rate of the pixel not at the edge in print scanning in which the recording rate of the pixel is maximum is 25%, and the recording rate of the pixel in print scanning in which the recording rate of the edge pixel is maximum is 50%. Furthermore, print scanning (second pass and fourth pass) in which the recording rate of the edge pixel by the recording material of the first group color is maximum is different from print scanning (first pass and third pass) in which the recording rate of the adjacent edge pixel by the recording material of the second group color is maximum.

Because of the restriction of the printhead, in a case where the maximum recording rate in one scan is limited, printing can be divided into a plurality of passes so that the recording rate in a specific pass for the edge pixel is higher than the maximum recording rates in the respective passes for the non-edge pixel, as described above.

### Other Embodiments

Each of the above-described embodiments has explained a case where printing using the serial-type printing apparatus is executed. However, the configuration of the printing apparatus is not limited to this. For example, the printing apparatus may include a line head. Alternatively, serial-type ink heads may be arranged. Each of the above-described embodiments has explained a case where the printing apparatus is an inkjet printer. However, the configuration of the printing apparatus is not limited to this. For example, the printing apparatus may be a laser printer that executes printing using toner or may be a copying machine.

In each of the above-described embodiments, the printing apparatus prints an image on a print medium by adhering recording materials of a plurality of colors to the print medium. However, the printing apparatus may print an image using only a recording material of one color. In this case as well, while improving the sharpness of a printed image such as a character or a line in, for example, the first embodiment, it is possible to suppress secondary deterioration in image quality such as a decrease in visibility in a case where the background density is high.

In each of the above-described embodiments, grayscale images used for edge detection include a luminance image representing the luminance value Y and an image representing total ink amount A of the cyan ink and the magenta ink. However, the types of grayscale images are not limited to them. For example, each pixel of the grayscale image may represent the total ink amount of each ink mounted on the printing apparatus and used for printing. In addition, a contribution ratio may be set for each ink color. In this case, each pixel of the grayscale image may represent the weighted total ink amount, based on the contribution ratio, of each ink used for printing. In this case, for example, the contribution ratio of the yellow ink can be set lower and the contribution ratios of cyan, magenta, and black can be set higher. As described above, an LUT indicating these total ink amounts corresponding to the RGB values can be created in advance. When generating the grayscale image, it is possible to refer to such LUT. This LUT may be prepared for each print condition. The LUT for each print condition can be created by obtaining ink amount information corresponding to the RGB values based on the ink color separation table prepared for each print condition.

Alternatively, the grayscale image may be a brightness image corresponding to the input image. This brightness image may represent the brightness of the color on the print medium, which is obtained by executing printing on the print medium in accordance with the color information indicated in the input image. The brightness is a value representing the brightness of the color and its type is not particularly limited. For example, an LUT that is referred to when generating a grayscale image may indicate the relationship between specific color information and the L* value of the CIEL*a*b* values obtained when an image according to the color information is printed on the print medium and the color of the image is measured by a colorimeter. Alternatively, an LUT that is referred to when generating a grayscale image may indicate the relationship between specific color information and the optical density of the color printed in accordance with the color information.

In the above-described first embodiment, generation of nozzle data is controlled not to thin out dots in the edge region in a region where the background has low brightness. In the above-described third embodiment, generation of nozzle data is controlled so passes are not biased in a region where the background has low brightness. For these purposes, in the above-described embodiments, an edge in an N-arized image (N is a natural number of 2 or more) representing the result of threshold-based processing for the grayscale image is detected so as not to detect an edge in a region where the background has low brightness. To achieve this purpose, however, it is not necessary to perform edge detection for the N-arized image. For example, the image analysis unit 210 can detect an edge in the grayscale image (for example, the luminance image or the brightness image) by an arbitrary method. At this time, the image analysis unit 210 may detect an edge using an edge detection filter. In this case, the color separation/quantization unit 211 and the nozzle separation processing unit 212 may generate print data based on the input image, the edge detection result, and pixel values at the edge of the grayscale image. For example, the color separation/quantization unit 211 and the nozzle separation processing unit 212 may generate print data based on the input image, the edge detection result, and the luminance or brightness on the high luminance or brightness side (that is, on the background side) at the edge of the luminance image or the brightness image.

As a practical example, in a case where the luminance or brightness on the background side is equal to or higher than the threshold, the color separation/quantization unit 211 may add the above-described edge information (upper 2 bits) to quantization data for an edge pixel or an adjacent edge pixel detected by the image analysis unit 210. The nozzle separation processing unit 212 can generate print data, as described above, in accordance with the thus generated quantization data. In another embodiment, the nozzle separation processing unit 212 may control the thinning-out amount of dots in an edge pixel or an adjacent edge pixel in accordance with the magnitude of the luminance or brightness on the background side. For example, in a case where the luminance or brightness on the background side is higher, the thinning-out amount of dots in an edge pixel or an adjacent edge pixel can be increased. In addition, the nozzle separation processing unit 212 can bias printing of pixels to some passes in accordance with the magnitude of the luminance or brightness on the background side. For example, in a case where the luminance or brightness on the background side is higher, bias of printing of pixels to some passes can be made larger.

In the above-described second embodiment, generation of nozzle data is controlled so as to increase the recording amount of adjacent black dots in a region where the total ink amount of the background is large. For this purpose, an edge in an N-arized image (N is a natural number of 2 or more) indicating the result of the threshold-based processing for the grayscale image representing the total ink amount is detected. However, to achieve this purpose, it is not necessary to perform edge detection for the N-arized image. As described above, the color separation/quantization unit 211 and the nozzle separation processing unit 212 may generate print data based on the input image, the edge detection result, and the pixel values at the edge of the grayscale image. For example, the color separation/quantization unit 211 and the nozzle separation processing unit 212 may generate print data based on the input image, the edge detection result, and the total ink amount on the large total ink amount side (that is, on the background side) at the edge of the grayscale image representing the total ink amount. As a practical example, in a case where the total ink amount for an edge pixel detected by the image analysis unit 210 is equal to or larger than the threshold, the color separation/quantization unit 211 may apply the second tone correction processing to the adjacent edge pixel adjacent to the edge pixel.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2023-131466, filed Aug. 10, 2023, and 2024-121295, filed Jul. 26, 2024, which are hereby incorporated by reference herein in their entirety.

What is claimed is:

1. An image processing apparatus for generating print data of at least one color, which is used by a printing apparatus for printing an image on a print medium by adhering a recording material of at least one color to the print medium in accordance with the print data, the image processing apparatus comprising one or more memories storing instructions and one or more processors that execute the instructions to:
detect an edge in an N-arized image (N is a natural number not less than 2) representing a result of threshold-based processing for a grayscale image obtained from an input image; and
generate the print data based on the input image and a detection result of the edge.

2. The image processing apparatus according to claim 1, wherein the grayscale image is a luminance image corresponding to the input image or a brightness image corresponding to the input image.

3. The image processing apparatus according to claim 1, wherein
the grayscale image indicates, for each pixel, a luminance or brightness on the print medium in a case where an image is printed on the print medium in accordance with each pixel value of the input image, and
the grayscale image is obtained by converting the pixel values of the input image in accordance with a conversion table corresponding to a type of the print medium.

4. The image processing apparatus according to claim 1, wherein the grayscale image indicates, for each pixel, an amount of at least one recording material used to print an image on the print medium in accordance with each pixel value of the input image.

5. The image processing apparatus according to claim 4, wherein the grayscale image is obtained by converting the pixel values of the input image in accordance with a conversion table corresponding to a print mode of the printing apparatus.

6. The image processing apparatus according to claim 1, wherein the one or more processors execute the instructions to generate the print data corresponding to a pixel of interest of the input image with respect to at least one color from a value of the pixel of interest of the input image by a method corresponding to whether the pixel of interest of the input image is at the edge.

7. The image processing apparatus according to claim 1, wherein the one or more processors execute the instructions to generate the print data so that a maximum recording amount for a pixel at the edge is smaller than a maximum recording amount for a pixel not at the edge.

8. The image processing apparatus according to claim 1, wherein the one or more processors execute the instructions to generate the print data so that a maximum recording amount for a pixel at the edge is larger than a maximum recording amount for a pixel not at the edge.

9. The image processing apparatus according to claim 1, wherein
the printing apparatus prints an image on the print medium by adhering recording materials of a plurality of colors to the print medium,
the plurality of colors are classified into at least two groups including a first group and a second group, and
the one or more processors execute the instructions to
detect a first edge pixel and a second edge pixel corresponding to two sides of the edge, and
generate the print data with respect to the color of the first group based on a detection result of the first edge pixel, and generate the print data with respect to the color of the second group based on a detection result of the second edge pixel.

10. The image processing apparatus according to claim 9, wherein the one or more processors execute the instructions to generate the print data with respect to the color of the first group so that a maximum recording amount for the first edge pixel is smaller than a maximum recording amount for a pixel not at the edge, and generate the print data with respect to the color of the second group so that a maximum recording amount for the second edge pixel is smaller than a maximum recording amount for a pixel not at the edge.

11. The image processing apparatus according to claim 10, wherein
the color of the first group includes at least one of black, cyan, and magenta, and
the color of the second group includes yellow.

12. The image processing apparatus according to claim 9, wherein the one or more processors execute the instructions to exclude, in a case where second edge pixels of at least two adjacent lines are detected, second edge pixels of at least one line from a detection result.

13. The image processing apparatus according to claim 9, wherein the one or more processors execute the instructions to
generate print data with respect to a plurality of positions corresponding to one pixel of the input image, and
generate the print data with respect to the color of the first group so that printing at a position adjacent to the second edge pixel among the plurality of positions corresponding to the first edge pixel is executed more than printing at a position not adjacent to the second edge pixel.

14. The image processing apparatus according to claim 9, wherein
the printing apparatus executes multi-pass printing of forming an image on the print medium by a plurality of print scanning operations, and
the one or more processors execute the instructions to generate the print data so that timings of printing the first edge pixels by the recording material of the color of the first group are biased to some print scanning operations among the plurality of print scanning operations, and timings of printing the second edge pixels by the recording material of the color of the second group are biased to some other print scanning operations among the plurality of print scanning operations.

15. The image processing apparatus according to claim 14, wherein
a print scanning operation in which a recording rate of the first edge pixel by the recording material of the color of the first group is maximum is different from a print scanning operation in which a recording rate of the second edge pixel by the recording material of the color of the second group is maximum,
a recording rate of a pixel not at the edge by the recording material of the color of the first group in a print scanning operation in which the recording rate of the pixel not at the edge by the recording material of the color of the first group is maximum is lower than the recording rate of the first edge pixel by the recording material of the color of the first group in the print scanning operation in which the recording rate of the first edge pixel by the recording material of the color of the first group is maximum, and
a recording rate of a pixel not at the edge by the recording material of the color of the second group in a print scanning operation in which the recording rate of the pixel not at the edge by the recording material of the color of the second group is maximum is lower than the recording rate of the second edge pixel by the recording material of the color of the second group in the print scanning operation in which the recording rate of the second edge pixel by the recording material of the color of the second group is maximum.

16. The image processing apparatus according to claim 14, wherein
the color of the first group includes black, and
the color of the second group includes at least one of cyan, magenta, and yellow.

17. The image processing apparatus according to claim 9, wherein
in the grayscale image, a pixel value of the first edge pixel is smaller than a pixel value of the second edge pixel, and
optical densities of all of recording materials of the colors of the first group are higher than an optical density of any of recording materials of the colors of the second group.

18. An image processing apparatus for generating print data corresponding to each color, which is used by a printing apparatus for printing an image on a print medium by adhering a recording material of at least one color to the print medium in accordance with the print data, the image processing apparatus comprising one or more memories storing instructions and one or more processors that execute the instructions to:
detect an edge in a grayscale image corresponding to an input image; and
generate the print data based on the input image, a detection result of the edge, and a pixel value at the edge of the grayscale image.

19. An image processing apparatus comprising one or more memories storing instructions and one or more processors that execute the instructions to:
detect an edge in an N-arized image (N is a natural number not less than 2) representing a result of threshold-based processing for a grayscale image obtained from an input image; and
generate, based on the input image and a detection result of the edge, color separation data indicating a recording amount for each pixel and a detection result of the edge for each pixel and corresponding to a recording material used by a printing apparatus for printing.

20. The image processing apparatus according to claim 1, wherein the one or more processors execute the instructions to operate in a first print mode in which a threshold in the threshold-based processing is a first value, and a second print mode in which the threshold is a second value different from the first value.

21. The image processing apparatus according to claim 20, wherein in the first print mode, a width of an edge region included in the detected edge is a first width, and in the second print mode, the width of the edge region is a second width different from the first width.

22. The image processing apparatus according to claim 21, wherein the one or more processors execute the instructions to operate in a third print mode in which the width of the edge region is the second width and the threshold is the first value.

23. The image processing apparatus according to claim 20, wherein the second print mode is a print mode of clearly printing a code image, and the first threshold is on a brighter density side of the grayscale image than the second threshold.

24. The image processing apparatus according to claim 22, wherein the third print mode is a print mode of clearly printing a code image, and the first threshold is on a brighter density side of the grayscale image than the second threshold.

25. The image processing method of generating print data of at least one color, which is used by a printing apparatus for printing an image on a print medium by adhering a recording material of at least one color to the print medium in accordance with the print data, comprising:
detecting an edge in an N-arized image (N is a natural number not less than 2) representing a result of threshold-based processing for a grayscale image obtained from an input image; and
generating the print data based on the input image and a detection result of the edge.

26. A non-transitory computer-readable medium storing a program executable by a computer to perform a method of generating print data of at least one color, which is used by a printing apparatus for printing an image on a print medium by adhering a recording material of at least one color to the print medium in accordance with the print data, comprising:
detecting an edge in an N-arized image (N is a natural number not less than 2) representing a result of threshold-based processing for a grayscale image obtained from an input image; and
generating the print data based on the input image and a detection result of the edge.
